(19) United States
(12) Patent Application Publication
(10) Pub. No.: US 2025/0048332 A1
(43) Pub. Date: Feb. 6, 2025

(54) UWB Signal Transmission Method and Related Apparatus

(71) Applicant: Huawei Technologies Co., Ltd., Shenzhen (CN)

(72) Inventors: Bin Qian, Shenzhen (CN); Zhengchun Zhou, Chengdu (CN); Chenchen Liu, Shenzhen (CN); Yang Yang, Chengdu (CN); Xun Yang, Singapore (SG)

(21) Appl. No.: 18/914,870

(22) Filed: Oct. 14, 2024

Related U.S. Application Data
(63) Continuation of application No. PCT/CN2023/087267, filed on Apr. 10, 2023.

(30) Foreign Application Priority Data
Apr. 12, 2022 (CN) 202210380061.X

(51) Int. Cl. H04W 64/00

(52) U.S. Cl. CPC H04W 64/006

(57) ABSTRACT

An ultra-wideband (UWB) signal transmission method includes that a plurality of initiators simultaneously sends a UWB signal. A UWB signal sent by any initiator is obtained by performing pulse shaping and modulation on a first sequence. The first sequence is obtained by performing a cyclic shift on a second sequence, and a number of cyclic shift bits is determined based on a shift factor and a step size of the cyclic shift that are of the any initiator. A responder determines time of arrival of the plurality of UWB signals based on the plurality of received UWB signals and the second sequence.

### CROSS-REFERENCE TO RELATED APPLICATIONS

This is a continuation of International Patent Application No. PCT/CN2023/087267 filed on Apr. 10, 2023, which claims priority to Chinese Patent Application No. 202210380061.X filed on Apr. 12, 2022. The disclosures of the aforementioned applications are hereby incorporated by reference in their entireties.

### TECHNICAL FIELD

This disclosure relates to the field of communication technologies, and in particular, to an ultra-wideband (UWB) signal transmission method and a related apparatus.

### BACKGROUND

UWB technologies are wireless carrier communication technologies. For example, the technologies can use non-sinusoidal narrow pulses at a nanosecond level to transmit data. Therefore, the technologies occupy a wide spectral range. Due to a narrow pulse and low radiation spectral density, UWB has advantages such as a strong multipath resolution capability, low power consumption, and high confidentiality, and is mainly applied to sensing and ranging scenarios.

In a multi-node UWB ranging scenario, there are one or more initiators and a plurality of responders. Round-trip time of a UWB signal between an initiator and a responder is calculated, to implement high-precision ranging between the initiator and a plurality of responders. For example, multi-node UWB ranging includes single-sided two-way ranging (SS-TWR) and double-sided two-way ranging (DS-TWR). For specific SS-TWR and DS-TWR processes, refer to other approaches. Details are not described one by one herein. In the SS-TWR and DS-TWR processes, after receiving a UWB signal broadcast by an initiator, each responder replies, in a scheduling manner or a contention-based manner, to the UWB signal broadcast by the initiator.

In other words, in the SS-TWR and DS-TWR processes, different responders reply to the UWB signal at different moments. In this case, to avoid missing UWB signals of the responders, the initiator needs to remain in a power-on state in an entire ranging process to receive the UWB signals of the responders, resulting in an increase in power consumption. In addition, the initiator needs to perform a correlation operation on each received UWB signal, resulting in high complexity of the correlation operation and high power consumption.

### SUMMARY

Embodiments of this disclosure provide a UWB signal transmission method and a related apparatus, to reduce a number of correlation operations during ranging in a UWB system and reduce power consumption in a ranging process.

The following describes this disclosure from different aspects. It should be understood that, for the following implementations and beneficial effect of the different aspects, refer to each other.

For ease of description, in this disclosure, a communication device that supports UWB technologies (or the 802.15 series protocols) is referred to as a UWB device. Details are not described in the following. It may be understood that the UWB device in this disclosure can support the 802.15 series protocols, for example, the 802.15.4ab standard or a next-generation standard of the 802.15.4ab, and can support other standard protocols (for example, the 802.11 series protocols), for example, a plurality of wireless local area network (WLAN) standards of the 802.11 family such as the 802.11ax, 802.11ac, 802.11n, 802.11g, 802.11b, 802.11a, 802.11be, and a next-generation standard of the 802.11be.

According to a first aspect, this disclosure provides a UWB signal transmission method. The method includes a first UWB device that receives a UWB signal simultaneously (or concurrently) sent by one or more second UWB devices. A UWB signal sent by any second UWB device is obtained by performing pulse shaping and modulation on a first sequence. The first sequence is obtained by performing a cyclic shift on a second sequence. The first UWB device determines, based on received one or more UWB signals and the second sequence, time of receiving the one or more UWB signals. It may be understood that one second UWB device sends one UWB signal. A number of cyclic shift bits is determined based on a shift factor and a step size of the cyclic shift that are of the any second UWB device.

A UWB signal sent by each device is obtained by performing pulse shaping and modulation on a first sequence of each device. In this disclosure, the first sequence of each device is obtained by performing a cyclic shift on the second sequence, but the number of cyclic shift bits of the cyclic shift performed by each device is determined based on a shift factor and a step size of the cyclic shift that are of the device. Therefore, each device needs to store only the second sequence, and may generate the first sequence of the device through the cyclic shift. In this way, storage space for storing a large number of sequences is reduced, and a receiving end can perform one correlation operation on all received UWB signals without a need to perform a plurality of correlation operations. This reduces a number of correlation operations performed by the receiving end, and reduces power consumption and complexity in a ranging process.

In addition, in a multi-node simultaneous ranging scenario, a plurality of devices in this disclosure may simultaneously send UWB signals. Therefore, even if distances between the plurality of devices and the receiving end are different, time at which the plurality of UWB signals sent by the plurality of devices arrive at the receiving end does not differ greatly (a time difference at which the plurality of UWB signals arrive at the receiving end is very small), so that the receiving end does not need to remain in a power-on state for a long time. To be specific, when the device does not perform a transmission operation or a receiving operation, the device may remain sleep to save electric energy, to reduce power consumption of the receiving end.

With reference to the first aspect, in a possible implementation, the method further includes that the first UWB device obtains cyclic shift parameters of the one or more second UWB devices. The cyclic shift parameter includes a shift factor and a step size of the cyclic shift, or the cyclic shift parameter includes a number of cyclic shift bits.

For example, the first UWB device locally obtains the cyclic shift parameter. For example, the first UWB device receives sequence configuration information sent by a specific second UWB device, where the sequence configuration information includes the cyclic shift parameters of the one or more second UWB devices.

In this disclosure, the first UWB device locally obtains the cyclic shift parameters of the one or more second UWB devices or receives the cyclic shift parameters of the one or more second UWB devices from a specific second UWB device. This helps the first UWB device determine, based on the cyclic shift parameter, receiving time of the UWB signal, that is, helps determine time of arrival of the UWB signal. For a specific determining manner, refer to related descriptions in the following method embodiments, and details are not described one by one herein.

According to a second aspect, this disclosure provides a UWB signal transmission method. The method includes a second UWB device that generates and sends a UWB signal, where the UWB signal is obtained by performing pulse shaping and modulation on a first sequence, the first sequence is obtained by performing a cyclic shift on a second sequence, and a number of cyclic shift bits is determined based on a shift factor and a step size of the cyclic shift that are of the second UWB device.

In this disclosure, the UWB signal sent by the second UWB device is obtained by performing pulse shaping and modulation on the first sequence of the second UWB device, the first sequence of the second UWB device is obtained by performing a cyclic shift on the second sequence, and the number of cyclic shift bits performed by the second UWB device is determined based on the shift factor and the step size of the cyclic shift that are of the second UWB device. Therefore, the second UWB device only needs to store the second sequence, and may generate the first sequence of the second UWB device through the cyclic shift, reducing storage space for storing a large number of sequences.

With reference to the second aspect, in a possible implementation, the method further includes that the second UWB device obtains a cyclic shift parameter of the second UWB device. The cyclic shift parameter includes a shift factor and a step size of the cyclic shift, or the cyclic shift parameter includes a number of cyclic shift bits.

For example, the second UWB device locally obtains the cyclic shift parameter of the second UWB device. For example, the second UWB device receives sequence configuration information sent by a first UWB device, where the sequence configuration information includes cyclic shift parameters of one or more UWB devices, and the one or more UWB devices include the second UWB device. Optionally, the one or more UWB devices support simultaneous sending of the UWB signal.

In this disclosure, the second UWB device locally obtains the cyclic shift parameter of the second UWB device and notifies the first UWB device of the cyclic shift parameter of the second UWB device, or receives the cyclic shift parameter of the second UWB device from the first UWB device. This helps the first UWB device and the second UWB device reach an agreement on the cyclic shift parameter of the second UWB device, and helps the first UWB device determine time of arrival of the UWB signal sent by the second UWB device. For a specific determining manner, refer to related descriptions in the following method embodiments. Details are not described one by one herein.

In a possible implementation of any one of the foregoing aspects, the second sequence further satisfies one or more of the following conditions: a ratio of a main lobe amplitude of autocorrelation of the second sequence to a side lobe amplitude of the autocorrelation of the second sequence is greater than or equal to a first threshold, the main lobe amplitude of the autocorrelation of the second sequence is greater than or equal to a second threshold, the side lobe amplitude of the autocorrelation of the second sequence is less than or equal to a third threshold, or a ratio of the main lobe amplitude of the autocorrelation of the second sequence to a main lobe amplitude of cross-correlation of the second sequence is greater than or equal to a fourth threshold.

It should be understood that the autocorrelation of the second sequence means correlation between second sequences in different delays. The cross-correlation of the second sequence means correlation between the second sequence and another sequence in different delays. The main lobe may be understood as a peak value in an autocorrelation function or a cross-correlation function, and an amplitude other than the main lobe may be referred to as a side lobe or a side-lobe. For example, the main lobe may correspond to the amplitude peak of the autocorrelation function or the cross-correlation function.

The first sequence is obtained by performing a cyclic shift on the second sequence, and the cyclic shift does not change a periodic correlation characteristic of a sequence. Therefore, in this disclosure, the second sequence is constrained to have a good periodic correlation characteristic, so that the first sequence also has the good periodic correlation characteristic, improving accuracy of obtaining the time of arrival through a correlation operation.

In a possible implementation of any one of the foregoing aspects, an element of the second sequence includes at least one of 1, −1, or 0. For example, the element of the second sequence includes 1 and −1, or the element of the second sequence includes 1, −1, and 0.

It may be understood that for specific descriptions of the second sequence, refer to related descriptions in the following method embodiments. Details are not described one by one herein again.

In a possible implementation of any one of the foregoing aspects, if the reference UWB signal is a UWB fragment signal, the UWB signal sent by the second UWB device is also a UWB fragment signal.

In this disclosure, an instantaneous power of the UWB signal is increased through fragment transmission, to increase a coverage area of the UWB signal and improve a signal-to-noise ratio of a signal received by a receiving end.

In a possible implementation of any one of the foregoing aspects, the step size of the cyclic shift is determined based on the length of the second sequence and a number of devices that support simultaneous sending of UWB signals.

Optionally, the step size of the cyclic shift satisfies the following condition:

$$Z \leq ⌊ \frac{N}{M} ⌋ ,$$

Z indicates the step size of the cyclic shift, N indicates the length of the second sequence, and M indicates the number of devices that support simultaneous sending of the UWB signals. └x┘ indicates rounding down x, and details are not described in the following.

In this disclosure, the step size of the cyclic shift is designed by using the number of devices that support simultaneous sending of the UWB signals, so that simultaneous ranging of a plurality of devices can be supported.

In a possible implementation of any one of the foregoing aspects, the step size of the cyclic shift is determined based on a ranging range, a delay in a channel environment, and an average pulse repetition frequency.

Optionally, the step size of the cyclic shift satisfies the following condition:

$$Z \geq ( {t}_{max} + {delay}_{channel} ) \times PRF , and {t}_{max} = \frac{d}{c} ,$$

d indicates the ranging range, c indicates a speed of light, tₘₐₓ indicates a maximum time difference of arrival of the UWB signal, PRF indicates the average pulse repetition frequency, and delay_{channel} indicates the delay in the channel environment. Herein, the delay in the channel environment delay_{channel} is mainly caused by multipath effect. For a specific value, refer to definitions of different channel environments in a UWB standard.

In this disclosure, the step size Z of the cyclic shift is determined by using the ranging range, the delay in the channel environment, and the average pulse repetition frequency, to resolve incorrect determining and ambiguity of a correlation peak location caused by a difference between distances from different UWB transmitting devices to a receiving device. For detailed analysis of the ambiguity, refer to the description of the following method embodiments.

In a possible implementation of any one of the foregoing aspects, a length of the second sequence is less than or equal to a maximum number of pulses contained in a reference UWB signal. For example, the length of the second sequence is as close as possible to the maximum number of pulses contained in the reference UWB signal. Optionally, when the reference UWB signal is a UWB fragment signal, the maximum number of pulses contained in the reference UWB signal is equal to a product of duration of the reference UWB signal and an average pulse repetition frequency.

A larger length of the second sequence indicates a larger number of devices that support simultaneous sending of the UWB signals. Therefore, in this embodiment of this disclosure, the length of the second sequence is constrained to be less than but as close as possible to the maximum number of pulses contained in the reference UWB signal. This can increase the number of devices that support simultaneous sending of the UWB signals, and improve related performance.

According to a third aspect, an embodiment of this disclosure provides a communication apparatus. The communication apparatus is a first UWB device or a chip in the first UWB device, and the communication apparatus is configured to perform the method in the first aspect or any one of the possible implementations of the first aspect. The communication apparatus includes units that perform the method according to the first aspect or any one of the possible implementations of the first aspect.

According to a fourth aspect, an embodiment of this disclosure provides a communication apparatus. The communication apparatus is a second UWB device or a chip in the second UWB device, and the communication apparatus is configured to perform the method in the second aspect or any one of the possible implementations of the second aspect. The communication apparatus includes units that perform the method according to the second aspect or any one of the possible implementations of the second aspect.

In the third aspect or the fourth aspect, the communication apparatus may include a transceiver unit and a processing unit. For specific descriptions of the transceiver unit and the processing unit, refer to the apparatus embodiments provided in the following. For beneficial effect of the third aspect and the fourth aspect, refer to related descriptions of the first aspect and the second aspect. Details are not described herein again.

According to a fifth aspect, this disclosure provides an information exchange method in a UWB system. The method includes a first node that generates and sends sequence configuration information, where the sequence configuration information includes a cyclic shift parameter of one or more nodes, the one or more nodes include a second node, and the one or more nodes support simultaneous sending of a UWB signal. For example, the first node broadcasts the sequence configuration information.

In this disclosure, the first node configures a cyclic shift parameter for the one or more nodes that support simultaneous sending of the UWB signal, so that the one or more nodes generate a respective sequence based on a respective cyclic shift parameter and a second sequence. This can lay a foundation for multi-node ranging, so that different nodes have different numbers of cyclic shift bits, and a receiving end can distinguish between UWB signals from the different nodes.

According to a sixth aspect, this disclosure provides an information exchange method in a UWB system. The method includes a second node that receives sequence configuration information, where the sequence configuration information includes a cyclic shift parameter of one or more nodes, the one or more nodes include a second node, and the one or more nodes support simultaneous sending of a UWB signal. The second node determines a cyclic shift parameter of the second node based on the sequence configuration information. For example, the second node determines a number of cyclic shift bits of the second node based on the received sequence configuration information.

It may be understood that a first node in this disclosure may be a first UWB device, and correspondingly, the second node is a second UWB device. Certainly, the first node in this disclosure may alternatively be the second UWB device, and correspondingly, the second node is the first UWB device.

With reference to the fifth aspect or the sixth aspect, in a possible implementation, the cyclic shift parameter includes a shift factor and a step size of the cyclic shift, or the cyclic shift parameter includes a number of cyclic shift bits.

With reference to the fifth aspect or the sixth aspect, in a possible implementation, the sequence configuration information further includes one or more of the following items: a fragment number of the UWB signal, duration of each fragment, total duration of the UWB signal, a number of nodes (or UWB devices) that support simultaneous sending of UWB signals, or address lengths of the one or more nodes.

With reference to the fifth aspect or the sixth aspect, in a possible implementation, the sequence configuration information is carried in a ranging control message (RCM).

According to a seventh aspect, an embodiment of this disclosure provides a communication apparatus. The communication apparatus is a first node or a chip in the first node, and the communication apparatus is configured to perform the method in the third aspect or any one of the possible implementations of the third aspect. The communication apparatus includes units that perform the method in the third aspect or any one of the possible implementations of the third aspect.

According to an eighth aspect, an embodiment of this disclosure provides a communication apparatus. The communication apparatus is a second node or a chip in the second node, and the communication apparatus is configured to perform the method in the fourth aspect or any one of the possible implementations of the fourth aspect. The communication apparatus includes units that perform the method in the fourth aspect or any one of the possible implementations of the fourth aspect.

In the seventh aspect or the eighth aspect, the communication apparatus may include a transceiver unit and a processing unit. For specific descriptions of the transceiver unit and the processing unit, refer to the apparatus embodiments provided in the following. For beneficial effect of the seventh aspect and the eighth aspect, refer to related descriptions of the fifth aspect and the sixth aspect. Details are not described herein again.

According to a ninth aspect, this disclosure provides a communication apparatus. The communication apparatus is a first UWB device, a first node, or a chip in the first UWB device or the first node, and the communication apparatus includes a processor configured to perform the method according to the first aspect or the fifth aspect or any one of the possible implementations of the first aspect or the fifth aspect. Alternatively, the processor is configured to execute a program stored in a memory. When the program is executed, the method according to the first aspect or the fifth aspect or any one of the possible implementations of the first aspect or the fifth aspect is performed.

With reference to the ninth aspect, in a possible implementation, the memory is located outside the communication apparatus.

With reference to the ninth aspect, in a possible implementation, the memory is located inside the communication apparatus.

In this disclosure, the processor and the memory may alternatively be integrated into one device. In other words, the processor and the memory may alternatively be integrated together.

With reference to the ninth aspect, in a possible implementation, the communication apparatus further includes a transceiver. The transceiver is configured to receive a signal or send a signal.

According to a tenth aspect, this disclosure provides a communication apparatus. The communication apparatus is a second UWB device, a second node, or a chip in the second UWB device or the second node, and the communication apparatus includes a processor configured to perform the method according to either the second aspect or the sixth aspect, or any one of the possible implementations of the second aspect or the sixth aspect. Alternatively, the processor is configured to execute a program stored in a memory. When the program is executed, the method according to either the second aspect or the sixth aspect, or any one of the possible implementations of the second aspect or the sixth aspect is performed.

With reference to the tenth aspect, in a possible implementation, the memory is located outside the communication apparatus.

With reference to the tenth aspect, in a possible implementation, the memory is located inside the communication apparatus.

In this disclosure, the processor and the memory may alternatively be integrated into one device. In other words, the processor and the memory may alternatively be integrated together.

With reference to the tenth aspect, in a possible implementation, the communication apparatus further includes a transceiver. The transceiver is configured to receive a signal or send a signal.

According to an eleventh aspect, this disclosure provides a communication apparatus. The communication apparatus includes a logic circuit and an interface, and the logic circuit is coupled to the interface.

In a design, the interface is configured to input a UWB signal sent by one or more second UWB devices, where a UWB signal sent by any second UWB device is obtained by performing pulse shaping and modulation on a first sequence, the first sequence is obtained by performing a cyclic shift on a second sequence, and a number of cyclic shift bits is determined based on a shift factor and a step size of the cyclic shift that are of the any second UWB device, and the logic circuit is configured to determine, based on the UWB signal sent by the one or more second UWB devices and the second sequence, time of receiving the UWB signal sent by the one or more second UWB devices.

In another design, the logic circuit is configured to generate a UWB signal, where the UWB signal is obtained by performing pulse shaping and modulation on a first sequence, the first sequence is obtained by performing a cyclic shift on a second sequence, and a number of cyclic shift bits is determined based on a shift factor and a step size of the cyclic shift that are of the second UWB device, and the interface is configured to output the UWB signal.

In a design, the logic circuit is configured to generate sequence configuration information, where the sequence configuration information includes a cyclic shift parameter of one or more nodes, the one or more nodes include a second node, and the one or more nodes support simultaneous sending of a UWB signal, and the interface is configured to output the sequence configuration information.

In another design, the interface is configured to input sequence configuration information, where the sequence configuration information includes a cyclic shift parameter of one or more nodes, the one or more nodes include a second node, and the one or more nodes support simultaneous sending of a UWB signal, and the logic circuit is configured to determine a cyclic shift parameter of the second node based on the sequence configuration information.

According to a twelfth aspect, an embodiment of this disclosure provides a computer-readable storage medium. The computer-readable storage medium is configured to store a computer program. When the computer program is run on a computer, the method according to the first aspect or the fifth aspect or any one of the possible implementations of the first aspect or the fifth aspect is performed.

According to a thirteenth aspect, an embodiment of this disclosure provides a computer-readable storage medium. The computer-readable storage medium is configured to store a computer program. When the computer program is run on a computer, the method according to the second aspect or the sixth aspect or any one of the possible implementations of the second aspect or the sixth aspect is performed.

According to a fourteenth aspect, an embodiment of this disclosure provides a computer program product. The computer program product includes a computer program or computer code. When the computer program product runs on a computer, the method according to the first aspect or the fifth aspect or any one of the possible implementations of the first aspect or the fifth aspect is performed.

According to a fifteenth aspect, an embodiment of this disclosure provides a computer program product. The computer program product includes a computer program or computer code. When the computer program product runs on a computer, the method according to the second aspect or the sixth aspect or any one of the possible implementations of the second aspect or the sixth aspect is performed.

According to a sixteenth aspect, an embodiment of this disclosure provides a computer program. When the computer program is run on a computer, the method according to the first aspect or the fifth aspect or any one of the possible implementations of the first aspect or the fifth aspect is performed.

According to a seventeenth aspect, an embodiment of this disclosure provides a computer program. When the computer program runs on a computer, the method according to the second aspect or the sixth aspect or any one of the possible implementations of the second aspect or the sixth aspect is performed.

According to an eighteenth aspect, an embodiment of this disclosure provides a wireless communication system. The wireless communication system includes a first UWB device and a second UWB device. The first UWB device is configured to perform the method according to the first aspect or the fifth aspect or the sixth aspect or any one of the possible implementations of the first aspect, the fifth aspect, or the sixth aspect. The second communication apparatus is configured to perform the method according to the second aspect or the fifth aspect or the sixth aspect or any one of the possible implementations of the first aspect, the fifth aspect, or the sixth aspect.

### BRIEF DESCRIPTION OF DRAWINGS

To describe the technical solutions in embodiments of this disclosure more clearly, the following briefly describes the accompanying drawings used for describing the embodiments.

FIG. 1 is a diagram of a structure of a wireless communication system according to an embodiment of this disclosure;

FIG. 2 is a diagram of another structure of a wireless communication system according to an embodiment of this disclosure;

FIG. 3 is a diagram of a frame format of a UWB signal according to an embodiment of this disclosure;

FIG. 4 is a diagram of a ranging principle according to an embodiment of this disclosure;

FIG. 5A is a diagram of an SS-TWR process according to an embodiment of this disclosure;

FIG. 5B is a diagram of a DS-TWR process according to an embodiment of this disclosure;

FIG. 6 is a diagram of fragment transmission of a UWB signal according to an embodiment of this disclosure;

FIG. 7 is a diagram of simultaneous ranging of a plurality of nodes according to this disclosure;

FIG. 8 is a diagram in which a plurality of anchors simultaneously send UWB signals according to this disclosure;

FIG. 9 is a schematic flowchart of a UWB signal transmission method according to an embodiment of this disclosure;

FIG. 10 is a diagram in which a plurality of initiators or a plurality of responders simultaneously send UWB signals according to an embodiment of this disclosure;

FIG. 11A and FIG. 11B are diagrams of ambiguity of a correlation peak according to an embodiment of this disclosure;

FIG. 12 is a diagram of a correlation peak shown when multipath effect exists according to an embodiment of this disclosure;

FIG. 13 shows an information exchange method in a UWB system according to an embodiment of this disclosure;

FIG. 14 is a diagram of a frame format of a sequence configuration information element according to an embodiment of this disclosure;

FIG. 15 is a diagram of a structure of a communication apparatus according to an embodiment of this disclosure;

FIG. 16 is a diagram of a structure of a communication apparatus according to an embodiment of this disclosure; and

FIG. 17 is a diagram of another structure of a communication apparatus according to an embodiment of this disclosure.

### DESCRIPTION OF EMBODIMENTS

The following clearly describes the technical solutions in embodiments of this disclosure with reference to the accompanying drawings in embodiments of this disclosure.

In this disclosure, the terms “first”, “second”, and so on are intended to distinguish between different objects but do not indicate a particular order of the objects. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another step or unit inherent to the process, the method, the product, or the device.

In the descriptions of this disclosure, “at least one (item)” means one or more, “a plurality of” means two or more, and “at least two (items)” means two, three, or more. In addition, the term “and/or” is used for describing an association relationship between associated objects, and indicates that three relationships may exist. For example, “A and/or B” may indicate the following three cases: only A exists, only B exists, and both A and B exist, where A and B may be singular or plural. The character “/” generally indicates an “or” relationship between the associated objects. “At least one of the following items (pieces)” or a similar expression thereof means any combination of these items. For example, at least one (piece) of a, b, or c may indicate: a, b, c, a and b, a and c, b and c, or a, b, and c.

In this disclosure, the terms “example”, “for example”, or the like are used to indicate giving an example, an illustration, or a description. Any embodiment or design scheme described with “example”, “in an example”, or “for example” in this disclosure should not be explained as being more preferred or having more advantages than another embodiment or design scheme. To be precise, the terms “example”, “in an example”, “for example”, or the like are intended to present a related concept in a specific manner.

In this disclosure, an element indicated in a singular form is intended to indicate “one or more”, but does not indicate “one and only one”, unless otherwise specified.

It should be understood that, in embodiments of this disclosure, determining B based on A does not mean that B is determined only based on A, and B may also be determined based on A and/or other information.

The technical solutions provided in this disclosure are applicable to a UWB-based wireless personal area network (WPAN). For example, a method provided in this disclosure is applicable to the Institute of Electrical and Electronics Engineers (IEEE) 802.15 series protocols, for example, the 802.15.4a protocol, the 802.15.4z protocol, the 802.15.4ab protocol, or a future generation of UWB WPAN standard. Examples are not enumerated one by one herein. The method provided in this disclosure is further applied to various communication systems, for example, an Internet of things (IoT) system, vehicle-to-everything (V2X), a narrowband IoT (NB-IoT) system, and is applied to a device used in V2X, an IoT node, a sensor, or the like in the IoT, a smart camera, a smart remote control, and a smart water or electricity meter in smart home, a sensor in smart city, and the like. The method provided in this disclosure may be further applicable to an Long-Term Evolution (LTE) frequency division duplex (FDD) system, an LTE time division duplex (TDD) system, a Universal Mobile Telecommunication System (UMTS), a Worldwide Interoperability for Microwave Access (WIMAX) communication system, an LTE system, a 5th-generation (5G) communication system, a 6th-generation (6G) communication system, or the like.

UWB technologies are new wireless communication technologies, and transmit data through non-sinusoidal narrow pulses at a nanosecond level. Modulation is performed on impulse pulses with very steep rise and fall time. Therefore, the technologies occupy a wide spectral range, so that a signal has a bandwidth on the order of gigahertz (GHz). A UWB system has a very wide spectrum and very low average power spectral density. A UWB wireless communication system has advantages such as a strong multipath resolution capability, low power consumption, and high confidentiality. This helps the system coexist with another system, improving spectrum utilization and a system capacity. In addition, in short-range communication application, a transmit power of an UWB transmitter may usually be lower than 1 milliwatt (mW). Theoretically, interference generated by an UWB signal is only equivalent to white noise relative to a narrowband system. This helps good coexistence between the UWB and existing narrowband communication. Therefore, the UWB system and a narrowband (NB) communication system can simultaneously work without interference.

Although embodiments of this disclosure are mainly described by using a WPAN as an example, for example, a network used in the IEEE 802.15 series standards is used as an example for description. A person skilled in the art easily understands that, various aspects in this disclosure may be extended to another network using various standards or protocols, for example, a wireless local area network (WLAN), BLUETOOTH, high-performance radio LAN (HIPERLAN) (a wireless standard similar to the IEEE 802.11 standard, mainly used in Europe), a wide area network (WAN), or another network that is known currently or developed in the future. Therefore, regardless of a used coverage area and a used wireless access protocol, various aspects provided in this disclosure are applicable to any appropriate wireless network.

The method provided in this disclosure may be implemented by a communication apparatus in a wireless communication system. The communication apparatus may be an apparatus in a UWB system. For example, the communication apparatus may include but is not limited to a communication server, a router, a switch, a bridge, a computer, a mobile phone, and the like that support the UWB technologies. For another example, the communication apparatus may include user equipment (UE). The user equipment may include various handheld devices, vehicle-mounted devices (for example, an automobile or a component installed in the automobile), wearable devices, IoT devices, or computing devices that support the UWB technologies, or another processing device connected to a wireless modem, or the like. Examples are not enumerated one by one herein. For another example, the communication apparatus may include a central control point, for example, a personal local area network (PAN), or a PAN coordinator. The PAN coordinator or the PAN may be a mobile phone, a vehicle-mounted device, an anchor, a tag, a smart home, or the like. For another example, the communication apparatus may include a chip, and the chip may be disposed in a communication server, a router, a switch, a terminal device, or the like. Examples are not enumerated one by one herein. It may be understood that the foregoing descriptions about the communication apparatus are applicable to a first UWB device and a second UWB device in this disclosure.

In embodiments of this disclosure, the communication apparatus may include a hardware layer, an operating system layer running above the hardware layer, and an application layer running above the operating system layer. The hardware layer includes hardware such as a central processing unit (CPU), a memory management unit (MMU), and a memory (or a main memory). The operating system may be any one or more types of computer operating systems that implement service processing through a process, for example, a LINUX operating system, a UNIX operating system, an ANDROID operating system, an IOS operating system, or a WINDOWS operating system. The application layer includes applications such as a browser, an address book, word processing software, and instant messaging software. In addition, a specific structure of an execution body of the method provided in embodiments of this disclosure is not limited in embodiments of this disclosure, provided that communication can be performed according to the method provided in embodiments of this disclosure by running a program that records code of the method provided in embodiments of this disclosure.

For example, FIG. 1 is a diagram of a structure of a wireless communication system according to an embodiment of this disclosure. As shown in FIG. 1, the wireless communication system is a star topology structure. In this structure, a central control node (for example, a PAN coordinator in FIG. 1) may perform data communication with one or more other devices. FIG. 2 is a diagram of another structure of a wireless communication system according to an embodiment of this disclosure. As shown in FIG. 2, the wireless communication system is a point-to-point topology structure. In this structure, a central control node (for example, a PAN coordinator in FIG. 2) may perform data communication with one or more other devices, and other different devices may also perform data communication with each other. In FIG. 1 and FIG. 2, both a full function device and a reduced function device may be understood as a UWB device shown in this disclosure. The full function device is relative to the reduced function device. For example, the reduced function device cannot be a PAN coordinator. For another example, compared with the full function device, the reduced function device may have no coordination capability, or have a lower communication rate than that of the full function device. It may be understood that the PAN coordinator shown in FIG. 2 is merely an example, and other three full function devices shown in FIG. 2 may also be used as PAN coordinators, which are not shown one by one herein. It may be further understood that the full function device and the reduced function device shown in this disclosure are merely examples of a UWB device, and any device that can implement a UWB signal transmission method provided in this disclosure falls within the protection scope of this disclosure.

For ease of description, in this disclosure, a communication device that supports UWB technologies (or the 802.15 series protocols) is referred to as a UWB device. Details are not described in the following. It may be understood that the UWB device in this disclosure can support the 802.15 series protocols, for example, the 802.15.4ab standard or a next-generation standard of the 802.15.4ab, and can support other standard protocols (for example, the 802.11 series protocols), for example, a plurality of wireless local area network (wireless local area network, WLAN) standards of the 802.11 family such as the 802.11ax, 802.11ac, 802.11n, 802.11 g, 802.11b, 802.11a, 802.11be, and a next-generation standard of the 802.11be.

The following briefly describes some content, terms, or nouns related to this disclosure.

### 1. Requirements on a UWB Signal:

An UWB system has a relatively large bandwidth. Therefore, to reduce interference to another device when the UWB system operates, the Federal Communications Commission (FCC) imposes strict limitation on power spectral density of a UWB signal. According to the Code of Federal Regulations (CFR) in the United States, the following two rules are used:

Regulation 1: An average value of maximum power spectral density (PSD) of transmitted UWB signals within 1 millisecond (ms) cannot be greater than 41.3 decibel-milliwatts (dBm) per megahertz (MHz).

Regulation 2: A maximum power of the transmitted UWB signals in any 50 MHz bandwidth cannot exceed 1 milliwatt.

It may be understood that the regulation 1 limits total transmitted energy of the UWB signal within 1 millisecond (not exceeding 37 nanojoules (nJ) in a 500 MHz bandwidth).

### 2. Frame Format of the UWB Signal:

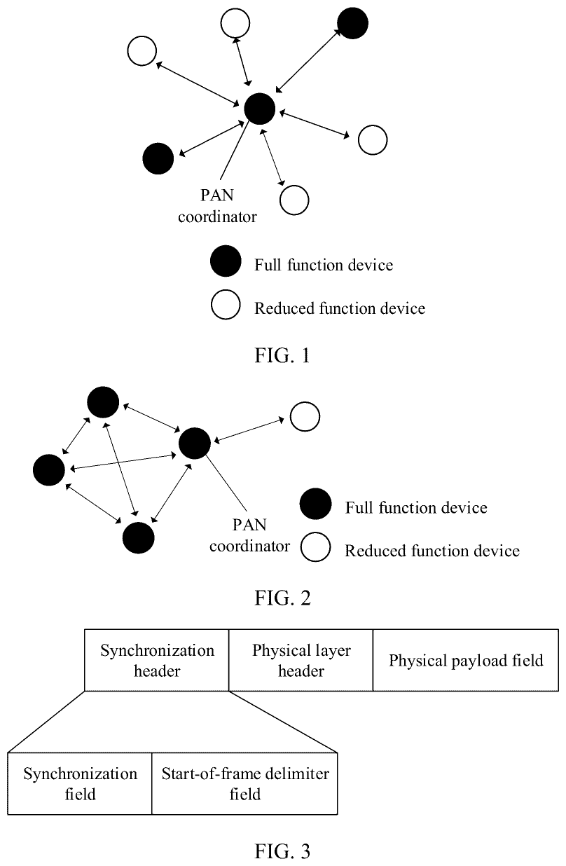

In the IEEE 802.15.4a and IEEE 802.15.4z standards, a frame format of a UWB signal is shown in FIG. 3. FIG. 3 is a diagram of a frame format of a UWB signal according to an embodiment of this disclosure. The UWB signal may include a synchronization header (SHR), a physical layer header (PHR), and a physical (PHY) payload field. For example, the synchronization header may include a frame synchronization (SYNC) field and a start-of-frame delimiter (SFD) field. The frame synchronization field may include a plurality of symbols, and the symbols are generated by a preamble sequence. For a specific generation manner, refer to an existing standard, for example, the 802.15.4a or 802.15.4z standard. The preamble sequence may be an Ipatov sequence with a length of 31, 127, or 91. The Ipatov sequence is a ternary sequence including three elements {−1, 0, 1}, and has a periodic correlation characteristic of a perfect sequence. For specific content of Ipatov sequences of different lengths, refer to the 802.15.4a and 802.15.4z standards. Details are not described herein.

### 3. Basic Principle of Ranging:

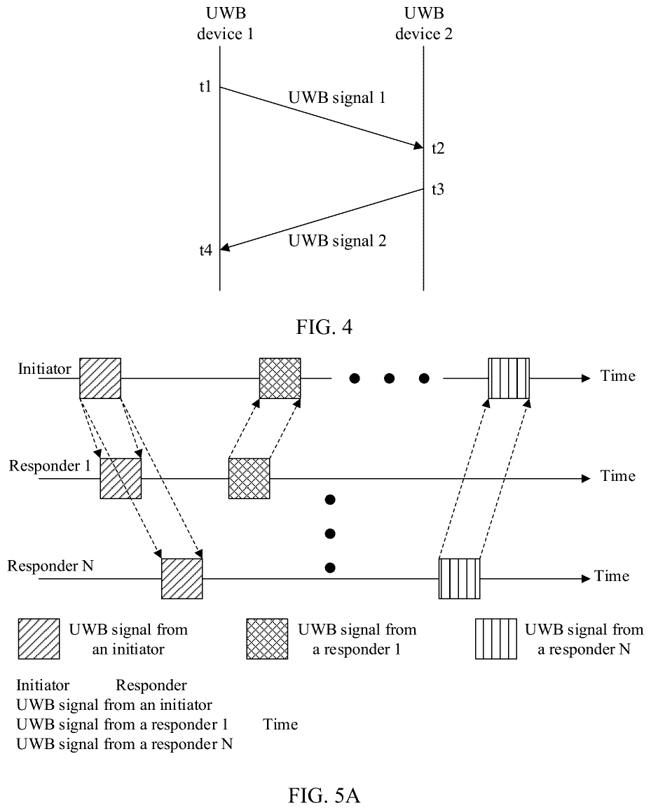

The basic principle of ranging is as follows. Two communication parties calculate a distance between the two communication parties by measuring round-trip time of a message. A ranging sequence sent by a transmitting end arrives at a receiving end after pulse shaping and modulation. The receiving end performs a correlation operation on the received ranging sequence and a locally stored sequence, and obtains time of arrival (namely, t2 and t4) based on a location of a correlation peak. FIG. 4 is a diagram of a ranging principle according to an embodiment of this disclosure. As shown in FIG. 4, a UWB device 1 sends a UWB signal 1 at a moment t1, and the UWB signal 1 arrives at a UWB device 2 at a moment t2 after being transmitted through a radio channel. After processing the received UWB signal, the UWB device 2 sends a UWB signal 2 to the UWB device 1 at a moment t3, and the UWB signal 2 arrives at the UWB device 1 at a moment t4 after being transmitted through a radio channel. The UWB signal is obtained by performing pulse shaping and modulation, for example, binary phase shift keying (BPSK), on a ranging sequence. The ranging sequence may be a preamble sequence, for example, an Ipatov sequence with a length of 31, 127, or 91.

A distance d between the UWB device 1 and the UWB device 2 may be calculated according to the following formulas (1-1), (1-2), and (1-3):

$$d = \frac{( {t}_{RTT} - {t}_{reply} )}{2} \times c \qquad ( 1 - 1 )$$

$${t}_{RTT} = ( t 4 - t 1 ) \qquad ( 1 - 2 )$$

$${t}_{reply} = ( t 3 - t 2 ) \qquad ( 1 - 3 )$$

c indicates a speed of light.

It should be understood that, when a signal is transmitted on a radio channel, the signal is reflected, diffracted, scattered, and the like by various obstacles, and is further affected by various noises. Consequently, when a signal sent by a transmitting end arrives at a receiving end, a waveform of the signal changes, but information or content carried by the signal does not change.

### 4. SS-TWR and DS-TWR:

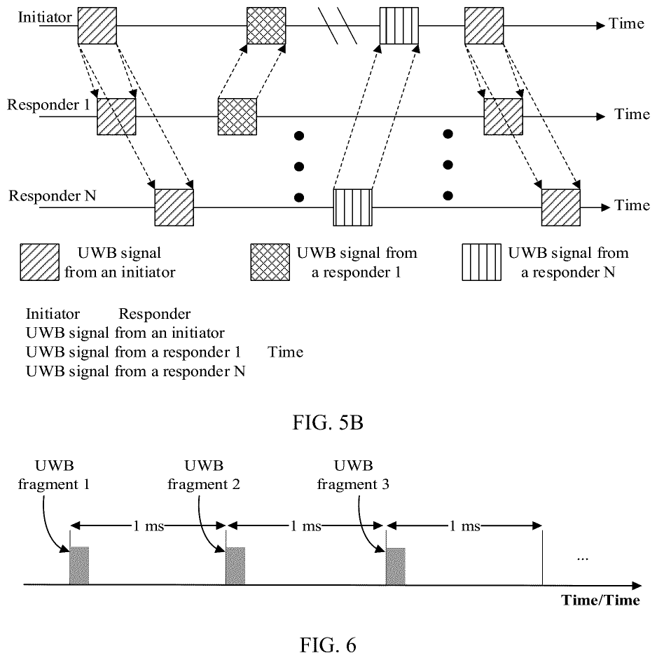

In the multi-node UWB ranging scenario, there are the following methods: SS-TWR and DS-TWR. FIG. 5A is a diagram of a SS-TWR process according to an embodiment of this disclosure. FIG. 5A shows a SS-TWR process between one node and a plurality of nodes, including one initiator and a plurality of responders. As shown in FIG. 5A, the SS-TWR process between the one node and the plurality of nodes includes the initiator that broadcasts a UWB signal. After receiving the UWB signal broadcast by the initiator, each responder replies, in a scheduling manner or a contention-based manner, to the UWB signal broadcast by the initiator. The initiator calculates time of flight (ToF) based on receiving time and sending time of the initiator and receiving time and sending time of different responders, to complete ranging. It should be understood that the SS-TWR process shown in FIG. 5A is merely an example, and there may be an SS-TWR between a plurality of nodes and a plurality of nodes. Details are not described one by one herein.

FIG. 5B is a diagram of a double-sided two-way ranging process according to an embodiment of this disclosure. FIG. 5B shows a DS-TWR process also between one node and a plurality of nodes, including one initiator and a plurality of responders. As shown in FIG. 5B, the DS-TWR process between the one node and the plurality of nodes includes the initiator that broadcasts a UWB signal. After receiving the UWB signal broadcast by the initiator, each responder replies, in a scheduling manner or a contention-based manner, to the UWB signal broadcast by the initiator. After receiving UWB signals replied by all responders, the initiator broadcasts one UWB signal again. After receiving the UWB signal broadcast by the initiator for the second time, each responder calculates ToF based on receiving time and sending time of the responder and receiving time and sending time of the initiator, to complete ranging. It should be understood that the DS-TWR process shown in FIG. 5B is merely an example, and there may be a DS-TWR between a plurality of nodes and a plurality of nodes. Details are not described one by one herein.

It may be understood that, because the UWB signal needs to satisfy the regulation 1 and regulation 2, a length of a single UWB signal is less than 1 ms, and total transmitted energy is less than 37 nJ. As a result, a signal-to-noise ratio (SNR) of a receiving end is limited, and measurement precision and a coverage area are limited. Although the UWB signal needs to satisfy the regulation 1 and the regulation 2, and the regulation 1 limits the total transmitted energy of the UWB signal within 1 millisecond (not exceeding 37 nJ in a 500 MHz bandwidth), an instantaneous power of a transmit signal may be increased by concentrating energy for transmission in shorter time, to increase the coverage area of the UWB signal and improve the signal-to-noise ratio of the signal received by the receiving end. Based on this, in some scenarios in which a transmit power needs to be increased, a UWB signal transmission method is shown in FIG. 6. FIG. 6 is a diagram of fragment transmission of a UWB signal according to an embodiment of this disclosure. As shown in FIG. 6, a transmitting end splits a to-be-transmitted UWB signal into a plurality of fragments, a time length of each UWB fragment signal is less than 1 millisecond, and only one UWB fragment is sent in each millisecond. Corresponding to fragment transmission of the UWB signal, a frame format of the UWB fragment signal may include only a frame SYNC field, and optionally include an SFD field. The UWB fragment signal does not include a data portion.

It may be understood that an instantaneous power of the UWB signal may be increased through fragment transmission, to increase a coverage area of the UWB signal and improve a signal-to-noise ratio of a signal received by a receiving end.

In this disclosure, a system that uses a fragment transmission mode (for example, a system that uses the 802.15.4ab protocol for transmission) shown in FIG. 6 is referred to as a multi-millisecond UWB system, and a system that does not use the fragment transmission mode (for example, a system that uses the 802.15.4a protocol and the 802.15.4z protocol for transmission) is referred to as a non-multi-millisecond UWB system or a UWB system.

For ease of subsequent description, in this disclosure, the UWB signal to be transmitted by the transmitting end is referred to as a “complete UWB signal”, and the fragment obtained by splitting the UWB signal (or fragment) is referred to as a “UWB fragment signal”. It should be understood that the “complete UWB signal” and the “UWB fragment signal” in this disclosure are relative, and the “UWB fragment signal” is understood as one fragment in the “complete UWB signal”. Certainly, if the “complete UWB signal” is split into only one fragment, the “complete UWB signal” is the same as the “UWB fragment signal”.

It can be learned from the SS-TWR process in FIG. 5A and the DS-TWR process in FIG. 5B that, after receiving the UWB signal broadcast by the initiator, the different responders reply to the UWB signal in the scheduling manner or the contention-based manner, that is, the different responders send the UWB signals at different moments. Then, to avoid missing UWB signals of the responders, the initiator needs to remain in a power-on state in an entire ranging process to receive the UWB signals of the responders, resulting in an increase in power consumption. In addition, to distinguish UWB signals from different devices in the SS-TWR and DS-TWR processes, the UWB signals sent by different devices are different. In this case, the initiator needs to perform a correlation operation on each received UWB signal, resulting in high complexity of the correlation operation and high power consumption.

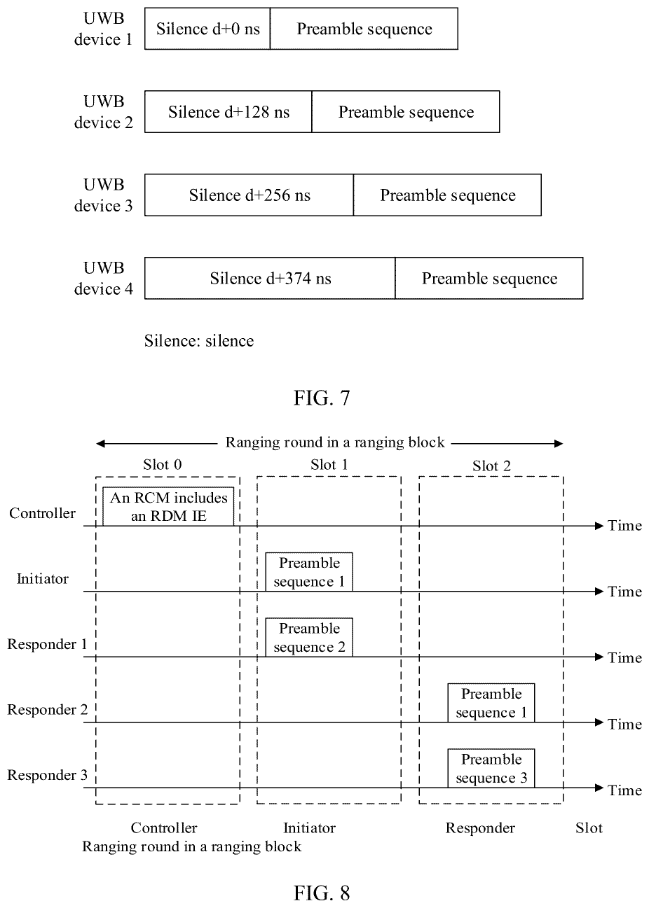

In a multi-device (or multi-node) simultaneous ranging method, a plurality of UWB devices use a same preamble sequence and perform transmission based on a pre-agreed delay. The method can reduce a time period in which the initiator remains in the power-on state in the SS-TWR and DS-TWR processes, reducing power consumption. FIG. 7 is a diagram of simultaneous ranging of a plurality of nodes according to this disclosure. As shown in FIG. 7, four UWB devices simultaneously perform ranging. A UWB device 1 directly sends a preamble sequence without a delay. A UWB device 2 delays 128 nanoseconds (ns) and then sends the preamble sequence. A UWB device 3 delays 256 nanoseconds and then sends the preamble sequence. A UWB device 4 delays 374 nanoseconds and then sends the preamble sequence. After detecting a signal, a receiving end performs a correlation operation on a local preamble sequence and the received sequence, to obtain correlation peaks, and calculates distances to complete ranging. “Silence d” in FIG. 7 indicates a start point of a delay, and start points of delays of the two UWB devices are the same. Although different UWB devices in this method have different delays, the delay is at a nanosecond level. Compared with a method in which an initiator needs to remain a power-on state in an entire ranging process (a time length is at a millisecond level) in SS-TWR and DS-TWR processes, this method reduces a time period in which an initiator retains a power-on state in SS-TWR and DS-TWR processes, and reduces power consumption. In addition, because a plurality of UWB devices in this method use a same preamble sequence, in this method, correlation peaks corresponding to all transmitting devices may be obtained by performing one correlation operation, reducing power consumption.

However, due to the delays, a UWB signal that first arrives may be from a transmitting device that is farthest away (assuming that a delay of the transmitting device is 0). Because the transmitting device is farthest away, signal energy of the transmitting device is the smallest. As a result, a receiving device may incorrectly determine the UWB signal as noise. In other words, it is difficult to determine a start time point of a related interval in this method. In addition, due to a distance difference between different transmitting devices and the receiving device and multipath effect, a delay between the different devices increases. As a result, a time length for the receiving end to perform a correlation operation increases, because a window size of the correlation operation remains unchanged, but a time length of a signal increases. In a multi-millisecond UWB system, this situation is more obvious because an increase percentage of a time length of the correlation operation is more obvious due to a very short time length of each UWB fragment signal, and impact of a delay and multipath effect. For example, it is assumed that the time length of each UWB fragment signal is 35 microseconds, and a window size of a correlation operation is also 35 microseconds. If there is no impact of the delay and multipath effect, a maximum time length of the correlation operation is 35 microseconds. When the delay is 128 nanoseconds, if 100 UWB devices simultaneously perform ranging, the time length of the correlation operation is 35+12.8-47.8 microseconds. In addition, due to a delay of the multipath effect, 128 nanoseconds are insufficient. In this case, the time length of the correlation operation is longer.

In a downlink time difference of arrival (DL-TDOA) scenario, a plurality of anchors simultaneously send UWB signals. Because there is no delay, a UWB signal that first arrives at a receiving end is from a transmitting device that is closest. Therefore, even if signal energy of a transmitting device that is farthest away is the smallest, the receiving end does not incorrectly determine this UWB signal as noise. In addition, a time length of a correlation operation can be reduced. In the DL-TDOA scenario, both an initiator and a responder are anchor devices. FIG. 8 is a diagram in which a plurality of anchors simultaneously send UWB signals according to this disclosure. As shown in FIG. 8, an initiator and a responder 1 simultaneously send different preamble sequences, and a responder 2 and a responder 3 simultaneously send different preamble sequences. After receiving a preamble sequence, a tag device needs to separately perform correlation operations on received UWB signals and different local preamble sequences, to obtain a correlation peak, to obtain a distance. Therefore, each tag device needs to perform a plurality of correlation operations in each slot, and complexity is high.

An embodiment of this disclosure provides a UWB signal transmission method. In the method, a UWB signal sent by each device is obtained by performing pulse shaping and modulation on a preamble sequence (namely, a first sequence in this disclosure) of each device. The preamble sequence of each device is obtained by performing a cyclic shift based on a same reference sequence (namely, a second sequence in this disclosure), and the number of cyclic shift bits of the cyclic shift performed by each device is determined based on a shift factor and a step size of the cyclic shift that are of the device. Therefore, each device needs to store only the reference sequence, and may generate the preamble sequence of the device through cyclic shift. In this way, storage space for storing a large number of sequences is reduced, and a receiving end can perform one correlation operation on all received UWB signals without a need to perform a plurality of correlation operations. This reduces a number of correlation operations performed by the receiving end, and reduces power consumption and complexity in a ranging process.

In addition, the method may be applied to a multi-node (or multi-device) simultaneous ranging scenario. In this scenario, because a plurality of devices in this embodiment of this disclosure may simultaneously send UWB signals, a receiving end does not need to remain in a power-on state in an entire ranging process. To be specific, when the device does not perform a transmission operation or a receiving operation, the device may remain sleep to save electric energy, to reduce power consumption of the receiving end. In addition, because there is no delay, a UWB signal that first arrives at a receiving end is from a transmitting device that is closest. Therefore, even if signal energy of a transmitting device that is farthest away is the smallest, the receiving end does not incorrectly determine this UWB signal as noise. In addition, a time length of a correlation operation can be reduced.

The following describes in detail the technical solutions provided in this disclosure with reference to more accompanying drawings.

For ease of clearly describing the technical solutions of this disclosure, this disclosure is described by using a plurality of embodiments. For details, refer to the following. In this disclosure, unless otherwise specified, for same or similar parts of embodiments or implementations, refer to each other. In embodiments of this disclosure and the implementations/methods/implementation methods in embodiments, unless otherwise specified or a logical conflict occurs, terms and/or descriptions are consistent and may be mutually referenced between different embodiments and between the implementations/methods/implementation methods in embodiments. Technical features in the different embodiments and the implementations/methods/implementation methods in embodiments may be combined to form a new embodiment, implementation, method, or implementation method based on an internal logical relationship thereof. The following implementations of this disclosure are not intended to limit the protection scope of this disclosure.

### Embodiment 1

Embodiment 1 of this disclosure mainly describes a manner of generating preamble sequences (namely, first sequences in this disclosure) of different devices in a ranging process.

Optionally, a method provided in this embodiment of this disclosure may be applied to all scenarios involving multi-node simultaneous ranging in a UWB system, including a multi-millisecond UWB system, a UWB system, a DL-TDOA system, and the like. For example, the method provided in this embodiment of this disclosure is applied to an SS-TWR scenario between one node and a plurality of nodes, a DS-TWR scenario between one node and a plurality of nodes, an SS-TWR scenario between a plurality of nodes and a plurality of nodes, a DS-TWR scenario between a plurality of nodes and a plurality of nodes, or a DL-TDOA scenario. When this embodiment of this disclosure is applied to the DL-TDOA scenario, in this embodiment of this disclosure, a second UWB device is an anchor device, and a first UWB device is a tag device. In other words, a plurality of anchor devices may simultaneously send UWB signals to the tag device in the DL-TDOA scenario.

Certainly, the method provided in this embodiment of this disclosure may also be applied to a ranging scenario between one node and one node.

Optionally, a sequence design in the following in this embodiment of this disclosure is mainly used in a preamble sequence design.

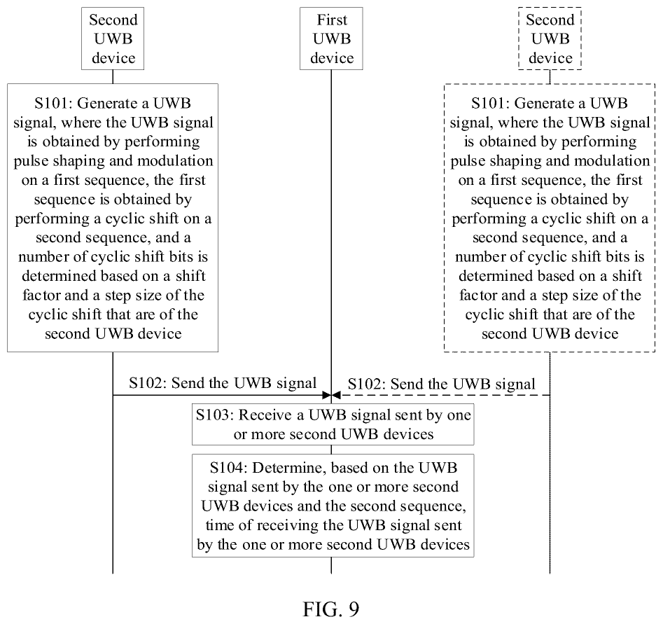

FIG. 9 is a schematic flowchart of a UWB signal transmission method according to an embodiment of this disclosure. The first UWB device and the second UWB device in the method may be any two devices that can perform data transmission in FIG. 1 or FIG. 2. As shown in FIG. 9, the UWB signal transmission method includes but is not limited to the following steps.

S101: The second UWB device generates a UWB signal, where the UWB signal is obtained by performing pulse shaping and modulation on a first sequence, the first sequence is obtained by performing a cyclic shift on a second sequence, and a number of cyclic shift bits is determined based on a shift factor and a step size of the cyclic shift that are of the second UWB device.

S102: The second UWB device sends the UWB signal.

Optionally, one or more second UWB devices generate a respective UWB signal, and the one or more second UWB devices simultaneously or concurrently send the UWB signal generated by the one or more second UWB devices. For example, the UWB signal may be one UWB fragment signal (for example, a UWB fragment 1, a UWB fragment 2, or a UWB fragment 3 in FIG. 6), or the UWB signal is one signal that is not fragmented, namely, one complete UWB signal. In other words, in this embodiment of this disclosure, a manner in which the second UWB device transmits the UWB signal may be fragment transmission, or may be non-fragment transmission, that is, the entire UWB signal is transmitted once. In other words, this embodiment of this disclosure may be applied to a multi-millisecond UWB system (for example, a system in which fragment transmission is performed in FIG. 6), a non-multi-millisecond UWB system (for example, a system in which transmission is performed by using the 802.15.4a protocol and the 802.15.4z protocol), and a DL-TDOA system. It may be understood that, if a fragment number of the UWB signal is 1, the UWB signal is one complete UWB signal.

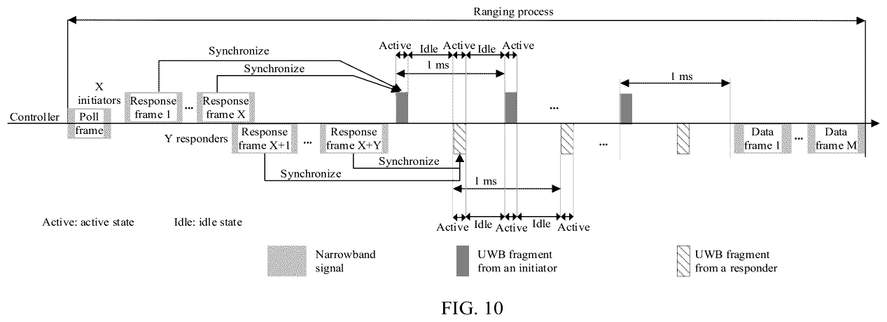

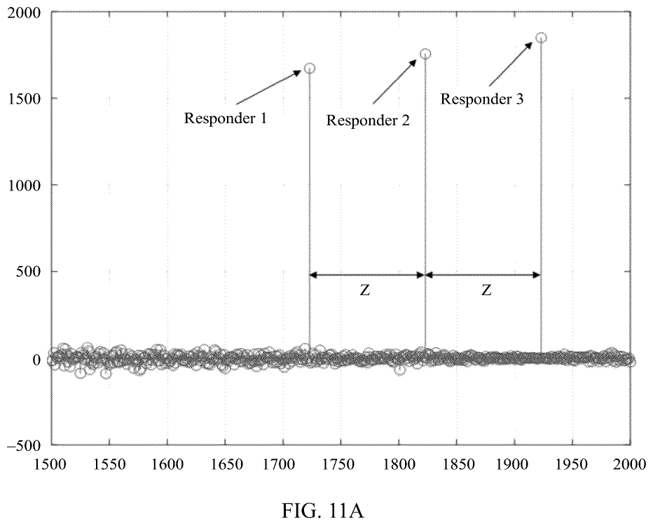

It should be understood that, in a multi-node ranging process in the multi-millisecond UWB system, regardless of SS-TWR or DS-TWR, the following scenarios exist. A plurality of initiators simultaneously broadcast UWB signals to responders, and the plurality of responders simultaneously reply to the initiators with a UWB signal. For example, the UWB signal is transmitted in fragments. FIG. 10 is a diagram in which a plurality of initiators or a plurality of responders simultaneously send UWB signals according to an embodiment of this disclosure. As shown in FIG. 10, X initiators simultaneously broadcast UWB fragments, and Y responders simultaneously reply with UWB fragments. When the X initiators simultaneously broadcast the UWB fragments, the X initiators are second UWB devices in this embodiment of this disclosure, and in this case, the responders are first UWB devices in this embodiment of this disclosure. When the Y responders simultaneously reply with the UWB fragments, the Y responders are second UWB devices in this embodiment of this disclosure, and in this case, the initiators are first UWB devices in this embodiment of this disclosure.

It should be understood that, although this embodiment of this disclosure uses the multi-node ranging process in the multi-millisecond UWB system as an example for description, the method provided in this embodiment of this disclosure is also applicable to a DL-TDOA scenario. In this scenario, a plurality of anchor devices simultaneously send UWB signals to a tag device. In this case, the anchor device is equivalent to the second UWB device in this embodiment of this disclosure, and the tag device is equivalent to the first UWB device in this embodiment of this disclosure.

The following describes the UWB signal. For ease of description, whether the UWB signal is a UWB fragment signal is not distinguished in the following.

Optionally, the UWB signal sent by the second UWB device may be obtained by performing pulse shaping and modulation (for example, BPSK) on the first sequence. The first sequence may be a preamble sequence, and the first sequence may be carried in a frame SYNC field of the UWB signal. For a specific carrying manner, refer to the 802.15.4a or 802.15.4z standard. An element of the first sequence includes at least one of 1, −1, or 0, where an element 0 indicates that there is no UWB pulse, an element 1 indicates a positive UWB pulse, and an element −1 indicates a negative UWB pulse. In other words, the element 1, −1, or 0 in the first sequence respectively corresponds to a positive pulse, a negative pulse, or no pulse of the UWB signal. It may be understood that the element 1 may indicate a positive pulse, or a negative pulse. Correspondingly, the element −1 indicates a negative pulse or a positive pulse. Whether the element 1 indicates a positive pulse or a negative pulse is not limited in this embodiment of this disclosure.

Optionally, the first sequence is obtained by performing the cyclic shift on the second sequence, and the number of cyclic shift bits is determined based on the shift factor and the step size of the cyclic shift that are of the second UWB device. For example, the number of cyclic shift bits is equal to a product of the shift factor and the step size of the cyclic shift. In this disclosure, shift factors of different UWB devices are different, and step sizes of cyclic shifts of different UWB devices may be the same or different. The second sequence may be a predefined sequence. The second sequence has a good periodic correlation characteristic, which is further reflected as follows. A ratio of a main lobe amplitude of autocorrelation of the second sequence to a side lobe amplitude of the autocorrelation of the second sequence is greater than or equal to a first threshold. For example, the first threshold may be 14 decibels (dB). The first sequence is obtained by performing the cyclic shift on the second sequence, and the cyclic shift does not change a periodic correlation characteristic of a sequence. Therefore, the first sequence also has a good periodic correlation characteristic. In other words, a ratio of a main lobe amplitude of autocorrelation of the first sequence to a side lobe amplitude of the autocorrelation of the first sequence is also greater than or equal to the first threshold.

Predefinition and presetting in this disclosure may be understood as definition, predefinition, storage, prestorage, pre-negotiation, pre-configuration, solidifying, pre-burning, or the like.

Optionally, before generating the UWB signal, the second UWB device may obtain a cyclic shift parameter of the second UWB device, where the cyclic shift parameter is used to determine the number of cyclic shift bits of the second UWB device. For example, the cyclic shift parameter may be the number of cyclic shift bits, or the cyclic shift parameter includes the shift factor, the step size of the cyclic shift, and the like. In an implementation, the second UWB device may locally obtain the cyclic shift parameter of the second UWB device. Optionally, the second UWB device may alternatively notify the first UWB device of the cyclic shift parameter of the second UWB device, so that the first UWB device determines, by using the cyclic shift parameter, time of receiving the UWB signal. A notification manner is described in the following Embodiment 2, and details are not described herein. In another implementation, the second UWB device receives sequence configuration information sent by the first UWB device, where the sequence configuration information includes cyclic shift parameters of one or more UWB devices, the one or more UWB devices include the second UWB device, and the one or more UWB devices support simultaneous sending of the UWB signal. For a specific implementation of the sequence configuration information, refer to related descriptions in the following Embodiment 2. Details are not described herein again.

Optionally, the step size of the cyclic shift may be determined based on a length of the second sequence and a number of devices that support simultaneous sending of UWB signals. For example, assuming that the length of the second sequence is indicated as N, the number of devices that support simultaneous sending of the UWB signals is indicated as M, and the step size of the cyclic shift is indicated as Z, the step size Z of the cyclic shift satisfies the following formula (2-1):

$$Z \leq ⌊ \frac{N}{M} ⌋ \qquad ( 2 - 1 )$$

└x┘ indicates rounding down x, and details are not described in the following.

Optionally, the step size of the cyclic shift may be determined based on a ranging range, a delay in a channel environment, and an average pulse repetition frequency. For example, assuming that a maximum ranging range is d, a speed of light is c, and a maximum time difference of arrival of the UWB signal is indicated as tₘₐₓ, tₘₐₓ satisfies the following formula (2-2):

$${t}_{max} = \frac{d}{c} \qquad ( 2 - 2 )$$

The step size of the cyclic shift is indicated as Z, the delay in the channel environment is indicated as delay_{channel}, and the average pulse repetition frequency is indicated as PRF. In this case, the step size Z of the cyclic shift satisfies the following formula (2-3):

$$Z \geq ( {t}_{max} + {delay}_{channel} ) \times PRF \qquad ( 2 - 3 )$$

Herein, the delay in the channel environment delay_{channel} is mainly caused by multipath effect. For a specific value, refer to definitions of different channel environments in a UWB standard.

In some scenarios, for example, in a scenario in which the number (namely, M) of devices that support simultaneous sending of the UWB signals is limited (or constrained), the step size Z of the cyclic shift may be determined by using the foregoing formula (2-1). In some other scenarios, for example, in a scenario in which the ranging range (namely, d) is limited (or constrained), the step size Z of the cyclic shift may be determined by using the foregoing formula (2-3). In some other scenarios, for example, in a scenario in which both the number (namely, M) of devices that support simultaneous sending of the UWB signals and the ranging range are limited (or constrained), the step size Z of the cyclic shift needs to satisfy both the foregoing formula (2-1) and the foregoing formula (2-3).

It may be understood that, the step size Z of the cyclic shift is determined by using the foregoing formula (2-3), to resolve incorrect determining and ambiguity (ambiguity) of a correlation peak location caused by a difference between distances from different UWB transmitting devices to a receiving device.

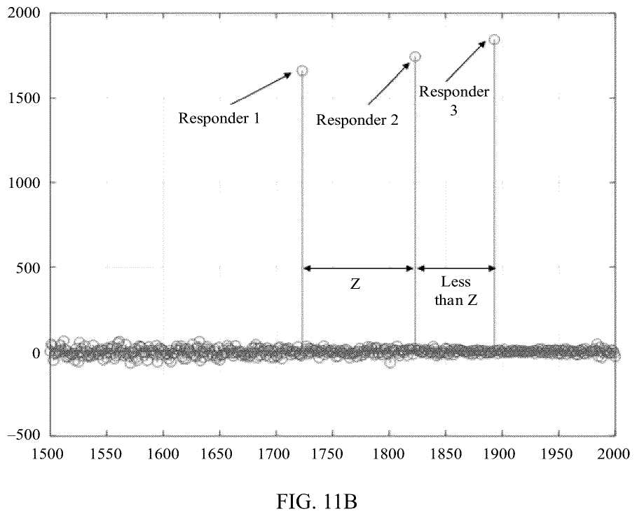

For example, FIG. 11A and FIG. 11B are diagrams of ambiguity of a correlation peak according to an embodiment of this disclosure. A horizontal coordinate indicates a sampling point, and a vertical coordinate indicates a correlation result. To improve display precision, both FIG. 11A and FIG. 11B show only some results obtained through a correlation operation. For example, FIG. 11A and FIG. 11B show correlation results from a 1500^{th} sampling point to a 2000^{th} sampling point on the horizontal coordinate. In FIG. 11A and FIG. 11B, it is assumed that three responders simultaneously transmit UWB signals to an initiator, a preamble sequence (namely, a first sequence) in a UWB signal of each responder is obtained by performing a cyclic shift on a second sequence, and different responders have different numbers of cyclic shift bits. Further, in FIG. 11A and FIG. 11B, it is assumed that step sizes of cyclic shifts of the three responders are all Z, a shift factor of a responder 1 is 2, a shift factor of a responder 2 is 1, and a shift factor of a responder 3 is 0. In other words, the responder 3 does not perform a cyclic shift, and the responder 2 and the responder 1 respectively perform cyclic shifts on the second sequence to the right by Z bits and 2Z bits. It should be understood that FIG. 11A and FIG. 11B are merely simple examples for describing the ambiguity of the correlation peak, and a length and a structure of the second sequence are not described in detail herein.

As shown in FIG. 11A, distances between the three responders and the initiator are the same. Therefore, the UWB signals of the three responders (the responder 1, the responder 2, and the responder 3) simultaneously arrive at the initiator. In this case, the initiator may obtain three correlation peaks by performing the correlation operation, which correspond to the three different responders respectively. Because the distances between the three responders and the initiator are the same, the responder 3 does not perform the cyclic shift, and the responder 2 and the responder 1 respectively perform the cyclic shifts on the second sequence to the right by the Z bits and the 2Z bits, an interval between the three correlation peaks is the same as the step size Z of the cyclic shift.

As shown in FIG. 11B, because a distance between the responder 1 and the initiator is the same as that between the responder 2 and the initiator, UWB signals of the responder 1 and the responder 2 simultaneously arrive. A distance between the responder 3 and the initiator is shorter than the distance between the responder 1 and the initiator and the distance between the responder 2 and the initiator. Therefore, a UWB signal of the responder 3 arrives before the UWB signals of the responder 1 and the responder 2. Therefore, if the step size of the cyclic shift is not sufficiently large, a correlation peak of the responder 3 may be before a correlation peak of the responder 2. As a result, the correlation peak of the responder 3 and the correlation peak of the responder 2 cannot be distinguished, that is, a correlation peak cannot accurately correspond to a responder. However, this case is considered in this embodiment of this disclosure. As shown in FIG. 11B, the step size Z of the cyclic shift determined in this embodiment of this disclosure is sufficiently large, so that the UWB signal of the responder 3 arrives before the UWB signals of the responder 1 and the responder 2, and the correlation peak of the responder 3 is not before the correlation peak of the responder 2. Three correlation peaks obtained by performing the correlation operation by the initiator respectively correspond to the three different responders. An interval between a correlation peak of the responder 1 and the correlation peak of the responder 2 is the same as the step size of the cyclic shift, an interval between the correlation peak of the responder 2 and the correlation peak of the responder 3 is shortened, and the UWB signal corresponding to the responder 3 arrives at the initiator before the UWB signal of the responder 2.

Therefore, in this embodiment of this disclosure, when the step size Z of the cyclic shift is selected, a sufficiently large step size needs to be selected, to avoid a case in which a correlation peak is incorrectly determined because the distances between the responders and the initiator are different. Refer to FIG. 11B. If an interval between the correlation peaks is insufficient, it is possible that the correlation peak corresponding to the responder 3 appears before the correlation peak corresponding to the responder 2. In this case, the initiator cannot correctly identify a correlation peak and a responder corresponding to the correlation peak.

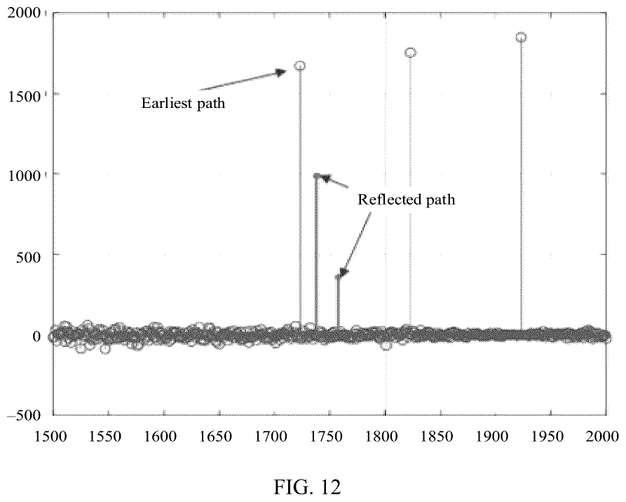

In addition, in this embodiment of this disclosure, when the step size Z of the cyclic shift is selected, multipath effect of the UWB signal further needs to be considered. FIG. 12 is a diagram of a correlation peak shown when multipath effect exists according to an embodiment of this disclosure. A horizontal axis indicates a sampling point, and a vertical axis indicates a correlation result. To improve display precision, FIG. 12 shows only some results obtained through a correlation operation. For example, FIG. 12 shows correlation results from a 1500^{th} sampling point to a 2000^{th} sampling point on the horizontal coordinate. As shown in FIG. 12, in a non-ideal state, there are several reflected paths after an earliest path of a UWB signal. A correlation peak in this embodiment of this disclosure usually means a correlation peak of an earliest path. Refer to FIG. 12. If a responder corresponding to a second correlation peak (for example, a fourth peak in FIG. 12) from left to right is far away from an initiator, energy of a UWB signal of the responder is relatively small when the UWB signal arrives at the initiator. In this case, energy of the second correlation peak obtained through a correlation operation is relatively small, and the second correlation peak may be incorrectly determined as a reflected path of a first earliest path. Therefore, a margin needs to be reserved when the step size Z of the cyclic shift is selected, to ensure that an interval between correlation peaks between earliest paths is sufficiently large, so that the reflected path does not interfere with determining of the earliest path.

It may be understood that, in this embodiment of this disclosure, a compromise between the number M of devices that support simultaneous sending of UWB signals, the ranging range d, and the multipath effect is adjusted, so that ambiguity in a ranging process can be resolved, and incorrect determining of a correlation peak location can be reduced.

Optionally, in this embodiment of this disclosure, a plurality of second UWB devices may simultaneously or concurrently send UWB signals, and each second UWB device may perform a cyclic shift on a second sequence to obtain a preamble sequence (namely, a first sequence) of the second UWB device. However, to distinguish between UWB signals sent by different UWB devices, the number M of devices that support simultaneous sending of the UWB signals cannot be infinite. Therefore, when the length of the second sequence is known as N, the step size Z of the cyclic shift, the number M of devices that support simultaneous sending of the UWB signals, and N satisfy the following relationship:

$$M = ⌊ \frac{N}{Z} ⌋ \qquad ( 2 - 4 )$$

In this embodiment of this disclosure, because different UWB devices may perform the cyclic shift on a same sequence (namely, the second sequence) to obtain preamble sequences (namely, first sequences) of the UWB devices, each UWB device only needs to store the second sequence, and can generate a preamble sequence of the UWB device by performing the cyclic shift. This reduces storage space for storing a large number of sequences.

S103: The first UWB device receives the UWB signal sent by the one or more second UWB devices.

S104: The first UWB device determines, based on the UWB signal sent by the one or more second UWB devices and the second sequence, time of receiving the UWB signal sent by the one or more second UWB devices.

Optionally, the first UWB device receives the UWB signal simultaneously sent by the one or more second UWB devices, and may perform a correlation operation on the second sequence locally stored in the first UWB device and the received UWB signal (there may be a plurality of UWB signals herein), to obtain locations of one or more correlation peaks. It may be understood that a number of correlation peaks obtained through the correlation operation is equal to a number of devices that simultaneously send the UWB signal (namely, a number of received UWB signals). In other words, the one or more correlation peaks correspond to the one or more second UWB devices, and one correlation peak corresponds to one second UWB device. The first UWB device may further obtain cyclic shift parameters (including numbers of cyclic shift bits, or including shift factors and step sizes of cyclic shifts) of the one or more second UWB devices, and then determine, based on the locations of the one or more correlation peaks and a number of cyclic shift bits of each second UWB device, time of arrival of a UWB signal sent by each second UWB device.

For example, it is assumed that the length of the second sequence is 1893. Refer to FIG. 11A. A horizontal coordinate of a correlation peak of the responder 2 is at a 1823^{rd} sampling point. In this example, a first sequence of the responder 2 is obtained by performing the cyclic shift on the second sequence to the right by 100 bits. Then, if the responder 2 does not perform the cyclic shift, a correlation peak of a UWB signal sent by the responder 2 should be at a [1923^{rd} (1823+100)] sampling point. If a sampling rate is 256 MHz, a time interval of each sampling point is 1/256M seconds. Theoretically, if a receiving end and a transmitting end are completely synchronized, a peak value should appear at a 1893^{rd} sampling point (because the length of the second sequence is 1893). Therefore, the time of arrival of the UWB signal sent by the responder 2 is equal to (1923−1893)*( 1/256M) seconds. It may be understood that, if the first sequence of the responder 2 is obtained by performing the cyclic shift on the second sequence to the left by 100 bits, a correlation peak obtained by performing the correlation operation on the UWB signal sent by the responder 2 is at a 2023^{rd} sampling point. Then, if the responder 2 does not perform the cyclic shift, a correlation peak of the UWB signal sent by the responder 2 should be at a [1923^{rd} (2023−100)] sampling point. However, theoretically, if the receiving end and the transmitting end are completely synchronized, the peak value should appear at the 1893^{rd} sampling point (because the length of the second sequence is 1893), that is, the time of arrival of the UWB signal sent by the responder 2 is equal to (1923−1893)*( 1/256M) seconds.

For specific implementation of the correlation operation, refer to other approaches. Details are not described in this embodiment of this disclosure. It should be understood that an object of the correlation operation may be a signal or a sequence. To be specific, that the first UWB device performs a correlation operation on the second sequence locally stored in the first UWB device and the received UWB signal includes the following. The first UWB device performs the correlation operation on the second sequence locally stored in the first UWB device and a sequence obtained by demodulating and/or decoding the received UWB signal, or the first UWB device performs pulse shaping and modulation on the second sequence locally stored in the first UWB device, to generate a signal, and then performs the correlation operation on the generated signal and the received UWB signal.

Optionally, the first UWB device obtains the cyclic shift parameters of the one or more second UWB devices in two manners. In one implementation, the cyclic shift parameters of the one or more second UWB devices are configured by the first UWB device, and the first UWB device may locally obtain the cyclic shift parameters of the one or more second UWB devices. For a manner in which the first UWB device configures the cyclic shift parameters for the one or more second UWB devices, refer to related descriptions in the following Embodiment 2. Details are not described herein again. In the other implementation, the first UWB device receives sequence configuration information sent by a specific second UWB device, where the sequence configuration information includes the cyclic shift parameters of the one or more second UWB devices. For a specific implementation of the sequence configuration information, refer to related descriptions in the following Embodiment 2. Details are not described herein again.

In this embodiment of this disclosure, the different UWB devices may perform the cyclic shift on the same sequence (namely, the second sequence) to obtain the preamble sequences (namely, the second sequences) of the UWB devices, generate respective UWB signals based on the respective second sequences of the UWB devices, and simultaneously send the UWB signals. Therefore, the receiving end can perform one correlation operation on a plurality of received UWB signals without a need to perform a plurality of correlation operations. This reduces a number of correlation operations, and reduces power consumption. It may be understood that, if the UWB signal in this embodiment of this disclosure is transmitted in fragments, the receiving end needs to perform only one correlation operation in each 1-millisecond time period, reducing complexity.

In addition, because the plurality of UWB devices in this embodiment of this disclosure may simultaneously send the UWB signals, the receiving end does not need to remain in a power-on state in an entire ranging process. To be specific, when the device does not perform a transmission operation or a receiving operation, the device may remain sleep to save electric energy, to reduce power consumption of the receiving end.

The following describes in detail the second sequence (or a base sequence or a reference sequence) provided in this embodiment of this disclosure.

### 1. Length of the Second Sequence:

The length of the second sequence is less than or equal to a maximum number of pulses contained in a reference UWB signal. Optionally, the length of the second sequence may be as close as possible to the maximum number of pulses contained in the reference UWB signal. It may be understood that, it can be learned from the foregoing formula (2-4) that a larger length N of the second sequence indicates a larger number of devices that support simultaneous sending of UWB signals. Therefore, in this embodiment of this disclosure, the length N of the second sequence is constrained to be less than but as close as possible to the maximum number of pulses contained in the reference UWB signal. This can increase the number of devices that support simultaneous sending of the UWB signals, and improve related performance.

For example, the maximum number of pulses contained in the reference UWB signal is equal to a product of duration of the reference UWB signal and an average pulse repetition frequency. For example, the reference UWB signal may be a UWB fragment signal. It may be understood that, if the reference UWB signal is a UWB fragment signal, the UWB signal generated by the second UWB device is also a UWB fragment signal. On the contrary, if the reference UWB signal is a complete UWB signal, the UWB signal generated by the second UWB device is also a complete UWB signal. When the reference UWB signal is a UWB fragment signal, duration of the reference UWB signal is equal to a value of total duration of the complete UWB signal divided by a fragment number. It may be understood that when the fragment number is 1, the reference UWB signal is a complete UWB signal.

The following Table 1 shows a possible configuration of a maximum number of pulses contained in each UWB fragment signal. Certainly, there may be another configuration, which is not listed one by one herein. A symbol “/” in Table 1 indicates a meaning of “or”. As shown in Table 1, different configurations have different fragment numbers of the UWB signal. This results in different fragment duration.

TABLE 1

| | Configuration | | | | |
|---|---|---|---|---|---|
| | Configuration | Configuration | Configuration | Configuration | Configuration |
| | 1 | 2 | 3 | 4 | 5 |
| Total duration | 1000 | 1000 | 1000 | 1000 | 1000 |
| (microsecond) | | | | | |
| Fragment | 32 | 16 | 8 | 4 | 2 |
| number of a | | | | | |
| UWB signal | | | | | |
| Duration of | 31.25 | 62.5 | 125 | 250 | 500 |
| each UWB | | | | | |
| signal | | | | | |
| fragment | | | | | |
| (microsecond) | | | | | |
| Average pulse | 64/256 | 64/256 | 64/256 | 64/256 | 64/256 |
| repetition | | | | | |
| frequency | | | | | |
| (MHz) | | | | | |
| Maximum | 2000/8000 | 4000/16000 | 8000/32000 | 16000/64000 | 32000/128000 |
| number of | | | | | |
| pulses | | | | | |
| contained in | | | | | |
| each UWB | | | | | |
| signal | | | | | |
| fragment | | | | | |
| Total number | 64000/256000 | 64000/256000 | 64000/256000 | 64000/256000 | 64000/256000 |
| of pulses | | | | | |

The total duration in Table 1 means total duration of one complete UWB signal. The configuration of the total duration 1000 microseconds is based on the 802.15.4z standard, and the total duration may be adjusted. Generally, the fragment number of the UWB signal is an exponent of 2. This configuration can also be adjusted. The duration of each UWB signal fragment is equal to a value of the total duration divided by the fragment number of the UWB signal. For setting of the average pulse repetition frequency, see the 802.15.4a and 802.15.4z protocols or the 802.15.4ab protocol. The configuration can be adjusted. The maximum number of pulses contained in each UWB signal fragment is equal to a product of the duration of each UWB signal fragment and the average pulse repetition frequency. Therefore, when one or more of the total duration, the fragment number of the UWB signal, and the average pulse repetition frequency change, the maximum number of pulses contained in each UWB signal fragment also changes correspondingly. A total number of pulses is equal to a product of the maximum number of pulses contained in each UWB signal fragment and the fragment number of the UWB signal.

It should be understood that values of the parameters in Table 1 are merely examples. In actual application, the parameters only need to satisfy the relationship described in the foregoing paragraph.

It should be further understood that the maximum number of pulses contained in the reference UWB signal is equivalent to the maximum number of pulses contained in each UWB signal fragment in Table 1.

### 2. Periodic Correlation Characteristic of the Second Sequence:

The second sequence has good autocorrelation and cross-correlation characteristics, and the second sequence has a good periodic correlation characteristic. Autocorrelation and cross-correlation characteristics (or the periodic correlation characteristic) of the second sequence are represented as follows. The ratio of the main lobe amplitude (or main lobe energy) of the autocorrelation of the second sequence to the side lobe amplitude (or side lobe energy) of the autocorrelation of the second sequence is greater than or equal to the first threshold. For example, the first threshold is 14 dB. The second sequence may further satisfy one or more of the following conditions. The main lobe amplitude (or the main lobe energy) of the autocorrelation of the second sequence is greater than or equal to a second threshold, the side lobe amplitude (or the side lobe energy) of the autocorrelation of the second sequence is less than or equal to a third threshold, or a ratio of the main lobe amplitude (or the main lobe energy) of the autocorrelation of the second sequence to a main lobe amplitude (or main lobe energy) of cross-correlation of the second sequence is greater than or equal to a fourth threshold. The first threshold to the fourth threshold may be preset values. For example, the second threshold is N−200. For example, the third threshold is 100. For example, the fourth threshold is 14 dB. N is the length of the second sequence. Optionally, the main lobe amplitude (or the main lobe energy) of the autocorrelation of the second sequence may alternatively be equal to a number of non-zero elements in the second sequence.

It should be understood that the autocorrelation of the second sequence means cross-correlation between a specific bit in the second sequence and the bit in the second sequence at different time points. The cross-correlation of the second sequence means a degree of correlation between the second sequence and another sequence at different time points. The main lobe may be understood as a peak value in an autocorrelation function or a cross-correlation function, and an amplitude other than the main lobe may be referred to as a side lobe or a side-lobe. For example, the main lobe may correspond to the amplitude peak of the autocorrelation function or the cross-correlation function.

### 3. Second Sequence Constructing Method and Examples

An element of the second sequence includes at least one of 1, −1, or 0. For example, the element of the second sequence includes 1 and −1, or the element of the second sequence includes 1, −1, and 0. The following Table 2 uses an Ipatov sequence as an example to construct the second sequence. The Ipatov sequence is a perfect ternary sequence, and a length of the Ipatov sequence may be indicated as:

$$\frac{{q}^{2 k + 1} - 1}{q - 1} ,$$

q is a power of a prime number, and k is a positive integer. The following Table 2 shows constructing a second sequence that satisfies a length requirement by using the Ipatov sequence.

TABLE 2

| Maximum number | | |
|---|---|---|
| of pulses contained | Length of | |
| in each UWB | a second | |
| signal fragment | sequence | Construction description |
| 2000 | 1893 | Directly select an Ipatov sequence with a length of 1893, |
| | | where parameters of the Ipatov sequence are as follows: |
| | | q = 43 and k = 1. |
| 4000 | 3991 | Generate the second sequence by combining an Ipatov |
| | | sequence with a length of 13 (parameters of the Ipatov |
| | | sequence are as follows: q = 3 and k = 1) with an Ipatov |
| | | sequence with a length of 307 (parameters of the Ipatov |
| | | sequence are as follows: q = 17 and k = 1). A combination |
| | | manner is as follows: first, repeating the Ipatov |
| | | sequence with the length of 13 for 307 times, second, |
| | | repeating the Ipatov sequence with the length of 307 for |
| | | 13 times, and finally, multiplying the two Ipatov |
| | | sequences obtained through repetition based on |
| | | elements, to obtain the constructed second sequence. |
| 8000 | 7651 | Generate the second sequence by combining an Ipatov |
| | | sequence with a length of 7 (parameters of the Ipatov |
| | | sequence are as follows: q = 2 and k = 1) with an Ipatov |
| | | sequence with a length of 1093 (parameters of the |
| | | Ipatov sequence are as follows: q = 3 and k = 3). A |
| | | combination manner is as follows: first, repeating the |
| | | Ipatov sequence with the length of 7 for 1093 times, |
| | | second, repeating the Ipatov sequence with the length of |
| | | 1093 for 7 times, and finally, multiplying the two Ipatov |
| | | sequences obtained through repetition based on |
| | | elements, to obtain the constructed second sequence. |
| 16000 | 15897 | Generate the second sequence by combining an Ipatov |
| | | sequence with a length of 21 (parameters of the Ipatov |
| | | sequence are as follows: q = 4 and k = 1) with an Ipatov |
| | | sequence with a length of 757 (parameters of the Ipatov |
| | | sequence are as follows: q = 27 and k = 1). A combination |
| | | manner is as follows: first, repeating the Ipatov |
| | | sequence with the length of 21 for 757 times, second, |
| | | repeating the Ipatov sequence with the length of 757 for |
| | | 21 times, and finally, multiplying the two Ipatov |
| | | sequences obtained through repetition based on |
| | | elements, to obtain the constructed second sequence. |
| 32000 | 31863 | Generate the second sequence by combining an Ipatov |
| | | sequence with a length of 13 (parameters of the Ipatov |
| | | sequence are as follows: q = 3 and k = 1) with an Ipatov |
| | | sequence with a length of 2451 (parameters of the |
| | | Ipatov sequence are as follows: q = 49 and k = 1). A |
| | | combination manner is as follows: first, repeating the |
| | | Ipatov sequence with the length of 13 for 2451 times, |
| | | second, repeating the Ipatov sequence with the length of |
| | | 2451 for 13 times, and finally, multiplying the two |
| | | Ipatov sequences obtained through repetition based on |
| | | elements, to obtain the constructed second sequence. |
| 64000 | 63583 | Generate the second sequence by combining an Ipatov |
| | | sequence with a length of 871 (parameters of the Ipatov |
| | | sequence are as follows: q = 29 and k = 1) with an Ipatov |
| | | sequence with a length of 73 (parameters of the Ipatov |
| | | sequence are as follows: q = 8 and k = 1). A combination |
| | | manner is as follows: first, repeating the Ipatov |
| | | sequence with the length of 871 for 73 times, second, |
| | | repeating the Ipatov sequence with the length of 73 for |
| | | 871 times, and finally, multiplying the two Ipatov |
| | | sequences obtained through repetition based on |
| | | elements, to obtain the constructed second sequence. |
| 128000 | 127897 | Generate the second sequence by combining an Ipatov |
| | | sequence with a length of 121 (parameters of the Ipatov |
| | | sequence are as follows: q = 3 and k = 2) with an Ipatov |
| | | sequence with a length of 1057 (parameters of the |
| | | Ipatov sequence are as follows: q = 32 and k = 1). A |
| | | combination manner is as follows: first, repeating the |
| | | Ipatov sequence with the length of 121 for 1057 times, |
| | | second, repeating the Ipatov sequence with the length of |
| | | 1057 for 121 times, and finally, multiplying the two |
| | | Ipatov sequences obtained through repetition based on |
| | | elements, to obtain the constructed second sequence. |

It may be understood that the second sequence designed in Table 2 belongs to a ternary Ipatov sequence, and the element of the second sequence include 0, 1, and −1. 0 indicates that there is no UWB pulse, 1 indicates a positive UWB pulse, and −1 indicates a negative UWB pulse. For the second sequence designed in Table 2, cyclic shift is performed on the second sequence in a direction (to the left or the right), to obtain another Ipatov sequence (namely, the foregoing first sequence). Therefore, based on a second sequence of a specific length, the different UWB devices perform different cyclic shifts, to construct a preamble sequence (the foregoing first sequence) of the UWB device. A number of cyclic shift bits is determined based on the number of devices that support simultaneous sending of the UWB signals, the ranging range, and the multipath effect. For details, refer to the foregoing description. Details are not described herein again. Therefore, after receiving the simultaneously transmitted UWB signal, the receiving end needs to perform only one correlation operation to obtain correlation peaks of all the transmitting devices, reducing complexity of the correlation operation.

It may be further understood that in some configurations, for example, the configuration 4 and the configuration 5 in Table 1, the second sequence to be designed is very long. In this case, a shorter sequence may be repeated to obtain the second sequence. For example, a second sequence with a length of less than or equal to 16000 (the length of the second sequence is as close as possible to 16000) needs to be generated in the configuration 4 of Table 1. In this case, a sequence with a length of 3991 in the configuration 2 may be repeated for four times. In this case, during a cyclic shift, the cyclic shift is performed on the sequence with the length of 3991, and then the sequence is repeated. In addition, a value of N in the foregoing formula (2-1) and formula (2-4) is 3991.

Because the second sequence in this embodiment of this disclosure is a newly designed sequence, and the preamble sequence (namely, the foregoing first sequence) is obtained by performing the cyclic shift on the second sequence, the preamble sequence in this embodiment of this disclosure is also a newly designed sequence. Therefore, for a UWB device (namely, a UWB device defined in the 802.15.4a and 802.15.4z protocols), the preamble sequence in this embodiment of this disclosure does not cause confusion to the UWB device (because the UWB device cannot understand the preamble sequence designed in this embodiment of this disclosure).

Table 2 shows a manner of constructing the second sequence by using the Ipatov sequence. Actually, there are many manners of constructing the second sequence, and only examples are provided herein for description. The following describes specific sequences used in Table 2 and several second sequences constructed in other manners. It should be understood that sequences provided in this specification are merely examples, and any sequence that satisfies at least either the constrained sequence length in 1 or the constrained periodic correlation characteristic in 2 falls within the protection scope of embodiments of this disclosure.

The following Table 3 shows Ipatov sequences involved in the foregoing Table 2.

TABLE 3

| Ipatov sequence | | |
|---|---|---|
| length | Ipatov sequence | |
| 7 | −1 | 1 1 0 1 0 0 |
| 13 | 0 | 0 −1 0 −1 −1 −1 1 1 0 |
| | | −1 1 −1 |
| 21 | 1 | 1 1 1 1 −1 1 0 1 0 |
| | | −1 1 1 −1 0 0 1 −1 0 |
| | | −1 −1 |
| 73 | −1 | 0 0 1 0 1 1 1 0 1 |
| | | 1 −1 1 −1 1 −1 0 1 1 |
| | | 1 1 −1 −1 1 1 −1 −1 −1 |
| | | 1 −1 −1 −1 0 1 1 −1 1 |
| | | 0 1 1 1 1 −1 −1 −1 1 |
| | | 1 −1 1 −1 −1 −1 −1 1 −1 |
| | | 0 1 1 −1 1 −1 −1 −1 1 |
| | | 0 1 1 −1 1 1 −1 1 1 |
| 121 | −1 | 0 0 0 1 −1 0 0 1 0 |
| | | −1 0 1 1 −1 −1 1 −1 0 |
| | | 1 0 0 −1 1 1 0 −1 0 |
| | | −1 1 −1 −1 −1 0 0 1 1 |
| | | −1 0 1 −1 0 −1 1 0 −1 |
| | | −1 0 1 −1 1 −1 1 0 0 |
| | | 0 0 1 0 0 0 1 1 0 |
| | | 0 1 −1 1 0 1 0 0 1 |
| | | 1 1 0 1 −1 −1 1 1 0 |
| | | 1 0 −1 1 1 1 −1 0 −1 |
| | | −1 0 −1 −1 1 −1 −1 1 0 |
| | | 0 1 0 1 0 1 1 1 1 |
| | | 1 −1 −1 −1 −1 0 1 1 1 |
| | | −1 1 −1 |
| 307 | −1 | 0 1 −1 1 −1 1 −1 1 1 |
| | | −1 −1 −1 0 −1 −1 −1 0 1 |
| | | −1 1 1 −1 −1 −1 1 −1 −1 |
| | | −1 1 1 −1 −1 1 1 1 1 |
| | | −1 −1 −1 1 0 1 1 1 −1 |
| | | 1 −1 −1 −1 1 −1 1 −1 −1 |
| | | −1 −1 −1 1 −1 1 −1 1 1 |
| | | 1 1 1 −1 1 1 −1 −1 −1 |
| | | 0 1 −1 1 1 −1 1 1 1 |
| | | −1 0 −1 −1 −1 1 1 −1 −1 |
| | | −1 1 1 1 1 −1 −1 −1 1 |
| | | 1 −1 1 −1 −1 1 0 −1 1 |
| | | −1 −1 −1 1 1 −1 1 −1 1 |
| | | 1 −1 1 1 1 −1 −1 1 1 |
| | | −1 −1 1 −1 −1 1 1 1 −1 |
| | | 1 −1 1 1 −1 1 1 1 1 |
| | | 1 −1 1 1 1 1 −1 −1 1 |
| | | 1 −1 1 −1 1 −1 1 1 1 |
| | | 1 1 1 −1 1 1 −1 −1 1 |
| | | 1 −1 1 1 −1 0 −1 −1 −1 |
| | | −1 −1 0 1 −1 1 −1 1 1 |
| | | 1 0 0 1 0 1 1 1 1 |
| | | 1 −1 1 −1 1 −1 1 1 1 |
| | | −1 −1 1 1 1 −1 1 1 −1 |
| | | −1 −1 −1 −1 0 −1 −1 −1 1 |
| | | 1 1 0 −1 1 −1 1 −1 −1 |
| | | 1 1 −1 −1 −1 −1 0 −1 −1 |
| | | −1 1 0 −1 1 −1 1 1 1 |
| | | −1 1 −1 −1 −1 1 1 1 1 |
| | | 1−1 1 1 −1 0 1 −1 1 |
| | | 1−1 1 −1 −1 1 −1 1 1 |
| | | −1 1 1 1 −1 −1 −1 −1 1 |
| | | 0 1 1 1 1 −1 −1 1 −1 |
| | | 1 1 1 1 −1 −1 −1 1 1 |
| 757 | 0 | 1 −1 1 −1 −1 −1 −1 −1 1 |
| | | 1 1 −1 1 1 −1 1 −1 −1 |
| | | 1 −1 −1 −1 1 −1 1 1 1 |
| | | −1 1 1 −1 −1 1 −1 0 −1 |
| | | 1 1 1 1 −1 1 −1 −1 −1 |
| | | −1 −1 1 −1 1 −1 −1 1 −1 |
| | | −1 −1 1 −1 1 −1 −1 −1 −1 |
| | | 1 1 −1 −1 −1 1 −1 −1 −1 |
| | | 1 −1 1 −1 1 1 1 −1 1 |
| | | 1 −1 −1 −1 −1 1 0 −1 1 |
| | | −1 −1 −1 −1 1 −1 1 1 1 |
| | | −1 1 −1 1 1 0 −1 −1 −1 |
| | | −1 1 1 −1 1 1 1 1 1 |
| | | 1 −1 1 1 −1 −1 0 1 1 |
| | | 1 −1 −1 1 1 −1 −1 1 −1 |
| | | 1 1 −1 1 −1 −1 −1 −1 1 |
| | | 1 −1 −1 −1 1 1 −1 1 −1 |
| | | −1 0 −1 −1 1 1 −1 −1 −1 |
| | | 1 1 −1 1 1 −1 −1 1 1 |
| | | −1 −1 −1 −1 −1 1 0 1 −1 |
| | | 1 0 −1 −1 −1 −1 −1 0 −1 |
| | | 1 −1 1 −1 −1 1 1 −1 −1 |
| | | −1 1 −1 0 0 −1 −1 −1 1 |
| | | −1 −1 −1 −1 1 −1 1 −1 −1 |
| | | 1 −1 1 1 −1 −1 −1 −1 1 |
| | | −1 1 −1 1 −1 1 −1 1 1 |
| | | 1 −1 1 1 1 −1 1 1 1 |
| | | 1 1 1 −1 −1 −1 1 −1 −1 |
| | | −1 −1 −1 1 1 −1 −1 1 1 |
| | | 1 −1 0 1 −1 −1 −1 1 1 |
| | | −1 1 −1 1 −1 −1 −1 1 −1 |
| | | −1 −1 −1 −1 1 1 1 1 −1 |
| | | 1 1 1 −1 −1 1 −1 1 1 |
| | | 1 −1 −1 −1 1 1 0 1 −1 |
| | | 1 1 1 −1 −1 1 0 −1 0 |
| | | −1 −1 −1 1 0 −1 −1 1 −1 |
| | | −1 −1 −1 1 −1 1 −1 1 1 |
| | | 1 −1 −1 −1 1 1 −1 −1 1 |
| | | 1 −1 1 −1 1 1 1 −1 1 |
| | | −1 1 1 1 −1 −1 −1 0 1 |
| | | −1 −1 1 −1 1 −1 −1 1 −1 |
| | | 1 −1 0 −1 1 1 −1 1 1 |
| | | 1 1 1 1 1 −1 −1 1 −1 |
| | | 1 1 1 1 1 1 1 −1 −1 |
| | | 1 −1 −1 0 1 1 −1 −1 −1 |
| | | −1 1 1 1 1 1 1 1 −1 |
| | | 1 1 1 1 1 −1 −1 1 −1 |
| | | −1 1 −1 −1 −1 −1 −1 −1 1 |
| | | −1 1 1 1 −1 −1 1 −1 −1 |
| | | −1 0 −1 1 1 1 −1 1 1 |
| | | 1 −1 −1 −1 −1 1 1 −1 −1 |
| | | 1 −1 −1 1 1 0 1 1 −1 |
| | | 1 1 −1 1 1 1 −1 1 1 |
| | | 1 1 −1 1 1 −1 −1 −1 −1 |
| | | −1 1 1 −1 1 1 −1 1 −1 |
| | | −1 1 1 1 1 1 −1 −1 −1 |
| | | 1 −1 −1 1 1 1 1 −1 1 |
| | | −1 −1 −1 1 1 −1 −1 −1 −1 |
| | | −1 −1 −1 1 −1 −1 1 −1 1 |
| | | 1 −1 0 −1 −1 1 −1 1 −1 |
| | | −1 −1 1 1 1 0 1 1 −1 |
| | | 1 1 −1 1 −1 −1 −1 −1 −1 |
| | | 1 1 −1 −1 −1 0 1 −1 −1 |
| | | 1 −1 1 −1 0 −1 −1 −1 1 |
| | | 1 1 −1 −1 1 −1 1 1 1 |
| | | 1 −1 1 −1 1 −1 1 1 −1 |
| | | −1 1 −1 −1 −1 1 1 −1 −1 |
| | | 1 −1 0 1 −1 0 −1 1 −1 |
| | | −1 1 −1 1 −1 −1 1 −1 1 |
| | | −1 1 −1 −1 −1 −1 1 −1 −1 |
| | | 1 1 −1 1 1 1 1 0 −1 |
| | | −1 1 1 1 1 −1 −1 −1 −1 |
| | | −1 1 1 −1 1 −1 1 −1 1 |
| | | 1 1 1 1 1 −1 1 1 −1 |
| | | −1 −1 −1 −1 1 −1 1 1 1 |
| | | −1 1 −1 −1 1 1 1 −1 −1 |
| | | −1 1 1 1 1 −1 1 −1 1 |
| | | 1 −1 −1 1 −1 1 1 −1 1 |
| | | −1 −1 1 1 1 −1 −1 1 1 |
| | | −1 −1 1 1 1 1 −1 1 −1 |
| | | −1 −1 1 1 1 1 −1 −1 1 |
| | | −1 −1 1 −1 1 1 1 1 1 |
| | | −1 1 −1 −1 1 −1 −1 1 −1 |
| | | −1 −1 1 −1 −1 −1 −1 −1 −1 |
| 871 | −1 | 0 1 −1 −1 −1 1 1 −1 −1 |
| | | −1 1 −1 0 1 −1 −1 1 1 |
| | | −1 1 1 −1 −1 1 1 1 −1 |
| | | 1 0 −1 1 1 −1 1 −1 1 |
| | | −1 −1 −1 −1 −1 −1 1 1 1 |
| | | 1 1 1 1 −1 1 −1 −1 −1 |
| | | −1 1 1 1 −1 1 −1 1 1 |
| | | −1 −1 −1 −1 1 1 1 1 1 |
| | | 1 −1 1 1 0 1 1 −1 1 |
| | | 1 −1 −1 1 −1 −1 1 −1 1 |
| | | 1 −1 −1 1 −1 1 −1 1 1 |
| | | 1 −1 1 −1 −1 1 1 1 −1 |
| | | −1 1 1 −1 1 −1 1 −1 1 |
| | | −1 1 −1 1 −1 −1 −1 1 −1 |
| | | 1 0 1 1 −1 −1 −1 −1 1 |
| | | −1 1 −1 1 1 1 −1 −1 −1 |
| | | −1 1 −1 1 −1 1 1 −1 1 |
| | | 1 1 −1 1 1 1 1 1 1 |
| | | −1 −1 −1 −1 −1 1 −1 −1 1 |
| | | −1 1 1 1 1 −1 −1 1 −1 |
| | | −1 −1 1 1 1 1 1 −1 1 |
| | | −1 −1 1 1 1 −1 −1 1 1 |
| | | 1 −1 −1 −1 1 −1 −1 −1 −1 |
| | | 1 −1 −1 −1 1 −1 −1 −1 −1 |
| | | −1 1 −1 0 1 −1 −1 1 1 |
| | | −1 1 0 1 1 −1 −1 −1 −1 |
| | | −1 1 −1 1 1 −1 1 −1 1 |
| | | −1 1 −1 −1 1 −1 1 1 1 |
| | | −1 −1 1 1 1 1 1 −1 −1 |
| | | −1 1 −1 1 −1 −1 1 −1 1 |
| | | 1 1 1 1 −1 −1 1 −1 1 |
| | | 0 0 1 0 −1 1 1 1 1 |
| | | −1 −1 1 1 −1 −1 −1 1 −1 |
| | | 1 1 1 −1 1 0 1 1 −1 |
| | | 1 −1 1 0 1 1 −1 1 −1 |
| | | −1 1 −1 1 1 0 −1 1 1 |
| | | 1 1 −1 1 −1 1 1 1 1 |
| | | 1 −1 −1 1 1 1 1 −1 1 |
| | | 1 −1 1 1 −1 −1 −1 1 −1 |
| | | −1 −1 −1 −1 −1 1 1 1 −1 |
| | | 1 1 1 −1 −1 1 −1 0 −1 |
| | | −1 1 −1 −1 −1 1 1 0 1 |
| | | 1 −1 −1 1 1 −1 −1 1 −1 |
| | | −1 −1 −1 −1 1 −1 −1 −1 1 |
| | | −1 −1 1 1 −1 −1 −1 −1 1 |
| | | 1 1 −1 1 −1 1 0 −1 1 |
| | | 1 1 1 −1 −1 −1 −1 1 1 |
| | | 1 −1 1 1 1 −1 −1 1 1 |
| | | 1 1 −1 −1 −1 1 1 −1 1 |
| | | −1 1 1 0 −1 1 1 0 −1 |
| | | 1 1 1 −1 1 1 −1 −1 −1 |
| | | −1 1 1 1 −1 −1 0 1 −1 |
| | | −1 1 1 −1 1 1 −1 −1 −1 |
| | | 1 −1 1 0 −1 1 1 1 1 |
| | | 1 −1 1 1 0 1 1 −1 −1 |
| | | 1 −1 −1 −1 1 1 1 1 −1 |
| | | 1 −1 −1 1 −1 1 −1 −1 1 |
| | | 1 0 1 1 −1 −1 1 1 1 |
| | | −1 −1 −1 1 −1 1 1 1 1 |
| | | −1 1 1 −1 −1 1 1 1 −1 |
| | | 1 −1 1 1 1 −1 1 −1 1 |
| | | 1 −1 1 1 −1 1 −1 −1 −1 |
| | | 1 −1 1 −1 1 1 1 −1 −1 |
| | | −1 1 1 −1 −1 1 −1 −1 1 |
| | | 1 −1 −1 1 1 −1 1 −1 1 |
| | | 0 1 1 −1 1 1 1 1 1 |
| | | 1 1 −1 −1 0 1 −1 −1 −1 |
| | | 1 1 1 1 1 1 1 1 1 |
| | | 1 1 1 1 1 1 1 −1 −1 |
| | | 1 −1 −1 0 1 −1 −1 1 −1 |
| | | −1 −1 −1 −1 −1 1 −1 −1 −1 |
| | | −1 1 −1 −1 −1 1 1 −1 1 |
| | | 1 1 1 1 1 −1 1 −1 1 |
| | | −1 1 −1 1 1 −1 1 −1 −1 |
| | | −1 −1 1 1 −1 1 −1 −1 −1 |
| | | −1 1 1 1 −1 1 1 1 −1 |
| | | −1 1 −1 −1 −1 −1 1 −1 −1 |
| | | −1 −1 1 −1 −1 1 −1 1 1 |
| | | −1 1 0 1 1 −1 1 −1 0 |
| | | 1 −1 −1 1 −1 1 −1 −1 1 |
| | | −1 1 1 −1 1 1 1 1 −1 |
| | | −1 −1 1 −1 1 1 −1 −1 −1 |
| | | −1 −1 1 1 −1 1 1 −1 1 |
| | | −1 1 1 −1 −1 1 1 −1 −1 |
| | | −1 −1 1 1 −1 1 −1 −1 −1 |
| | | 1 −1 −1 1 1 −1 1 −1 −1 |
| | | −1 −1 −1 −1 −1 1 −1 1 −1 |
| | | 1 1 1 −1 −1 −1 −1 −1 −1 |
| | | −1 −1 1 1 1 1 −1 −1 1 |
| | | 1 1 1 1 1 −1 1 −1 1 |
| | | 1 1 1 −1 −1 −1 1 −1 −1 |
| | | 1 1 0 1 1 −1 −1 0 −1 |
| | | −1 1 −1 1 −1 1 −1 1 −1 |
| | | 1 −1 −1 0 −1 −1 1 1 1 |
| | | 1 −1 −1 −1 1 1 −1 1 1 |
| | | −1 −1 −1 −1 1 1 1 −1 −1 |
| | | −1 1 −1 1 1 −1 |
| 1057 | 1 | −1 −1 1 1 1 −1 1 1 −1 |
| | | −1 −1 1 −1 1 −1 1 −1 1 |
| | | 1 1 −1 1 1 −1 −1 1 0 |
| | | 1 1 1 −1 1 −1 −1 −1 −1 |
| | | 1 −1 −1 1 1 1 1 −1 −1 |
| | | 1 −1 −1 −1 1 −1 1 0 |
| | | −1 1 1 1 −1 1 1 1 1 |
| | | −1 −1 1 −1 1 −1 −1 −1 1 |
| | | 1 −1 1 1 1 1 1 −1 1 |
| | | 1 0 1 −1 1 −1 1 1 −1 |
| | | −1 −1 1 −1 −1 −1 −1 −1 −1 |
| | | 1 −1 1 −1 1 −1 −1 1 0 |
| | | 1 1 1 1 1 −1 1 1 1 |
| | | 1 −1 1 −1 1 −1 1 1 1 |
| | | −1 1 1 −1 −1 −1 −1 1 1 |
| | | 1 −1 1 −1 1 1 −1 1 1 |
| | | −1 1 −1 −1 −1 1 1 1 −1 |
| | | 1 1 1 1 1 −1 −1 1 −1 |
| | | −1 −1 1 0 1 −1 1 1 −1 |
| | | −1 1 1 1 −1 1 −1 0 1 |
| | | 1 1 −1 1 −1 −1 1 −1 1 |
| | | 1 −1 −1 −1 −1 −1 1 1 −1 |
| | | −1 1 1 1 1 −1 1 −1 1 |
| | | −1 −1 1 1 −1 −1 1 −1 0 |
| | | −1 −1 −1 1 −1 1 1 −1 1 |
| | | −1 1 1 −1 1 1 −1 −1 −1 |
| | | 1 −1 −1 −1 −1 1 −1 1 −1 |
| | | −1 1 −1 −1 1 1 −1 −1 −1 |
| | | −1 −1 −1 1 −1 1 1 −1 −1 |
| | | 1 −1 1 −1 1 −1 1 1 −1 |
| | | 0 1 −1 1 1 1 1 1 −1 |
| | | 1 −1 −1 1 −1 0 −1 1 1 |
| | | −1 −1 1 1 −1 −1 1 −1 1 |
| | | 1 1 −1 −1 1 −1 −1 1 1 |
| | | 1 −1 0 1 −1 1 1 1 −1 |
| | | −1 −1 1 −1 −1 −1 −1 −1 |
| | | 1 1 −1 −1 −1 −1 −1 0 1 |
| | | 1 1 −1 −1 −1 −1 −1 −1 −1 |
| | | −1 1 1 1 −1 −1 −1 −1 −1 |
| | | 1 1 1 1 −1 −1 0 1 1 |
| | | −1 −1 1 −1 1 −1 −1 −1 1 |
| | | −1 −1 1 0 −1 0 −1 −1 1 |
| | | 1 1 −1 −1 1 1 1 −1 1 |
| | | −1 −1 1 −1 −1 1 −1 −1 1 |
| | | −1 −1 −1 −1 1 1 −1 −1 |
| | | 1 1 −1 −1 −1 −1 1 1 −1 |
| | | 1 1 −1 −1 −1 −1 1 −1 −1 |
| | | 1 −1 1 −1 1 1 −1 −1 0 |
| | | −1 1 0 −1 1 1 −1 1 −1 |
| | | −1 0 −1 −1 −1 1 1 −1 1 |
| | | −1 1 0 1 −1 1 −1 1 −1 |
| | | 1 −1 −1 −1 −1 1 −1 −1 1 |
| | | 1 −1 −1 1 −1 1 1 1 −1 |
| | | −1 −1 1 −1 −1 1 −1 −1 1 |
| | | 1 1 1 1 1 1 −1 −1 −1 |
| | | 1 −1 −1 1 1 −1 1 −1 −1 |
| | | 1 1 −1 −1 −1 1 1 1 −1 |
| | | −1 1 −1 −1 −1 1 1 −1 1 |
| | | −1 1 −1 1 −1 1 −1 1 −1 |
| | | −1 −1 −1 1 1 −1 1 1 1 |
| | | 1 0 −1 1 −1 1 1 1 1 |
| | | 1 1 1 1 −1 −1 1 1 −1 |
| | | −1 1 −1 −1 −1 1 1 −1 1 |
| | | −1 −1 0 1 1 −1 1 −1 1 |
| | | −1 −1 1 −1 1 1 1 1 −1 |
| | | 1 1 −1 1 −1 −1 1 −1 −1 |
| | | −1 −1 −1 1 −1 −1 −1 1 1 |
| | | −1 1 1 −1 −1 −1 −1 1 1 |
| | | −1 1 −1 −1 −1 0 1 −1 −1 |
| | | 1 −1 1 1 1 1 −1 −1 −1 |
| | | 1 −1 −1 −1 1 1 1 1 −1 |
| | | 1 1 1 −1 1 −1 −1 −1 1 |
| | | 1 1 −1 1 1 −1 −1 1 1 |
| | | −1 −1 −1 1 −1 1 0 −1 1 |
| | | −1 −1 −1 1 0 1 −1 −1 1 |
| | | −1 1 −1 −1 1 1 1 0 −1 |
| | | −1 1 1 −1 −1 1 1 1 1 |
| | | 1 1 −1 −1 −1 −1 1 1 1 |
| | | −1 1 1 1 −1 1 1 1 −1 |
| | | 1 1 −1 0 0 −1 −1 −1 −1 |
| | | −1 1 1 −1 −1 1 1 −1 −1 |
| | | 1 −1 −1 1 −1 1 −1 −1 1 |
| | | −1 −1 −1 −1 1 −1 −1 0 1 |
| | | 1 −1 0 −1 −1 1 −1 0 1 |
| | | 1 −1 −1 1 1 1 −1 −1 1 |
| | | −1 −1 −1 1 1 1 −1 −1 1 |
| | | −1 −1 1 1 1 −1 1 1 −1 |
| | | −1 −1 −1 1 −1 −1 1 1 1 |
| | | −1 −1 −1 −1 −1 1 1 1 −1 |
| | | 1 −1 −1 −1 −1 1 −1 −1 1 |
| | | 1 1 1 −1 1 1 −1 1 1 |
| | | −1 −1 −1 1 −1 1 1 1 1 |
| | | −1 −1 1 1 1 1 1 1 1 |
| | | 1 −1 1 1 −1 1 −1 1 1 |
| | | −1 −1 1 1 −1 −1 1 1 −1 |
| | | 1 1 1 −1 1 1 −1 −1 0 |
| | | −1 −1 1 1 1 0 1 1 1 |
| | | −1 −1 −1 −1 −1 −1 1 1 1 |
| | | 1 1 1 0 −1 −1 −1 −1 1 |
| | | −1 1 −1 −1 1 1 −1 1 1 |
| | | 1 −1 −1 −1 1 0 −1 −1 1 |
| | | −1 −1 1 1 −1 −1 1 −1 −1 |
| | | 1 −1 1 −1 −1 −1 −1 −1 −1 |
| | | −1 1 1 1 −1 −1 −1 −1 1 |
| | | −1 1 1 1 −1 −1 −1 −1 1 |
| | | 1 1 1 −1 1 1 −1 1 1 |
| | | 1 −1 −1 −1 −1 1 −1 1 −1 |
| | | 1 1 −1 −1 1 1 −1 −1 1 |
| | | 1 −1 1 −1 1 1 1 −1 −1 |
| | | −1 −1 −1 1 −1 1 1 −1 1 |
| | | −1 1 1 1 −1 1 −1 1 1 |
| | | 1 −1 −1 −1 1 1 1 −1 −1 |
| | | −1 1 1 1 1 −1 1 −1 1 |
| | | 1 −1 −1 1 −1 1 1 −1 1 |
| | | −1 −1 1 1 1 1 −1 1 1 |
| | | −1 −1 1 −1 1 −1 1 −1 −1 |
| | | −1 −1 −1 −1 −1 −1 −1 −1 1 |
| | | 1 1 1 |
| 1093 | 1 | 0 0 0 0 1 0 1 0 0 |
| | | −1 0 0 0 1 1 0 −1 0 |
| | | −1 −1 1 −1 0 0 1 1 0 |
| | | 1 −1 −1 −1 1 0 1 −1 0 |
| | | 1 −1 0 1 1 1 1 1 1 |
| | | −1 0 0 0 0 −1 1 −1 0 |
| | | 0 1 −1 0 1 −1 −1 1 1 |
| | | 1 1 −1 1 1 0 0 −1 0 |
| | | 1 1 1 1 0 1 −1 0 0 |
| | | 1 0 1 1 −1 −1 0 0 −1 |
| | | −1 −1 −1 −1 1 1 0 0 0 |
| | | 1 1 1 1 0 −1 −1 0 0 |
| | | 1 −1 1 −1 −1 −1 1 0 0 |
| | | −1 0 1 −1 1 1 0 1 1 |
| | | 0 1 1 0 −1 1 0 −1 1 |
| | | −1 −1 −1 −1 −1 0 −1 0 0 |
| | | 0 −1 0 0 −1 0 1 0 −1 |
| | | 1 0 1 0 −1 −1 −1 0 0 |
| | | −1 1 0 −1 −1 1 −1 −1 −1 |
| | | 1 1 0 −1 0 1 1 1 −1 |
| | | 0 1 −1 0 −1 1 1 1 1 |
| | | 0 −1 1 0 0 1 −1 −1 −1 |
| | | 1 −1 1 −1 0 1 0 0 0 |
| | | 1 1 0 1 0 −1 −1 1 0 |
| | | 0 −1 1 1 −1 1 1 −1 1 |
| | | −1 0 1 −1 0 0 1 1 1 |
| | | 1 −1 −1 −1 0 0 −1 −1 0 |
| | | −1 −1 1 1 −1 0 1 1 1 |
| | | −1 1 1 −1 0 −1 0 1 −1 |
| | | 1 0 0 1 1 0 −1 1 −1 |
| | | −1 1 −1 −1 0 −1 1 0 −1 |
| | | −1 0 −1 −1 −1 1 −1 0 1 |
| | | 0 1 0 1 1 0 0 0 0 |
| | | −1 1 1 0 0 1 −1 1 1 |
| | | 1 −1 1 0 1 0 −1 0 −1 |
| | | 0 0 −1 0 0 0 −1 1 0 |
| | | −1 0 1 −1 −1 −1 0 1 1 |
| | | −1 0 −1 1 −1 −1 1 0 −1 |
| | | 0 −1 1 −1 −1 0 0 −1 0 |
| | | −1 −1 −1 1 0 0 1 0 1 |
| | | −1 1 −1 0 0 1 0 0 1 |
| | | −1 −1 0 1 −1 1 −1 −1 1 |
| | | 1 0 0 −1 1 1 1 1 1 |
| | | −1 1 0 0 0 −1 0 −1 1 |
| | | 0 1 0 0 −1 −1 0 0 1 |
| | | 1 1 −1 −1 −1 −1 0 −1 −1 |
| | | 0 0 −1 0 1 −1 −1 1 0 |
| | | 1 1 −1 1 −1 0 −1 −1 0 |
| | | 0 1 0 1 −1 −1 −1 0 0 |
| | | 1 −1 0 −1 −1 −1 1 1 0 |
| | | 1 0 1 1 1 0 0 0 −1 |
| | | 0 1 1 0 1 0 1 −1 1 |
| | | 0 0 0 1 0 −1 1 0 −1 |
| | | 0 −1 −1 −1 −1 0 0 1 0 |
| | | 0 −1 −1 −1 0 1 1 1 0 |
| | | −1 1 −1 0 1 −1 −1 0 1 |
| | | 1 1 −1 −1 1 −1 0 −1 −1 |
| | | 1 0 1 0 1 1 −1 0 0 |
| | | 0 −1 −1 1 −1 0 1 1 1 |
| | | 0 1 1 −1 0 1 0 −1 −1 |
| | | 1 1 0 −1 1 1 1 1 −1 |
| | | −1 1 0 0 −1 −1 1 −1 1 |
| | | 1 1 1 0 0 1 0 0 1 |
| | | 1 −1 0 1 −1 −1 −1 1 1 |
| | | 1 −1 0 1 1 0 −1 1 1 |
| | | −1 1 −1 −1 1 −1 0 0 −1 |
| | | 1 0 1 −1 1 −1 −1 0 1 |
| | | 0 0 −1 −1 1 0 1 1 1 |
| | | 1 −1 0 −1 0 0 −1 1 0 |
| | | 0 −1 1 −1 −1 1 1 −1 0 |
| | | −1 1 1 −1 1 0 −1 1 −1 |
| | | 0 −1 −1 −1 0 1 0 1 0 |
| | | −1 1 0 0 0 −1 −1 −1 1 |
| | | 0 1 1 0 1 −1 0 −1 1 |
| | | 0 1 1 0 −1 −1 0 −1 1 |
| | | −1 1 −1 0 −1 0 0 0 1 |
| | | 0 0 −1 0 −1 0 1 1 0 |
| | | 0 0 1 −1 1 1 0 −1 1 |
| | | 0 1 1 −1 −1 −1 0 −1 −1 |
| | | −1 0 −1 0 1 0 −1 0 0 |
| | | 1 0 −1 0 −1 −1 0 −1 0 |
| | | 0 1 −1 0 0 −1 −1 1 1 |
| | | −1 1 1 1 1 −1 0 1 0 |
| | | 0 −1 1 1 0 1 1 −1 1 |
| | | 1 0 −1 −1 0 1 1 −1 1 |
| | | −1 1 −1 −1 0 0 0 0 −1 |
| | | −1 −1 0 0 1 1 0 −1 −1 |
| | | −1 −1 1 −1 1 0 0 1 0 |
| | | 0 −1 1 −1 0 1 1 −1 0 |
| | | 1 1 −1 −1 1 1 −1 −1 −1 |
| | | 1 1 −1 −1 0 1 1 −1 −1 |
| | | −1 1 −1 −1 −1 0 1 0 −1 |
| | | 0 −1 1 0 −1 0 0 −1 −1 |
| | | −1 0 −1 1 1 0 −1 0 −1 |
| | | 1 1 −1 0 0 −1 1 −1 1 |
| | | −1 1 −1 0 0 0 0 0 1 |
| | | −1 0 0 0 −1 1 1 −1 0 |
| | | 1 −1 1 −1 1 1 1 0 0 |
| | | 0 1 0 1 1 0 −1 0 0 |
| | | −1 1 −1 0 −1 1 −1 0 1 |
| | | 0 −1 0 1 1 0 −1 0 1 |
| | | −1 1 −1 0 1 1 0 0 1 |
| | | 1 −1 1 1 −1 −1 −1 0 1 |
| | | −1 −1 0 −1 1 1 −1 −1 0 |
| | | −1 1 −1 −1 −1 0 −1 0 −1 |
| | | 0 −1 0 0 0 0 0 0 −1 |
| | | 0 0 0 0 1 0 −1 0 0 |
| | | −1 0 −1 0 −1 1 0 0 0 |
| | | 0 −1 −1 1 0 0 1 1 1 |
| | | −1 1 −1 −1 0 −1 0 0 −1 |
| | | −1 0 0 −1 1 1 −1 −1 1 |
| | | −1 1 −1 −1 1 0 0 0 −1 |
| | | 1 −1 1 0 1 −1 0 0 −1 |
| | | 0 1 1 −1 1 0 1 −1 −1 |
| | | 0 −1 0 1 −1 −1 0 0 1 |
| | | 1 −1 −1 −1 −1 −1 −1 −1 0 |
| | | 0 0 0 0 −1 −1 0 0 0 |
| | | 1 1 −1 −1 0 −1 −1 −1 −1 |
| | | −1 0 1 0 0 0 −1 1 0 |
| | | 1 0 1 −1 −1 0 0 0 1 |
| | | −1 −1 −1 0 −1 1 −1 0 −1 |
| | | 0 −1 0 |
| 1893 | −1 | 0 1 −1 −1 1 1 −1 1 −1 |
| | | 1 1 −1 1 −1 1 1 1 −1 |
| | | −1 1 1 −1 1 1 −1 −1 −1 |
| | | 1 1 1 −1 1 1 1 −1 1 |
| | | −1 −1 1 −1 −1 −1 0 1 −1 |
| | | −1 −1 −1 0 1 −1 −1 −1 1 |
| | | −1 1 1 −1 1 1 −1 1 −1 |
| | | −1 −1 1 1 −1 −1 −1 1 1 |
| | | −1 −1 1 1 1 −1 0 −1 −1 |
| | | 1 −1 1 −1 1 1 1 −1 1 |
| | | 1 −1 −1 1 1 −1 −1 1 −1 |
| | | 1 1 1 −1 1 −1 −1 1 1 |
| | | −1 1 −1 1 −1 −1 −1 1 −1 |
| | | −1 −1 −1 −1 1 −1 1 1 1 |
| | | 1 −1 −1 −1 −1 −1 −1 −1 1 |
| | | −1 1 −1 −1 1 1 −1 1 1 |
| | | 1 −1 −1 −1 −1 1 −1 −1 1 |
| | | 1 1 1 −1 1 1 −1 −1 −1 |
| | | 1 −1 1 −1 1 1 −1 −1 −1 |
| | | −1 1 −1 −1 1 1 1 1 |
| | | 1 1 −1 −1 1 1 1 1 1 |
| | | 1 −1 1 1 1 −1 −1 −1 1 |
| | | −1 1 1 −1 −1 1 −1 −1 1 |
| | | −1 1 1 1 1 −1 0 1 −1 |
| | | −1 −1 −1 −1 −1 −1 1 1 1 |
| | | 1 −1 −1 1 1 1 −1 −1 −1 |
| | | 1 −1 −1 1 1 −1 1 −1 1 |
| | | −1 1 −1 −1 −1 −1 −1 1 1 |
| | | 1 1 −1 1 1 1 1 −1 −1 |
| | | −1 1 1 −1 −1 −1 −1 1 1 |
| | | 1 1 1 1 −1 1 −1 1 1 |
| | | −1 −1 1 1 −1 1 1 1 −1 |
| | | −1 1 −1 1 −1 −1 1 −1 −1 |
| | | −1 1 −1 −1 −1 −1 −1 0 1 |
| | | −1 −1 1 0 1 1 −1 1 −1 |
| | | −1 −1 1 −1 −1 −1 1 −1 1 |
| | | 1 −1 −1 1 0 1 1 −1 −1 |
| | | 1 1 1 −1 1 −1 −1 1 −1 |
| | | −1 1 1 −1 1 −1 −1 −1 1 |
| | | 1 −1 −1 −1 −1 1 −1 −1 1 |
| | | −1 1 1 1 1 −1 1 −1 1 |
| | | −1 1 1 1 −1 −1 −1 −1 −1 |
| | | −1 −1 1 1 1 1 −1 −1 −1 |
| | | 1 1 −1 −1 1 −1 1 1 −1 |
| | | 1 1 −1 1 −1 −1 1 1 −1 |
| | | −1 1 −1 −1 −1 1 1 1 0 |
| | | 1 1 −1 1 −1 1 −1 1 1 |
| | | 1 1 1 −1 1 1 1 1 1 |
| | | 1 1 −1 1 −1 1 1 −1 1 |
| | | 1 −1 −1 −1 −1 −1 1 −1 1 |
| | | 1 1 1 1 −1 −1 1 −1 1 |
| | | 1 −1 1 1 1 1 −1 −1 1 |
| | | 1 1 −1 −1 1 0 −1 1 1 |
| | | 1 1 1 −1 0 −1 −1 1 1 |
| | | −1 −1 1 −1 1 −1 −1 −1 1 |
| | | 1 −1 −1 −1 1 −1 1 1 1 |
| | | 1 1 −1 1 −1 1 −1 1 1 |
| | | 1 1 −1 −1 −1 1 1 −1 1 |
| | | −1 1 −1 1 −1 1 −1 −1 −1 |
| | | −1 −1 −1 −1 −1 −1 1 −1 1 |
| | | −1 −1 −1 −1 1 1 −1 −1 1 |
| | | −1 1 −1 −1 −1 1 1 1 1 |
| | | 1 1 −1 0 1 −1 −1 1 −1 |
| | | 1 1 −1 −1 1 1 −1 1 1 |
| | | −1 1 −1 1 −1 −1 1 1 1 |
| | | 1 1 −1 1 −1 −1 1 −1 −1 |
| | | 1 1 −1 1 −1 1 −1 −1 1 |
| | | 1 1 0 1 1 −1 −1 1 −1 |
| | | 1 −1 −1 −1 1 1 −1 1 1 |
| | | −1 1 1 1 1 1 1 1 −1 |
| | | 0 1 −1 −1 −1 1 1 −1 1 |
| | | 1 −1 −1 −1 1 1 −1 1 1 |
| | | −1 −1 1 −1 −1 −1 −1 −1 −1 |
| | | −1 −1 1 1 1 −1 −1 1 1 |
| | | 1 0 1 1 −1 −1 −1 1 −1 |
| | | −1 1 −1 1 −1 1 −1 −1 1 |
| | | −1 1 1 1 1 1 −1 1 −1 |
| | | −1 −1 1 −1 1 −1 −1 −1 −1 |
| | | 1 1 −1 −1 −1 1 −1 −1 1 |
| | | 1 1 0 1 1 −1 1 1 −1 |
| | | 1 1 1 1 −1 −1 1 −1 −1 |
| | | −1 1 −1 1 −1 1 −1 1 −1 |
| | | −1 1 1 1 1 1 0 −1 1 |
| | | 1 −1 −1 1 1 1 1 −1 −1 |
| | | −1 1 −1 −1 −1 1 1 −1 0 |
| | | −1 −1 1 1 1 1 −1 1 −1 |
| | | −1 −1 −1 1 −1 −1 1 −1 1 |
| | | 1 −1 −1 1 −1 −1 −1 −1 −1 |
| | | −1 −1 −1 1 −1 −1 1 −1 1 |
| | | 1 −1 −1 −1 1 1 1 1 −1 |
| | | 1 1 −1 −1 1 −1 −1 −1 −1 |
| | | −1 1 −1 1 −1 1 1 −1 1 |
| | | 1 1 −1 1 1 1 0 −1 1 |
| | | 1 1 1 −1 1 1 1 −1 1 |
| | | 1 −1 1 1 1 1 1 −1 −1 |
| | | −1 −1 1 −1 1 −1 −1 1 −1 |
| | | 1 −1 1 1 −1 1 −1 −1 −1 |
| | | 1 0 −1 1 1 1 1 1 1 |
| | | −1 −1 −1 1 −1 1 1 −1 1 |
| | | 1 −1 −1 1 0 1 1 −1 1 |
| | | −1 −1 1 1 −1 1 −1 1 −1 |
| | | −1 1 1 1 1 −1 1 −1 1 |
| | | 1 1 −1 −1 1 −1 −1 −1 1 |
| | | −1 1 −1 −1 −1 −1 −1 1 1 |
| | | 1 −1 1 1 −1 1 1 1 1 |
| | | −1 −1 1 −1 1 1 −1 −1 −1 |
| | | 1 −1 −1 −1 1 1 1 −1 −1 |
| | | −1 1 1 1 −1 1 −1 1 1 |
| | | 1 −1 1 1 1 −1 1 −1 −1 |
| | | 1 1 1 −1 1 −1 1 1 −1 |
| | | 1 −1 −1 1 −1 1 −1 −1 −1 |
| | | 1 1 −1 1 −1 −1 −1 −1 −1 |
| | | −1 −1 1 1 1 −1 −1 −1 1 |
| | | 1 1 −1 1 1 1 −1 −1 −1 |
| | | −1 1 1 1 −1 1 1 1 1 |
| | | −1 1 −1 −1 −1 1 1 −1 −1 |
| | | −1 1 −1 −1 −1 1 −1 1 −1 |
| | | −1 −1 −1 −1 1 −1 −1 −1 −1 |
| | | −1 −1 1 −1 −1 −1 −1 1 1 |
| | | −1 −1 −1 −1 −1 1 −1 1 −1 |
| | | −1 −1 −1 −1 1 1 −1 1 1 |
| | | 1 −1 1 −1 −1 −1 1 1 1 |
| | | −1 −1 −1 −1 1 −1 1 −1 1 |
| | | −1 1 −1 1 1 −1 −1 1 −1 |
| | | −1 −1 −1 0 1 −1 −1 −1 1 |
| | | −1 −1 1 1 −1 1 1 −1 0 |
| | | 1 −1 −1 −1 −1 1 −1 1 −1 |
| | | −1 1 1 −1 −1 1 −1 −1 1 |
| | | −1 1 −1 −1 −1 1 −1 1 −1 |
| | | 1 −1 1 1 1 −1 −1 −1 1 |
| | | 1 1 −1 −1 1 −1 −1 1 1 |
| | | −1 −1 1 −1 1 −1 −1 −1 −1 |
| | | 1 1 1 1 1 1 1 −1 1 |
| | | 1 −1 1 −1 1 1 1 1 1 |
| | | −1 1 −1 1 −1 −1 −1 −1 0 |
| | | −1 −1 1 −1 −1 −1 1 1 1 |
| | | −1 −1 −1 1 1 −1 1 1 1 |
| | | −1 1 1 1 1 1 −1 −1 −1 |
| | | −1 −1 −1 −1 1 1 1 −1 −1 |
| | | 1 0 1 1 −1 −1 1 −1 −1 |
| | | −1 0 1 −1 −1 1 1 −1 −1 |
| | | −1 −1 −1 1 −1 1 −1 −1 1 |
| | | 1 1 1 1 −1 −1 −1 −1 |
| | | −1 −1 1 −1 −1 −1 0 −1 −1 |
| | | 1 −1 1 1 1 1 1 1 1 |
| | | −1 1 1 −1 −1 −1 1 1 1 |
| | | 1 −1 1 −1 1 1 1 1 −1 |
| | | −1 1 −1 1 1 1 1 −1 1 |
| | | −1 1 −1 −1 −1 1 1 1 −1 |
| | | 1 1 −1 −1 1 1 −1 −1 −1 |
| | | 1 1 −1 1 −1 1 1 −1 −1 |
| | | 1 1 1 1 −1 −1 1 1 |
| | | −1 −1 1 −1 −1 −1 1 1 1 |
| | | −1 −1 −1 −1 1 −1 1 −1 −1 |
| | | −1 1 −1 −1 −1 −1 −1 −1 1 |
| | | −1 1 −1 1 −1 1 1 1 −1 |
| | | −1 1 −1 −1 1 1 −1 1 −1 |
| | | 1 1 1 −1 1 1 −1 −1 −1 |
| | | 1 −1 −1 1 −1 1 −1 1 −1 |
| | | 1 −1 1 1 1 0 1 1 −1 |
| | | −1 1 1 1 −1 −1 −1 −1 0 |
| | | 0 −1 0 1 −1 −1 −1 1 1 |
| | | −1 1 −1 1 −1 −1 1 1 −1 |
| | | −1 1 1 1 −1 1 1 −1 −1 |
| | | 1 1 1 1 −1 −1 1 1 −1 |
| | | −1 −1 1 −1 −1 1 1 1 1 |
| | | −1 1 −1 −1 1 −1 1 1 −1 |
| | | 0 −1 −1 1 0 −1 1 1 −1 |
| | | −1 1 1 1 −1 1 1 −1 1 |
| | | −1 −1 1 −1 −1 1 1 −1 1 |
| | | 1 1 1 −1 1 −1 1 1 1 |
| | | 1 1 −1 1 1 1 1 −1 1 |
| | | 1 1 1 −1 1 −1 −1 −1 1 |
| | | −1 −1 1 1 1 −1 −1 −1 −1 |
| | | −1 −1 −1 1 −1 −1 1 −1 1 |
| | | −1 −1 −1 −1 −1 1 1 1 1 |
| | | −1 1 −1 −1 1 −1 −1 −1 1 |
| | | 1 −1 1 −1 1 −1 −1 −1 −1 |
| | | 1 −1 1 −1 −1 1 −1 −1 1 |
| | | −1 −1 1 1 1 −1 1 1 −1 |
| | | −1 1 1 1 1 −1 −1 −1 1 |
| | | 0 −1 1 1 −1 1 −1 −1 −1 |
| | | 1 1 1 −1 1 1 −1 1 −1 |
| | | 1 −1 −1 −1 −1 −1 −1 −1 −1 |
| | | 1 0 −1 1 1 −1 −1 1 −1 |
| | | −1 1 −1 −1 1 −1 1 1 −1 |
| | | 1 −1 1 −1 1 1 −1 1 −1 |
| | | 1 −1 −1 1 −1 −1 −1 −1 −1 |
| | | 1 1 1 1 1 −1 −1 1 −1 |
| | | 1 −1 1 −1 −1 −1 1 1 1 |
| | | 1 1 −1 −1 −1 −1 −1 −1 1 |
| | | −1 −1 −1 −1 0 −1 −1 1 1 |
| | | 1 1 0 −1 1 1 1 1 −1 |
| | | −1 1 −1 −1 1 −1 1 1 −1 |
| | | 0 −1 −1 1 1 −1 −1 −1 −1 |
| | | −1 0 −1 −1 1 −1 −1 −1 −1 |
| | | −1 −1 −1 −1 1 −1 1 1 1 |
| | | 0 1 1 −1 −1 −1 −1 1 1 |
| | | −1 −1 1 −1 1 1 −1 −1 −1 |
| | | −1 −1 −1 1 0 1 1 −1 1 |
| | | −1 −1 1 −1 1 −1 1 −1 1 |
| | | −1 −1 −1 −1 1 1 −1 −1 −1 |
| | | 1 1 1 1 −1 −1 −1 −1 1 |
| | | 1 1 1 0 −1 1 1 −1 −1 |
| | | −1 −1 −1 1 1 1 −1 1 −1 |
| | | −1 −1 1 0 1 1 −1 1 −1 |
| | | 1 −1 1 1 1 0 −1 1 1 |
| | | −1 1 −1 −1 −1 −1 1 −1 −1 |
| | | 1 −1 −1 1 1 1 −1 1 1 |
| | | −1 −1 −1 1 −1 1 −1 −1 −1 |
| | | 1 1 |
| 2451 | 1 | −1 1 1 1 1 −1 −1 1 −1 |
| | | −1 −1 −1 1 1 1 −1 1 1 |
| | | −1 1 1 −1 1 −1 1 −1 1 |
| | | 1 −1 1 −1 −1 1 −1 1 1 |
| | | −1 −1 −1 −1 1 −1 0 1 1 |
| | | 1 −1 −1 1 −1 −1 −1 −1 |
| | | −1 1 1 −1 1 −1 −1 −1 −1 |
| | | −1 1 1 −1 −1 −1 −1 −1 −1 |
| | | −1 1 1 1 −1 1 1 1 −1 |
| | | −1 1 −1 1 1 −1 1 1 −1 |
| | | 1 −1 1 1 −1 1 −1 1 −1 |
| | | 1 −1 1 −1 1 1 −1 1 1 |
| | | −1 1 −1 −1 −1 −1 −1 −1 −1 |
| | | 1 1 1 −1 −1 −1 −1 1 1 |
| | | −1 −1 1 −1 1 1 −1 −1 −1 |
| | | 1 −1 1 1 1 1 1 −1 1 |
| | | −1 −1 1 1 −1 1 1 −1 1 |
| | | −1 −1 −1 1 −1 1 −1 1 0 |
| | | 1 −1 1 1 −1 −1 1 1 1 |
| | | 1 −1 −1 1 1 1 1 −1 1 |
| | | −1 −1 1 1 1 −1 1 −1 1 |
| | | 1 1 0 −1 1 −1 1 −1 1 |
| | | −1 −1 1 1 −1 0 −1 1 −1 |
| | | 1 −1 1 −1 1 1 1 1 1 |
| | | −1 −1 −1 −1 1 1 −1 −1 1 |
| | | 1 −1 −1 −1 1 1 1 0 −1 |
| | | −1 1 −1 −1 1 −1 −1 −1 1 |
| | | −1 1 1 −1 1 1 1 1 1 |
| | | 1 1 −1 −1 −1 0 −1 −1 −1 |
| | | 1 1 −1 1 −1 1 −1 −1 1 |
| | | −1 −1 −1 1 −1 1 1 −1 1 |
| | | −1 1 −1 1 −1 −1 −1 1 −1 |
| | | −1 1 −1 −1 1 −1 1 −1 −1 |
| | | −1 1 1 0 −1 1 1 1 −1 |
| | | −1 1 −1 1 −1 1 1 1 1 |
| | | 1 −1 −1 1 1 −1 1 −1 1 |
| | | 0 1 1 −1 −1 −1 1 −1 −1 |
| | | −1 1 −1 −1 −1 −1 1 1 1 |
| | | −1 1 −1 −1 −1 −1 1 1 −1 |
| | | 1 1 1 −1 1 −1 −1 −1 −1 |
| | | 1 1 −1 −1 1 −1 1 1 1 |
| | | 1 −1 1 −1 −1 −1 −1 −1 −1 |
| | | 1 −1 1 −1 1 −1 −1 1 0 |
| | | 1 −1 1 −1 1 1 −1 1 −1 |
| | | −1 1 1 1 1 −1 1 −1 −1 |
| | | −1 1 −1 1 1 −1 1 1 1 |
| | | 1 −1 1 1 1 −1 1 −1 1 |
| | | 1 0 −1 −1 1 −1 1 −1 −1 |
| | | 1 −1 −1 −1 −1 1 −1 1 −1 |
| | | 1 1 −1 −1 1 1 −1 1 1 |
| | | −1 1 1 1 1 −1 −1 1 −1 |
| | | −1 −1 1 1 −1 1 −1 −1 1 |
| | | −1 1 −1 −1 1 1 1 −1 −1 |
| | | −1 1 1 −1 1 −1 1 −1 1 |
| | | −1 1 −1 −1 −1 1 1 −1 −1 |
| | | 1 −1 −1 −1 1 −1 1 −1 −1 |
| | | −1 −1 −1 −1 −1 1 −1 1 −1 |
| | | −1 −1 1 1 1 −1 −1 −1 −1 |
| | | −1 0 1 1 −1 −1 −1 −1 −1 |
| | | 1 −1 −1 −1 1 −1 −1 −1 1 |
| | | 1 1 −1 1 1 1 −1 1 1 |
| | | −1 −1 −1 1 1 −1 1 −1 1 |
| | | 1 1 −1 −1 1 1 1 −1 −1 |
| | | −1 −1 1 1 −1 −1 −1 −1 1 |
| | | −1 1 1 1 1 1 1 1 0 |
| | | −1 −1 −1 −1 1 −1 1 1 −1 |
| | | 1 −1 1 −1 −1 −1 −1 1 −1 |
| | | 1 0 −1 1 −1 −1 −1 −1 1 |
| | | 1 −1 1 1 1 −1 1 −1 −1 |
| | | −1 1 1 1 1 −1 1 1 −1 |
| | | 1 1 1 1 −1 −1 1 −1 −1 |
| | | −1 −1 1 1 −1 1 1 1 1 |
| | | 1 1 1 1 −1 1 1 1 −1 |
| | | 1 1 −1 1 −1 1 −1 −1 −1 |
| | | −1 1 1 −1 1 1 −1 −1 1 |
| | | −1 −1 1 −1 1 −1 1 −1 −1 |
| | | −1 1 −1 1 −1 −1 −1 1 −1 |
| | | 1 −1 1 −1 1 1 1 1 −1 |
| | | −1 −1 1 −1 −1 −1 −1 −1 1 |
| | | −1 1 1 −1 1 −1 −1 1 1 |
| | | −1 −1 1 1 −1 1 1 1 1 |
| | | 1 1 1 −1 1 1 1 −1 −1 |
| | | −1 −1 −1 −1 1 −1 1 1 1 |
| | | −1 1 −1 −1 1 1 −1 1 1 |
| | | −1 −1 −1 1 0 −1 −1 1 1 |
| | | −1 −1 1 −1 1 −1 1 −1 1 |
| | | −1 −1 −1 1 −1 1 1 −1 1 |
| | | −1 1 −1 1 −1 −1 1 −1 1 |
| | | 1 1 1 −1 −1 −1 −1 1 1 |
| | | −1 1 1 −1 −1 1 −1 0 1 |
| | | −1 −1 −1 −1 1 1 0 −1 −1 |
| | | −1 1 −1 1 −1 1 1 −1 1 |
| | | −1 −1 −1 −1 1 −1 −1 1 1 |
| | | −1 1 1 −1 1 1 1 1 −1 |
| | | −1 1 −1 1 −1 −1 −1 −1 −1 |
| | | 1 1 −1 1 1 −1 1 −1 1 |
| | | −1 −1 1 −1 1 −1 −1 1 1 |
| | | 1 1 −1 −1 −1 −1 1 −1 1 |
| | | −1 1 1 −1 −1 −1 1 0 |
| | | −1 1 −1 −1 1 1 −1 −1 |
| | | −1 1 1 1 −1 1 0 −1 1 |
| | | −1 −1 1 1 1 −1 −1 1 1 |
| | | 1 −1 −1 −1 1 1 1 −1 −1 |
| | | 1 1 −1 −1 1 1 −1 −1 −1 |
| | | 1 −1 −1 0 −1 −1 −1 −1 −1 |
| | | 1 1 1 −1 1 1 1 −1 1 |
| | | 1 −1 1 −1 −1 −1 −1 −1 −1 |
| | | −1 1 1 −1 −1 1 −1 1 −1 |
| | | 1 1 1 −1 1 1 −1 1 1 |
| | | 1 −1 1 −1 −1 1 1 1 −1 |
| | | 1 1 1 1 −1 −1 1 1 1 |
| | | 1 −1 1 −1 1 1 1 −1 1 |
| | | 1 1 −1 −1 1 −1 −1 1 −1 |
| | | 1 −1 −1 1 −1 −1 −1 1 1 |
| | | −1 −1 1 −1 −1 1 1 1 −1 |
| | | 1 −1 −1 1 −1 −1 −1 −1 1 |
| | | −1 1 1 1 1 1 1 −1 1 |
| | | 1 −1 −1 1 −1 −1 −1 1 −1 |
| | | 1 −1 1 −1 −1 −1 −1 −1 1 |
| | | 1 −1 1 1 −1 −1 −1 −1 −1 |
| | | 1 1 −1 −1 −1 1 −1 1 1 |
| | | 1 −1 −1 −1 1 1 1 1 −1 |
| | | 1 −1 1 1 1 −1 −1 −1 −1 |
| | | 1 1 1 1 −1 1 −1 1 −1 |
| | | −1 1 1 −1 −1 −1 −1 −1 −1 |
| | | −1 1 −1 −1 −1 1 1 1 0 |
| | | 1 −1 −1 1 −1 −1 1 −1 1 |
| | | 1 −1 1 −1 −1 −1 −1 −1 1 |
| | | −1 −1 1 −1 1 1 1 −1 1 |
| | | 1 −1 1 −1 0 1 1 −1 1 |
| | | 1 −1 −1 −1 1 −1 1 1 −1 |
| | | 0 1 −1 1 −1 −1 −1 −1 −1 |
| | | −1 1 1 1 1 1 −1 −1 1 |
| | | 1 −1 1 1 1 −1 1 1 1 |
| | | 1 1 1 −1 −1 1 1 −1 1 |
| | | 1 0 −1 0 −1 1 1 1 1 |
| | | 1 1 −1 1 1 −1 1 1 1 |
| | | 1 −1 −1 −1 −1 1 −1 1 1 |
| | | 1 −1 −1 1 1 1 1 1 −1 |
| | | −1 −1 1 −1 −1 −1 1 −1 1 |
| | | −1 1 1 1 −1 −1 −1 1 1 |
| | | 1 1 1 1 −1 1 1 −1 1 |
| | | −1 −1 1 1 1 1 1 1 −1 |
| | | 1 1 1 −1 −1 1 −1 1 1 |
| | | −1 −1 −1 1 1 −1 −1 1 −1 |
| | | −1 −1 −1 1 −1 −1 −1 −1 −1 |
| | | −1 −1 1 1 −1 1 −1 −1 1 |
| | | −1 −1 1 −1 1 1 1 1 −1 |
| | | 1 1 0 1 1 1 0 1 1 |
| | | −1 1 0 −1 1 1 1 1 −1 |
| | | −1 −1 1 1 −1 1 1 1 1 |
| | | 1 1 −1 −1 1 −1 −1 −1 −1 |
| | | 1 −1 1 1 −1 −1 1 1 1 |
| | | −1 −1 −1 −1 −1 1 1 1 1 |
| | | −1 1 1 1 −1 1 −1 −1 1 |
| | | −1 1 −1 −1 −1 1 −1 1 −1 |
| | | −1 −1 1 −1 1 1 −1 1 −1 |
| | | 1 −1 1 −1 −1 1 1 −1 1 |
| | | 1 −1 1 1 1 0 −1 1 1 |
| | | −1 −1 −1 −1 1 −1 1 −1 1 |
| | | 1 1 −1 1 −1 −1 0 −1 −1 |
| | | −1 1 −1 1 −1 1 1 1 −1 |
| | | 1 −1 1 1 −1 −1 −1 1 1 |
| | | −1 1 1 1 1 −1 −1 −1 −1 |
| | | −1 1 1 1 1 1 −1 1 −1 |
| | | −1 0 1 1 1 1 −1 1 1 |
| | | 1 1 1 1 −1 1 −1 −1 −1 |
| | | 1 1 −1 1 1 −1 −1 −1 1 |
| | | 1 1 1 −1 1 −1 −1 1 1 |
| | | 1 1 1 −1 −1 1 −1 −1 1 |
| | | 1 −1 −1 −1 −1 1 1 −1 1 |
| | | −1 −1 −1 1 1 −1 1 1 1 |
| | | 1 1 1 −1 −1 1 1 1 1 |
| | | 1 1 −1 −1 −1 −1 1 −1 1 |
| | | −1 −1 −1 −1 1 1 1 −1 1 |
| | | 1 −1 1 1 −1 1 1 −1 1 |
| | | −1 −1 −1 −1 −1 1 1 1 1 |
| | | 1 1 −1 1 −1 1 −1 1 1 |
| | | −1 −1 1 1 −1 −1 1 1 −1 |
| | | 1 0 1 −1 1 1 1 −1 1 |
| | | 1 1 1 1 1 1 −1 1 1 |
| | | 1 0 1 −1 0 1 −1 1 −1 |
| | | 1 1 1 1 −1 0 −1 1 1 |
| | | −1 1 −1 −1 1 −1 1 1 −1 |
| | | 1 −1 −1 −1 −1 −1 1 −1 −1 |
| | | −1 1 −1 1 1 −1 −1 1 1 |
| | | 1 1 1 0 1 −1 −1 −1 1 |
| | | −1 −1 −1 −1 1 0 1 −1 −1 |
| | | 1 −1 −1 −1 −1 1 −1 1 1 |
| | | −1 −1 0 −1 −1 −1 −1 1 −1 |
| | | −1 1 −1 1 1 −1 −1 1 1 |
| | | 1 −1 1 −1 −1 1 −1 1 1 |
| | | −1 1 −1 −1 −1 1 −1 1 1 |
| | | 1 1 −1 −1 −1 1 1 −1 −1 |
| | | 1 1 −1 1 1 −1 −1 1 1 |
| | | −1 1 −1 −1 1 −1 1 1 1 |
| | | 1 1 −1 −1 −1 −1 1 −1 −1 |
| | | 1 1 1 1 1 1 −1 1 −1 |
| | | 1 0 −1 −1 1 −1 −1 −1 −1 |
| | | −1 −1 1 1 −1 1 1 −1 −1 |
| | | 1 −1 −1 −1 −1 0 −1 1 −1 |
| | | 1 −1 −1 −1 1 1 −1 −1 −1 |
| | | −1 −1 1 −1 −1 −1 −1 −1 −1 |
| | | 1 1 −1 −1 −1 1 1 1 1 |
| | | 1 −1 −1 1 1 −1 1 −1 −1 |
| | | −1 −1 −1 1 −1 −1 −1 1 1 |
| | | 1 −1 −1 −1 −1 1 1 −1 −1 |
| | | 1 1 1 −1 1 1 −1 1 −1 |
| | | 1 −1 −1 −1 1 0 1 −1 1 |
| | | 1 −1 1 0 1 1 −1 −1 1 |
| | | 1 1 −1 −1 1 −1 −1 −1 −1 |
| | | −1 −1 −1 −1 −1 −1 −1 1 1 |
| | | 1 1 −1 −1 −1 1 −1 1 1 |
| | | 1 1 −1 1 −1 1 1 −1 −1 |
| | | 1 1 1 −1 1 1 1 1 1 |
| | | −1 1 −1 1 −1 −1 0 1 1 |
| | | 1 −1 −1 −1 1 1 −1 1 1 |
| | | 1 1 −1 1 1 −1 −1 1 1 |
| | | −1 1 1 1 1 1 −1 −1 −1 |
| | | 1 1 −1 −1 −1 1 1 −1 1 |
| | | 1 −1 1 −1 1 1 1 −1 −1 |
| | | 1 −1 0 −1 −1 −1 −1 −1 −1 |
| | | 1 −1 −1 −1 1 −1 −1 1 1 |
| | | 1 1 1 −1 1 1 1 −1 −1 |
| | | 1 1 0 0 1 −1 −1 −1 −1 |
| | | 1 1 −1 −1 1 1 −1 −1 1 |
| | | 1 −1 −1 −1 1 −1 −1 1 1 |
| | | −1 1 1 1 1 1 1 1 1 |
| | | −1 −1 0 1 −1 −1 1 1 −1 |
| | | −1 −1 1 1 1 1 −1 1 −1 |
| | | 1 −1 1 1 −1 1 1 1 −1 |
| | | −1 1 1 1 1 1 −1 −1 1 |
| | | −1 1 1 1 1 −1 1 1 −1 |
| | | 1 1 1 −1 1 1 −1 −1 1 |
| | | 0 1 1 −1 −1 1 1 −1 −1 |
| | | −1 −1 1 −1 −1 1 1 −1 0 |
| | | 1 1 1 1 −1 0 −1 −1 1 |
| | | 1 1 1 1 −1 1 1 1 −1 |
| | | 1 −1 −1 1 −1 −1 −1 1 −1 |
| | | −1 1 1 1 1 1 1 1 1 |
| | | 1 1 −1 1 1 −1 1 1 −1 |
| | | 1 −1 −1 −1 1 −1 1 −1 1 |
| | | −1 1 −1 −1 −1 1 −1 −1 −1 |
| | | −1 1 1 1 −1 1 1 1 −1 |
| | | −1 1 −1 1 1 −1 −1 −1 1 |
| | | 1 1 −1 −1 1 −1 1 1 1 |
| | | −1 −1 −1 −1 −1 −1 −1 1 −1 |
| | | 1 1 −1 −1 1 1 1 −1 1 |
| | | 1 1 −1 1 −1 −1 −1 1 1 |
| | | 1 −1 1 1 1 −1 −1 −1 1 |
| | | 1 −1 1 1 −1 1 −1 −1 −1 |
| | | −1 −1 −1 1 −1 −1 −1 −1 1 |
| | | 1 −1 1 1 1 1 0 1 1 |
| | | −1 1 1 −1 1 1 1 1 1 |
| | | −1 −1 1 −1 1 1 −1 −1 1 |
| | | −1 −1 −1 −1 −1 1 −1 −1 1 |
| | | −1 1 −1 −1 1 −1 1 1 −1 |
| | | −1 −1 −1 1 1 1 −1 −1 1 |
| | | 1 −1 −1 1 −1 1 1 −1 −1 |
| | | 1 1 1 1 1 −1 −1 1 1 |
| | | −1 1 −1 −1 1 −1 −1 1 1 |
| | | 1 1 −1 1 −1 1 −1 −1 −1 |
| | | −1 1 1 1 1 −1 1 −1 −1 |
| | | −1 1 1 1 −1 −1 −1 1 −1 |
| | | 1 −1 −1 1 1 1 −1 −1 −1 |
| | | −1 1 1 1 −1 1 −1 1 1 |
| | | 1 1 1 −1 −1 −1 −1 1 −1 |
| | | 1 −1 1 1 1 1 1 −1 1 |
| | | −1 −1 −1 1 1 −1 −1 1 1 |
| | | −1 −1 −1 1 1 1 −1 −1 1 |
| | | 1 1 −1 1 1 −1 1 1 −1 |
| | | −1 1 1 1 1 1 1 −1 1 |
| | | 1 1 |

For example, the second sequence is constructed by using a Golay (Golay) sequence. The second sequence that satisfies the length requirement of Table 1 is constructed by using Golay sequences with lengths of 512, 1024, 2048, and 4096.

Definition of the Golay sequence:

A sequence a=(a₀, a₁, . . . , a₂_{^{m-_1}}) is defined, where aᵢ=(Σₖ₌₁^{m-1}i_{π(k)}i_{π(k+1)}+Σₖ₌₁^{m}cₖiₖ+c₀) mod 2, π is a permutation of (1, 2, 3, . . . , m), i=Σₖ₌₁^{m}iₖ2^{k-1}, and cₖ∈{0,1}.

When π satisfies any one of the following conditions, the Golay sequence may be constructed:
(1) π(1)=1, and π(2)=2;
(2) π(1)=m, and π(2)=m−1;
(3) π(2)=2, π(3)=1, π(4)=3, and c1=0;
(4) π(2)=m−1, π(3)=m, π(4)=m−2, and c1=1;
(5) π(1)=1, π(2)=2, π(3)=3, and c1=1; and
(6) π(1)=m−1, π(2)=m, π(3)=m−2, and c1=1.

The following Table 4 shows Golay sequences of different lengths. For the Golay sequences in Table 4, a generation condition is π(1)=1, π(2)=2, π(3)=3, . . . , π(m)=m, and cₖ=0.

TABLE 4

| Golay | |
|---|---|
| sequence | |
| length | Golay sequence |

| | | |
|---|---|---|
| 512 | 1 | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 1 1 1 |
| | | −1 1 1 −1 1 −1 −1 −1 1 1 |
| | | 1 −1 1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 |
| 1024 | 1 | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 1 1 1 |
| | | −1 1 1 −1 1 −1 −1 −1 1 1 |
| | | 1 −1 1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 −1 −1 −1 |
| | | 1 −1 −1 1 −1 −1 −1 −1 1 1 |
| | | 1 −1 1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 |
| 2048 | 1 | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 1 1 1 |
| | | −1 1 1 −1 1 −1 −1 −1 1 1 |
| | | 1 −1 1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 −1 −1 −1 |
| | | 1 −1 −1 1 −1 −1 −1 −1 1 1 |
| | | 1 −1 1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 −1 −1 −1 1 −1 −1 1 |
| | | −1 −1 −1 −1 1 1 1 −1 1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 −1 −1 −1 1 −1 −1 1 −1 1 |
| | | 1 1 −1 −1 −1 1 −1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 |
| 4096 | 1 | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 1 1 1 |
| | | −1 1 1 −1 1 −1 −1 −1 1 1 |
| | | 1 −1 1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 −1 −1 −1 |
| | | 1 −1 −1 1 −1 −1 −1 −1 1 1 |
| | | 1 −1 1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 −1 −1 −1 1 −1 −1 1 |
| | | −1 −1 −1 −1 1 1 1 −1 1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 −1 −1 −1 1 −1 −1 1 −1 1 |
| | | 1 1 −1 −1 −1 1 −1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 −1 −1 −1 1 −1 −1 1 |
| | | −1 −1 −1 −1 1 1 1 −1 1 1 |
| | | 1 1 −1 1 1 −1 1 −1 −1 −1 |
| | | 1 1 1 −1 1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 −1 −1 −1 1 −1 −1 1 |
| | | −1 −1 −1 −1 1 1 1 −1 1 1 |
| | | 1 1 −1 1 1 −1 1 −1 −1 −1 |
| | | 1 1 1 −1 1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 −1 −1 −1 1 −1 −1 1 −1 1 |
| | | 1 1 −1 −1 −1 1 −1 −1 −1 −1 |
| | | 1 −1 −1 1 −1 −1 −1 −1 1 1 |
| | | 1 −1 1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 −1 −1 −1 |
| | | 1 −1 −1 1 −1 −1 −1 −1 1 1 |
| | | 1 −1 1 −1 −1 −1 1 −1 −1 1 |
| | | −1 1 1 1 −1 −1 −1 1 −1 1 |
| | | 1 1 −1 1 1 −1 1 1 1 1 |
| | | −1 −1 −1 1 −1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 −1 −1 −1 1 −1 −1 1 |
| | | −1 −1 −1 −1 1 1 1 −1 1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 −1 −1 −1 1 −1 |
| | | −1 1 −1 −1 −1 −1 1 1 1 −1 |
| | | 1 1 1 1 −1 1 1 −1 1 −1 |
| | | −1 −1 1 1 1 −1 1 −1 −1 −1 |
| | | 1 −1 −1 1 −1 −1 −1 −1 1 1 |
| | | 1 −1 1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 1 1 1 −1 1 1 −1 1 −1 |
| | | −1 −1 1 1 1 −1 1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 1 1 1 −1 1 1 −1 1 1 |
| | | 1 1 −1 −1 −1 1 −1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 1 |
| | | 1 1 −1 1 1 −1 1 −1 −1 −1 |
| | | 1 1 1 −1 1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 −1 |
| | | −1 −1 1 −1 −1 1 −1 −1 −1 −1 |
| | | 1 1 1 −1 1 1 1 1 −1 1 |
| | | 1 −1 1 −1 −1 −1 1 1 1 −1 |
| | | 1 1 1 1 −1 1 1 −1 1 1 |
| | | 1 1 −1 −1 −1 1 −1 1 1 1 |
| | | −1 1 1 −1 1 −1 −1 −1 1 1 |
| | | 1 −1 1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 −1 −1 −1 1 −1 |
| | | −1 1 −1 −1 −1 −1 1 1 1 −1 |
| | | 1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 −1 −1 −1 1 −1 −1 1 |
| | | −1 1 1 1 −1 −1 −1 1 −1 −1 |
| | | −1 −1 1 −1 −1 1 −1 −1 −1 −1 |
| | | 1 1 1 −1 1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 1 1 1 |
| | | −1 1 1 −1 1 −1 −1 −1 1 1 |
| | | 1 −1 1 −1 −1 −1 1 −1 −1 1 |
| | | −1 −1 −1 −1 1 1 1 −1 1 −1 |
| | | −1 −1 1 −1 −1 1 −1 1 1 1 |
| | | −1 −1 −1 1 −1 1 1 1 −1 1 |
| | | 1 −1 1 1 1 1 −1 −1 −1 1 |
| | | −1 −1 −1 −1 1 −1 −1 1 −1 1 |
| | | 1 1 −1 −1 −1 1 −1 1 1 1 |
| | | −1 1 1 −1 1 1 1 1 −1 −1 |
| | | −1 1 −1 1 1 1 −1 1 1 −1 |
| | | 1 −1 −1 −1 1 1 1 −1 1 1 |
| | | 1 1 −1 1 1 −1 1 1 1 1 |
| | | −1 −1 −1 1 −1 −1 −1 −1 1 −1 |
| | | −1 1 −1 1 1 1 −1 −1 −1 1 |
| | | −1 −1 −1 −1 1 −1 −1 1 −1 −1 |
| | | −1 −1 1 1 1 −1 1 −1 −1 −1 |
| | | 1 −1 −1 1 −1 1 1 1 −1 −1 |
| | | −1 1 −1 1 1 1 −1 1 1 −1 |
| | | 1 1 1 1 −1 −1 −1 1 −1 −1 |
| | | −1 −1 1 −1 −1 1 −1 1 1 1 |
| | | −1 −1 −1 1 −1 |

For another example, the second sequence is constructed by using a perfect ternary sequence (Perfect Ternary Sequence).

It is assumed that a is a primitive element in a finite field GF (qⁿ), and β=α^{N}, where q is an odd prime power, n is an odd number, and N=(qⁿ−1)/(q−1). A ternary sequence is defined as follows:

$${S}_{i} \{ \begin{matrix}0 ; {Tr}_{{q}^{n} / q} ( {α}^{i} ) = 0 \\ {( - 1 )}^{i + k} ; {Tr}_{{q}^{n} / q} ( {α}^{i} ) = {β}^{k}\end{matrix}$$

Then, (s₀, s₁, . . . , s_{N-1}) is a perfect ternary sequence.

$${Tr}_{{q}^{n} / q} ( {α}^{i} ) = {\sum }_{i = 1}^{n} {( {α}^{i} )}^{{q}^{i}}$$

A sequence generated based on the foregoing manner is shown in the following Table 5.

TABLE 5

| Perfect ternary | | |
|---|---|---|
| sequence length | Perfect ternary sequence | |
| 1893 | −1 | 0 1 −1 −1 1 1 −1 1 −1 1 |
| | | 1 −1 1 −1 1 1 1 −1 −1 1 |
| | | 1 −1 1 1 −1 −1 −1 1 1 1 |
| | | −1 1 1 1 −1 1 −1 −1 1 −1 |
| | | −1 −1 0 1 −1 −1 −1 −1 0 1 |
| | | −1 −1 −1 1 −1 1 1 −1 1 1 |
| | | −1 1 −1 −1 −1 1 1 −1 −1 −1 |
| | | 1 1 −1 −1 1 1 1 −1 0 −1 |
| | | −1 1 −1 1 −1 1 1 1 −1 1 |
| | | 1 −1 −1 1 1 −1 −1 1 −1 1 |
| | | 1 1 −1 1 −1 −1 1 1 −1 1 |
| | | −1 1 −1 −1 −1 1 −1 −1 −1 −1 |
| | | −1 1 −1 1 1 1 1 −1 −1 −1 |
| | | −1 −1 −1 −1 1 −1 1 −1 −1 1 |
| | | 1 −1 1 1 1 −1 −1 −1 −1 1 |
| | | −1 −1 1 1 1 1 −1 1 1 −1 |
| | | −1 −1 1 −1 1 −1 1 1 −1 −1 |
| | | −1 −1 1 1 −1 −1 1 1 1 1 |
| | | 1 1 −1 −1 1 1 1 1 1 1 |
| | | −1 1 1 1 −1 −1 −1 1 −1 1 |
| | | 1 −1 −1 1 −1 −1 1 −1 1 1 |
| | | 1 1 −1 0 1 −1 −1 −1 −1 −1 |
| | | −1 −1 1 1 1 1 −1 −1 1 1 |
| | | 1 −1 −1 −1 1 −1 −1 1 1 −1 |
| | | 1 −1 1 −1 1 −1 −1 −1 −1 −1 |
| | | 1 1 1 1 −1 1 1 1 1 −1 |
| | | −1 −1 1 1 −1 −1 −1 −1 1 1 |
| | | 1 1 1 1 −1 1 −1 1 1 −1 |
| | | −1 1 1 −1 1 1 1 −1 −1 1 |
| | | −1 1 −1 −1 1 −1 −1 −1 1 −1 |
| | | −1 −1 −1 −1 0 1 −1 −1 1 0 |
| | | 1 1 −1 1 −1 −1 −1 1 −1 −1 |
| | | −1 1 −1 1 1 −1 −1 1 0 1 |
| | | 1 −1 −1 1 1 1 −1 1 −1 −1 |
| | | 1 −1 −1 1 1 −1 1 −1 −1 −1 |
| | | 1 1 −1 −1 −1 −1 1 −1 −1 1 |
| | | −1 1 1 1 1 −1 1 −1 1 −1 |
| | | 1 1 1 −1 −1 −1 −1 −1 −1 −1 |
| | | 1 1 1 1 −1 −1 −1 1 1 −1 |
| | | −1 1 −1 1 1 −1 1 1 −1 1 |
| | | −1 −1 1 1 −1 −1 1 −1 −1 −1 |
| | | 1 1 1 0 1 1 −1 1 −1 1 |
| | | −1 1 1 1 1 1 −1 1 1 1 |
| | | 1 1 1 1 −1 1 −1 1 1 −1 |
| | | 1 1 −1 −1 −1 −1 −1 1 −1 1 |
| | | 1 1 1 1 −1 −1 1 −1 1 1 |
| | | −1 1 1 1 1 −1 −1 1 1 1 |
| | | −1 −1 1 0 −1 1 1 1 1 1 |
| | | −1 0 −1 −1 1 1 −1 −1 1 −1 |
| | | 1 −1 −1 −1 1 1 −1 −1 −1 1 |
| | | −1 1 1 1 1 1 −1 1 −1 1 |
| | | −1 1 1 1 1 −1 −1 −1 1 1 |
| | | −1 1 −1 1 −1 1 −1 1 −1 −1 |
| | | −1 −1 −1 −1 −1 −1 −1 1 −1 1 |
| | | −1 −1 −1 −1 1 1 −1 −1 1 −1 |
| | | 1 −1 −1 −1 1 1 1 1 1 1 |
| | | −1 0 1 −1 −1 1 −1 1 1 −1 |
| | | −1 1 1 −1 1 1 −1 1 −1 1 |
| | | −1 −1 1 1 1 1 1 −1 1 −1 |
| | | −1 1 −1 −1 1 1 −1 1 −1 1 |
| | | −1 −1 1 1 1 0 1 1 −1 −1 |
| | | 1 −1 1 −1 −1 −1 1 1 −1 1 |
| | | 1 −1 1 1 1 1 1 1 1 −1 |
| | | 0 1 −1 −1 −1 1 1 −1 1 1 |
| | | −1 −1 −1 1 1 −1 1 1 −1 −1 |
| | | 1 −1 −1 −1 −1 −1 −1 −1 −1 1 |
| | | 1 1 −1 −1 1 1 1 0 1 1 |
| | | −1 −1 −1 1 −1 −1 1 −1 1 −1 |
| | | 1 −1 −1 1 −1 1 1 1 1 1 |
| | | −1 1 −1 −1 −1 1 −1 1 −1 −1 |
| | | −1 −1 1 1 −1 −1 −1 1 −1 −1 |
| | | 1 1 1 0 1 1 −1 1 1 −1 |
| | | 1 1 1 1 −1 −1 1 −1 −1 −1 |
| | | 1 −1 1 −1 1 −1 1 −1 −1 1 |
| | | 1 1 1 1 0 −1 1 1 −1 −1 |
| | | 1 1 1 1 −1 −1 −1 1 −1 −1 |
| | | −1 1 1 −1 0 −1 −1 1 1 1 |
| | | 1 −1 1 −1 −1 −1 −1 1 −1 −1 |
| | | 1 −1 1 1 −1 −1 1 −1 −1 −1 |
| | | −1 −1 −1 −1 −1 1 −1 −1 1 −1 |
| | | 1 1 −1 −1 −1 1 1 1 1 −1 |
| | | 1 1 −1 −1 1 −1 −1 −1 −1 −1 |
| | | 1 −1 1 −1 1 1 −1 1 1 1 |
| | | −1 1 1 1 0 −1 1 1 1 1 |
| | | −1 1 1 1 −1 1 1 −1 1 1 |
| | | 1 1 1 −1 −1 −1 −1 1 −1 1 |
| | | −1 −1 1 −1 1 −1 1 1 −1 1 |
| | | −1 −1 −1 1 0 −1 1 1 1 1 |
| | | 1 1 −1 −1 −1 1 −1 1 1 −1 |
| | | 1 1 −1 −1 1 0 1 1 −1 1 |
| | | −1 −1 1 1 −1 1 −1 1 −1 −1 |
| | | 1 1 1 1 −1 1 −1 1 1 1 |
| | | −1 −1 1 −1 −1 −1 1 −1 1 −1 |
| | | −1 −1 −1 −1 1 1 1 −1 1 1 |
| | | −1 1 1 1 1 −1 −1 1 −1 1 |
| | | 1 −1 −1 −1 1 −1 −1 −1 1 1 |
| | | 1 −1 −1 −1 1 1 1 −1 1 −1 |
| | | 1 1 1 −1 1 1 1 −1 1 −1 |
| | | −1 1 1 1 −1 1 −1 1 1 −1 |
| | | 1 −1 −1 1 −1 1 −1 −1 −1 1 |
| | | 1 −1 1 −1 −1 −1 −1 −1 −1 −1 |
| | | 1 1 1 −1 −1 −1 1 1 1 −1 |
| | | 1 1 1 −1 −1 −1 −1 1 1 1 |
| | | −1 1 1 1 1 −1 1 −1 −1 −1 |
| | | 1 1 −1 −1 −1 1 −1 −1 −1 1 |
| | | −1 1 −1 −1 −1 −1 −1 1 −1 −1 |
| | | −1 −1 −1 −1 1 −1 −1 −1 −1 1 |
| | | 1 −1 −1 −1 −1 −1 1 −1 1 −1 |
| | | −1 −1 −1 −1 1 1 −1 1 1 1 |
| | | −1 1 −1 −1 −1 1 1 1 −1 −1 |
| | | −1 −1 1 −1 1 −1 1 −1 1 −1 |
| | | 1 1 −1 −1 1 −1 −1 −1 −1 0 |
| | | 1 −1 −1 −1 1 −1 −1 1 1 −1 |
| | | 1 1 −1 0 1 −1 −1 −1 −1 1 |
| | | −1 1 −1 −1 1 1 −1 −1 1 −1 |
| | | −1 1 −1 1 −1 −1 −1 1 −1 1 |
| | | −1 1 −1 1 1 1 −1 −1 −1 1 |
| | | 1 1 −1 −1 1 −1 −1 1 1 −1 |
| | | −1 1 −1 1 −1 −1 −1 −1 1 1 |
| | | 1 1 1 1 1 −1 1 1 −1 1 |
| | | −1 1 1 1 1 1 −1 1 −1 1 |
| | | −1 −1 −1 −1 0 −1 −1 1 −1 −1 |
| | | −1 1 1 1 −1 −1 −1 1 1 −1 |
| | | 1 1 1 −1 1 1 1 1 1 −1 |
| | | −1 −1 −1 −1 −1 −1 1 1 1 −1 |
| | | −1 1 0 1 1 −1 −1 1 −1 −1 |
| | | −1 0 1 −1 −1 1 1 −1 −1 −1 |
| | | −1 −1 1 −1 1 −1 −1 1 1 1 |
| | | 1 1 1 −1 −1 −1 −1 −1 −1 1 |
| | | −1 −1 −1 0 −1 −1 1 −1 1 1 |
| | | 1 1 1 1 1 −1 1 1 −1 −1 |
| | | −1 1 1 1 1 −1 1 −1 1 1 |
| | | 1 1 −1 −1 1 −1 1 1 1 1 |
| | | −1 1 −1 1 −1 −1 −1 1 1 1 |
| | | −1 1 1 −1 −1 1 1 −1 −1 −1 |
| | | 1 1 −1 1 −1 1 1 −1 −1 −1 |
| | | 1 1 1 1 −1 −1 1 1 −1 −1 |
| | | 1 −1 −1 −1 1 1 1 −1 −1 −1 |
| | | −1 1 −1 1 −1 −1 −1 1 −1 −1 |
| | | −1 −1 −1 −1 1 −1 1 −1 1 −1 |
| | | 1 1 1 −1 −1 1 −1 −1 1 1 |
| | | −1 1 −1 1 1 1 −1 1 1 −1 |
| | | −1 −1 1 −1 −1 1 −1 1 −1 1 |
| | | −1 1 −1 1 1 1 0 1 1 −1 |
| | | −1 1 1 1 −1 −1 −1 −1 0 0 |
| | | −1 0 1 −1 −1 −1 1 1 −1 1 |
| | | −1 1 −1 −1 1 1 −1 −1 1 1 |
| | | 1 −1 1 1 −1 −1 1 1 1 1 |
| | | −1 −1 1 1 −1 −1 −1 1 −1 −1 |
| | | 1 1 1 1 −1 1 −1 −1 1 −1 |
| | | 1 1 −1 0 −1 −1 1 0 −1 1 |
| | | 1 −1 −1 1 1 1 −1 1 1 −1 |
| | | 1 −1 −1 1 −1 −1 1 1 −1 1 |
| | | 1 1 1 −1 1 −1 1 1 1 1 |
| | | 1 −1 1 1 1 1 −1 1 1 1 |
| | | 1 −1 1 −1 −1 −1 1 −1 −1 1 |
| | | 1 1 −1 −1 −1 −1 −1 −1 −1 1 |
| | | −1 −1 1 −1 1 −1 −1 −1 −1 −1 |
| | | 1 1 1 1 −1 1 −1 −1 1 −1 |
| | | −1 −1 1 1 −1 1 −1 1 −1 −1 |
| | | −1 −1 1 −1 1 −1 −1 1 −1 −1 |
| | | 1 −1 −1 1 1 1 −1 1 1 −1 |
| | | −1 1 1 1 1 −1 −1 −1 1 0 |
| | | −1 1 1 −1 1 −1 −1 −1 1 1 |
| | | 1 −1 1 1 −1 1 −1 1 −1 −1 |
| | | −1 −1 −1 −1 −1 −1 1 0 −1 1 |
| | | 1 −1 −1 1 −1 −1 1 −1 −1 1 |
| | | −1 1 1 −1 1 −1 1 −1 1 1 |
| | | −1 1 −1 1 −1 −1 1 −1 −1 −1 |
| | | −1 −1 1 1 1 1 1 −1 −1 1 |
| | | −1 1 −1 1 −1 −1 −1 1 1 1 |
| | | 1 1 −1 −1 −1 −1 −1 −1 1 −1 |
| | | −1 −1 −1 0 −1 −1 1 1 1 1 |
| | | 0 −1 1 1 1 1 −1 −1 1 −1 |
| | | −1 1 −1 1 1 −1 0 −1 −1 1 |
| | | 1 −1 −1 −1 −1 −1 0 −1 −1 1 |
| | | −1 −1 −1 −1 −1 −1 −1 −1 1 −1 |
| | | 1 1 1 0 1 1 −1 −1 −1 −1 |
| | | 1 1 −1 −1 1 −1 1 1 −1 −1 |
| | | −1 −1 −1 −1 1 0 1 1 −1 1 |
| | | −1 −1 1 −1 1 −1 1 −1 1 −1 |
| | | −1 −1 −1 1 1 −1 −1 −1 1 1 |
| | | 1 1 −1 −1 −1 −1 1 1 1 1 |
| | | 0 −1 1 1 −1 −1 −1 −1 −1 1 |
| | | 1 1 −1 1 −1 −1 −1 1 0 1 |
| | | 1 −1 1 −1 1 −1 1 1 1 0 |
| | | −1 1 1 −1 1 −1 −1 −1 −1 1 |
| | | −1 −1 1 −1 −1 1 1 1 −1 1 |
| | | 1 −1 −1 −1 1 −1 1 −1 −1 −1 |
| | | 1 1 |
| 3783 | 1 | 0 1 1 −1 −1 1 −1 1 1 1 |
| | | 1 1 −1 −1 −1 1 −1 −1 1 1 |
| | | 1 −1 1 −1 1 −1 −1 −1 1 −1 |
| | | −1 1 −1 1 1 −1 −1 −1 −1 1 |
| | | 1 0 −1 1 1 −1 −1 −1 −1 −1 |
| | | 1 1 1 1 −1 −1 −1 1 −1 −1 |
| | | 0 −1 −1 1 −1 1 −1 −1 −1 −1 |
| | | 1 1 1 −1 −1 −1 1 −1 1 1 |
| | | 0 1 1 −1 −1 −1 1 −1 −1 0 |
| | | 1 −1 −1 −1 −1 −1 −1 −1 1 1 |
| | | 1 −1 1 1 −1 −1 1 1 −1 −1 |
| | | 1 1 −1 1 1 −1 1 1 1 1 |
| | | 1 1 −1 1 −1 1 −1 1 −1 1 |
| | | 1 1 1 −1 −1 −1 −1 1 1 1 |
| | | −1 1 1 1 1 1 1 1 −1 −1 |
| | | −1 1 1 −1 1 −1 1 −1 −1 1 |
| | | 1 1 −1 −1 −1 −1 −1 −1 1 1 |
| | | 1 −1 1 −1 −1 −1 1 −1 1 −1 |
| | | −1 −1 1 1 −1 −1 1 1 −1 1 |
| | | −1 1 −1 −1 1 1 1 −1 1 1 |
| | | −1 −1 1 1 1 −1 −1 −1 −1 1 |
| | | −1 1 1 1 −1 1 1 0 −1 1 |
| | | 1 −1 1 1 −1 1 1 1 1 −1 |
| | | −1 −1 1 1 1 −1 1 −1 1 1 |
| | | 1 1 1 −1 1 0 1 1 −1 1 |
| | | 1 1 1 −1 −1 −1 1 1 −1 1 |
| | | −1 1 1 −1 1 −1 −1 −1 −1 1 |
| | | 1 1 1 1 1 −1 1 1 0 −1 |
| | | 1 1 1 1 1 −1 −1 1 −1 1 |
| | | 1 1 1 −1 −1 −1 −1 −1 −1 1 |
| | | 1 −1 −1 −1 −1 1 −1 1 1 1 |
| | | −1 1 −1 1 1 1 1 −1 1 −1 |
| | | −1 −1 1 −1 1 −1 1 −1 −1 1 |
| | | −1 −1 −1 −1 −1 1 −1 1 1 1 |
| | | 1 1 1 1 −1 1 1 1 1 −1 |
| | | 1 1 −1 1 1 1 −1 −1 −1 −1 |
| | | 1 −1 1 1 −1 1 1 −1 1 1 |
| | | −1 1 −1 −1 1 −1 −1 −1 1 −1 |
| | | 1 −1 −1 −1 1 −1 1 −1 1 1 |
| | | −1 1 1 1 1 −1 −1 1 −1 1 |
| | | 0 1 1 −1 −1 −1 −1 −1 1 −1 |
| | | 1 1 −1 −1 0 1 −1 −1 −1 −1 |
| | | 1 1 −1 −1 1 −1 −1 −1 1 −1 |
| | | 1 −1 −1 −1 1 1 −1 1 −1 −1 |
| | | −1 −1 −1 −1 −1 1 −1 1 1 1 |
| | | −1 −1 1 −1 −1 −1 −1 −1 −1 −1 |
| | | 1 −1 1 1 −1 −1 1 1 −1 −1 |
| | | 1 −1 −1 1 1 1 1 −1 1 −1 |
| | | −1 −1 −1 −1 −1 1 −1 1 −1 −1 |
| | | 1 −1 1 0 −1 1 1 1 −1 −1 |
| | | −1 −1 −1 −1 −1 −1 −1 1 −1 1 |
| | | 1 1 1 −1 1 1 1 −1 1 1 |
| | | 1 1 1 1 −1 1 −1 1 −1 1 |
| | | −1 1 1 1 −1 1 1 −1 −1 −1 |
| | | −1 −1 1 1 1 1 1 1 1 −1 |
| | | 1 −1 1 1 −1 1 1 −1 1 −1 |
| | | −1 1 −1 −1 −1 1 −1 1 1 −1 |
| | | −1 −1 1 −1 −1 −1 −1 −1 −1 1 |
| | | −1 −1 −1 1 1 −1 1 1 −1 1 |
| | | −1 1 −1 −1 1 −1 −1 −1 −1 −1 |
| | | 1 −1 −1 −1 −1 1 1 −1 1 1 |
| | | −1 1 −1 −1 1 −1 1 1 −1 1 |
| | | 1 1 1 1 −1 1 −1 −1 −1 −1 |
| | | −1 1 −1 −1 1 −1 1 1 1 1 |
| | | −1 −1 1 1 1 1 1 1 1 −1 |
| | | 1 1 1 1 1 −1 −1 −1 1 1 |
| | | −1 1 −1 −1 −1 −1 −1 1 −1 1 |
| | | 1 1 −1 −1 −1 1 1 1 1 −1 |
| | | 1 −1 −1 1 −1 1 −1 1 1 1 |
| | | −1 −1 1 1 −1 −1 1 1 1 1 |
| | | −1 1 −1 −1 −1 1 −1 −1 1 1 |
| | | 1 1 −1 −1 0 1 −1 −1 −1 −1 |
| | | 1 1 −1 1 1 −1 −1 1 −1 −1 |
| | | −1 1 −1 −1 1 1 1 1 1 1 |
| | | 1 1 1 −1 −1 −1 1 −1 1 1 |
| | | 0 1 1 −1 1 −1 1 −1 1 1 |
| | | −1 −1 1 1 −1 1 1 −1 1 1 |
| | | −1 1 −1 1 1 −1 −1 −1 1 1 |
| | | 1 −1 −1 −1 −1 −1 1 1 −1 1 |
| | | −1 −1 −1 1 −1 −1 1 −1 −1 1 |
| | | 1 1 −1 −1 −1 −1 −1 −1 1 −1 |
| | | 1 −1 −1 1 1 −1 −1 −1 1 1 |
| | | −1 1 −1 −1 −1 −1 1 1 1 −1 |
| | | −1 1 −1 −1 1 1 1 −1 1 −1 |
| | | 1 −1 −1 −1 −1 1 1 −1 −1 1 |
| | | 1 1 −1 −1 −1 1 −1 −1 1 1 |
| | | −1 1 1 1 −1 −1 −1 −1 −1 1 |
| | | 1 −1 1 1 −1 1 −1 −1 −1 −1 |
| | | 1 −1 −1 −1 −1 −1 1 1 −1 1 |
| | | −1 1 1 1 −1 −1 1 1 −1 −1 |
| | | −1 −1 1 1 1 1 1 1 1 1 |
| | | 1 −1 1 1 −1 −1 −1 −1 −1 −1 |
| | | −1 1 −1 −1 −1 1 1 1 1 −1 |
| | | −1 1 −1 1 1 1 1 −1 1 1 |
| | | −1 −1 −1 1 −1 1 1 −1 1 1 |
| | | −1 1 1 −1 1 1 1 1 1 1 |
| | | 1 −1 1 1 1 −1 −1 1 1 −1 |
| | | −1 −1 −1 1 −1 1 −1 1 1 0 |
| | | 1 1 −1 −1 −1 1 1 −1 −1 1 |
| | | 1 −1 1 −1 −1 1 −1 −1 1 −1 |
| | | 1 −1 1 1 −1 −1 −1 1 1 −1 |
| | | −1 −1 1 1 1 1 −1 1 1 −1 |
| | | 1 1 −1 −1 −1 1 1 −1 1 −1 |
| | | 1 1 1 1 −1 1 −1 −1 −1 −1 |
| | | −1 1 1 1 −1 −1 1 −1 −1 1 |
| | | −1 −1 1 −1 1 −1 −1 1 1 1 |
| | | −1 1 1 −1 1 0 −1 1 1 1 |
| | | −1 1 −1 1 1 −1 −1 −1 −1 1 |
| | | 1 −1 −1 −1 −1 −1 1 1 −1 −1 |
| | | −1 1 −1 −1 1 1 1 −1 −1 1 |
| | | 1 −1 1 −1 −1 1 −1 1 −1 −1 |
| | | 1 1 0 1 1 −1 −1 1 −1 1 |
| | | −1 1 1 −1 −1 1 1 −1 1 1 |
| | | 1 1 1 1 −1 −1 1 1 1 −1 |
| | | −1 −1 −1 1 1 −1 1 −1 1 −1 |
| | | 1 1 −1 −1 −1 1 1 0 1 1 |
| | | −1 −1 1 −1 1 1 −1 1 −1 −1 |
| | | 1 1 1 1 −1 1 −1 −1 0 1 |
| | | −1 −1 −1 1 −1 −1 1 −1 1 −1 |
| | | 1 1 −1 1 1 −1 −1 1 −1 1 |
| | | 1 −1 1 −1 1 1 −1 1 1 1 |
| | | −1 1 −1 1 1 −1 −1 1 1 1 |
| | | 1 −1 1 1 −1 −1 −1 −1 −1 1 |
| | | −1 1 1 −1 −1 1 −1 −1 −1 1 |
| | | 1 −1 −1 1 1 1 −1 1 −1 1 |
| | | 1 1 −1 −1 −1 1 −1 −1 1 1 |
| | | 0 −1 1 1 1 −1 −1 1 −1 −1 |
| | | −1 −1 1 −1 1 −1 −1 −1 1 1 |
| | | 1 −1 1 1 1 −1 −1 1 1 −1 |
| | | −1 1 −1 1 −1 −1 −1 −1 1 1 |
| | | 1 −1 1 1 1 1 1 −1 −1 1 |
| | | 1 −1 −1 1 1 −1 1 1 1 −1 |
| | | 1 −1 1 1 −1 1 1 1 1 1 |
| | | −1 −1 1 −1 −1 1 −1 1 −1 1 |
| | | −1 −1 1 1 1 1 1 1 1 −1 |
| | | 1 1 −1 1 1 −1 1 1 −1 −1 |
| | | 1 −1 1 1 −1 1 1 −1 1 1 |
| | | −1 −1 −1 1 1 1 −1 1 1 −1 |
| | | 1 −1 1 1 1 −1 1 1 −1 1 |
| | | 1 −1 1 −1 1 −1 1 −1 1 −1 |
| | | 1 −1 1 1 −1 −1 1 −1 1 1 |
| | | 0 1 1 −1 −1 −1 1 −1 1 −1 |
| | | 1 −1 1 −1 1 1 −1 1 1 1 |
| | | 1 1 −1 −1 1 1 1 1 1 −1 |
| | | 1 1 1 1 −1 −1 −1 1 −1 1 |
| | | −1 −1 1 1 −1 1 −1 −1 −1 1 |
| | | 1 1 −1 −1 1 1 1 −1 1 1 |
| | | 1 −1 −1 −1 1 −1 1 1 −1 1 |
| | | −1 1 −1 −1 −1 −1 −1 1 −1 −1 |
| | | −1 1 1 1 1 1 −1 −1 1 −1 |
| | | 1 −1 −1 1 1 1 −1 −1 −1 1 |
| | | 1 −1 1 −1 1 −1 1 −1 −1 −1 |
| | | 1 −1 −1 1 1 −1 1 −1 1 −1 |
| | | 1 −1 −1 −1 1 1 1 −1 1 1 |
| | | 1 1 −1 1 1 −1 −1 −1 −1 1 |
| | | −1 −1 −1 −1 −1 1 1 1 1 1 |
| | | 1 −1 −1 1 1 −1 −1 −1 1 1 |
| | | 1 1 1 1 −1 1 1 1 −1 1 |
| | | 1 1 1 −1 −1 −1 1 −1 −1 −1 |
| | | 1 1 −1 1 1 −1 −1 −1 −1 −1 |
| | | 1 1 −1 −1 −1 1 1 −1 −1 −1 |
| | | −1 1 1 −1 1 0 0 1 0 −1 |
| | | 1 1 1 1 1 1 −1 1 −1 1 |
| | | 1 1 −1 −1 −1 1 1 1 1 1 |
| | | −1 −1 1 1 −1 −1 −1 −1 −1 −1 |
| | | 1 1 −1 −1 −1 1 1 1 −1 −1 |
| | | 1 1 −1 1 −1 −1 −1 −1 1 1 |
| | | −1 −1 1 1 1 −1 −1 1 1 1 |
| | | 1 1 1 −1 1 −1 1 1 1 1 |
| | | −1 −1 1 −1 −1 1 1 1 −1 1 |
| | | −1 1 1 −1 1 1 0 −1 1 1 |
| | | −1 −1 1 1 −1 −1 1 −1 −1 −1 |
| | | −1 −1 −1 1 −1 −1 −1 1 1 −1 |
| | | 1 1 1 1 −1 1 −1 −1 1 1 |
| | | 1 1 −1 −1 1 −1 1 −1 −1 −1 |
| | | 1 −1 1 1 1 1 −1 1 1 1 |
| | | −1 1 0 1 1 −1 1 1 1 −1 |
| | | 1 1 −1 −1 −1 −1 −1 1 1 1 |
| | | −1 −1 1 −1 −1 −1 −1 1 −1 0 |
| | | −1 −1 1 1 1 −1 1 1 1 −1 |
| | | −1 −1 −1 −1 1 −1 1 −1 −1 −1 |
| | | 1 −1 −1 1 1 1 1 1 1 −1 |
| | | 1 1 1 1 1 1 1 −1 −1 −1 |
| | | 1 −1 −1 −1 −1 1 −1 1 −1 −1 |
| | | 0 1 −1 −1 1 1 −1 1 −1 −1 |
| | | −1 −1 1 −1 −1 −1 1 1 −1 −1 |
| | | −1 −1 1 1 1 1 −1 −1 1 1 |
| | | −1 1 1 −1 −1 1 −1 1 1 −1 |
| | | 1 −1 −1 −1 1 1 0 1 1 −1 |
| | | −1 1 −1 −1 −1 1 1 1 1 1 |
| | | 1 −1 1 1 −1 1 1 1 1 1 |
| | | −1 1 1 1 1 −1 1 1 1 −1 |
| | | −1 1 −1 1 1 1 1 −1 −1 −1 |
| | | −1 −1 1 −1 −1 −1 −1 −1 −1 −1 |
| | | −1 1 1 1 −1 −1 1 −1 0 −1 |
| | | −1 1 −1 −1 −1 1 1 1 1 1 |
| | | 1 −1 1 1 −1 −1 −1 1 1 1 |
| | | 1 −1 1 −1 1 −1 1 −1 −1 1 |
| | | −1 −1 −1 1 1 0 −1 1 1 −1 |
| | | 1 −1 1 −1 1 1 −1 1 −1 1 |
| | | −1 0 1 −1 −1 1 −1 1 1 −1 |
| | | 1 −1 −1 1 −1 −1 −1 1 1 −1 |
| | | 1 1 1 1 −1 1 1 1 −1 −1 |
| | | −1 −1 1 1 −1 −1 1 −1 −1 1 |
| | | 1 1 1 −1 −1 −1 −1 −1 −1 −1 |
| | | 1 −1 1 −1 1 −1 1 1 1 −1 |
| | | −1 −1 1 1 1 1 1 −1 1 1 |
| | | 1 −1 −1 1 1 1 1 1 1 1 |
| | | −1 1 −1 −1 1 1 0 −1 1 1 |
| | | 1 −1 −1 −1 −1 −1 −1 1 −1 0 |
| | | −1 −1 1 1 −1 −1 1 1 −1 −1 |
| | | −1 1 1 −1 1 −1 1 −1 1 1 |
| | | 1 1 1 −1 1 −1 −1 −1 −1 −1 |
| | | 1 1 −1 −1 1 1 −1 −1 1 1 |
| | | −1 1 −1 −1 1 −1 1 −1 1 −1 |
| | | −1 −1 1 1 1 −1 1 1 −1 1 |
| | | 1 −1 1 −1 1 1 −1 1 1 −1 |
| | | −1 1 1 −1 1 −1 1 1 −1 −1 |
| | | −1 1 −1 1 −1 −1 −1 1 −1 −1 |
| | | 1 1 −1 1 −1 −1 1 1 1 1 |
| | | −1 1 −1 −1 0 1 −1 −1 1 −1 |
| | | −1 −1 −1 1 −1 0 1 −1 −1 −1 |
| | | −1 −1 1 −1 1 1 1 −1 −1 −1 |
| | | −1 1 1 −1 1 −1 −1 1 −1 −1 |
| | | 1 −1 1 −1 1 −1 −1 1 1 1 |
| | | 1 1 1 1 1 1 −1 1 −1 −1 |
| | | 1 1 −1 −1 1 −1 −1 1 −1 1 |
| | | 1 −1 1 1 0 1 1 −1 1 −1 |
| | | 1 1 −1 −1 −1 1 1 1 1 −1 |
| | | −1 −1 −1 −1 −1 −1 1 −1 −1 −1 |
| | | 1 −1 1 1 −1 −1 −1 −1 −1 1 |
| | | −1 −1 1 −1 1 1 1 −1 1 −1 |
| | | −1 −1 1 1 −1 1 −1 1 1 −1 |
| | | −1 1 1 1 −1 −1 −1 1 1 1 |
| | | −1 1 1 1 1 1 1 1 1 −1 |
| | | −1 1 1 −1 1 1 1 −1 1 −1 |
| | | −1 −1 1 1 1 −1 −1 1 1 −1 |
| | | −1 −1 1 1 −1 −1 −1 1 −1 1 |
| | | −1 −1 −1 1 1 −1 1 1 1 −1 |
| | | −1 1 −1 −1 −1 −1 1 1 −1 −1 |
| | | 1 −1 1 −1 −1 −1 1 1 −1 1 |
| | | 1 −1 1 1 −1 −1 1 1 −1 1 |
| | | 1 1 −1 1 −1 1 1 −1 1 1 |
| | | −1 1 1 1 −1 1 1 −1 −1 1 |
| | | 1 1 −1 −1 −1 1 −1 −1 −1 1 |
| | | −1 −1 −1 1 −1 1 1 1 −1 1 |
| | | 1 −1 1 −1 1 −1 1 0 −1 1 |
| | | 1 −1 −1 −1 −1 1 1 1 −1 1 |
| | | 1 1 1 1 1 −1 1 1 −1 −1 |
| | | −1 −1 1 1 −1 1 −1 1 −1 1 |
| | | 1 −1 1 −1 −1 −1 1 −1 1 0 |
| | | −1 1 1 1 −1 −1 1 −1 1 −1 |
| | | 1 0 1 1 −1 1 −1 −1 −1 1 |
| | | 1 −1 −1 1 −1 −1 1 −1 −1 −1 |
| | | 1 −1 1 0 1 1 −1 1 −1 −1 |
| | | 1 1 −1 −1 1 −1 1 1 1 −1 |
| | | 1 0 1 1 −1 1 −1 1 1 −1 |
| | | 1 −1 −1 −1 −1 1 −1 1 0 1 |
| | | 1 −1 1 1 −1 −1 0 −1 −1 1 |
| | | 1 −1 1 0 1 1 −1 −1 1 1 |
| | | 1 1 1 1 1 1 −1 −1 1 −1 |
| | | 1 1 −1 1 −1 1 0 −1 1 1 |
| | | −1 −1 −1 −1 −1 1 1 −1 −1 1 |
| | | −1 −1 −1 1 −1 1 1 −1 −1 1 |
| | | −1 1 −1 1 −1 −1 1 1 1 −1 |
| | | 1 1 −1 1 1 1 −1 1 1 −1 |
| | | 1 −1 1 1 −1 1 −1 1 1 −1 |
| | | 1 1 −1 −1 −1 −1 −1 1 1 1 |
| | | −1 −1 −1 1 −1 −1 −1 1 −1 1 |
| | | 1 −1 −1 −1 −1 −1 1 1 1 −1 |
| | | −1 1 1 0 −1 1 1 1 1 −1 |
| | | 1 1 −1 −1 −1 −1 −1 −1 1 1 |
| | | −1 1 1 1 1 1 −1 −1 −1 −1 |
| | | 1 1 −1 −1 −1 −1 −1 1 −1 1 |
| | | 1 −1 1 1 1 −1 1 1 −1 −1 |
| | | −1 −1 −1 1 −1 1 −1 −1 −1 1 |
| | | 1 −1 1 −1 −1 1 −1 −1 1 −1 |
| | | 0 1 −1 −1 1 1 −1 −1 −1 1 |
| | | −1 −1 −1 1 1 −1 1 −1 1 −1 |
| | | 1 1 1 1 1 −1 −1 −1 −1 −1 |
| | | 1 −1 −1 1 1 −1 −1 1 1 −1 |
| | | 1 −1 1 1 1 1 1 −1 1 −1 |
| | | 1 1 1 −1 1 −1 −1 1 1 −1 |
| | | 1 1 1 −1 −1 1 1 1 1 −1 |
| | | −1 −1 1 −1 0 1 −1 −1 1 1 |
| | | −1 −1 −1 −1 −1 −1 −1 −1 1 −1 |
| | | −1 −1 −1 1 1 −1 −1 −1 1 −1 |
| | | 0 1 −1 −1 1 −1 −1 1 1 1 |
| | | −1 −1 1 1 −1 1 1 −1 −1 −1 |
| | | 1 −1 −1 −1 −1 −1 1 1 1 −1 |
| | | −1 −1 −1 1 −1 1 −1 1 −1 −1 |
| | | −1 −1 1 −1 −1 −1 −1 1 1 1 |
| | | −1 −1 −1 −1 1 −1 −1 −1 −1 1 |
| | | 1 −1 1 1 −1 −1 −1 1 1 1 |
| | | −1 1 −1 1 −1 −1 −1 1 −1 1 |
| | | −1 1 1 −1 1 −1 1 1 1 −1 |
| | | −1 −1 1 −1 1 1 1 1 1 −1 |
| | | 1 1 −1 1 −1 −1 −1 −1 −1 1 |
| | | 1 −1 1 −1 −1 1 1 1 −1 −1 |
| | | −1 1 −1 1 1 1 1 1 1 −1 |
| | | 1 −1 −1 −1 −1 −1 −1 1 −1 1 |
| | | 0 −1 1 1 −1 1 −1 1 −1 1 |
| | | 1 −1 1 1 −1 −1 −1 −1 1 −1 |
| | | −1 1 −1 1 0 −1 1 1 1 1 |
| | | −1 1 −1 1 −1 −1 −1 −1 1 −1 |
| | | −1 −1 −1 1 −1 −1 −1 1 1 −1 |
| | | 1 −1 −1 1 −1 −1 −1 −1 1 1 |
| | | 1 −1 1 1 −1 −1 −1 −1 −1 1 |
| | | −1 −1 −1 −1 −1 1 1 1 −1 −1 |
| | | −1 −1 −1 −1 1 1 −1 −1 −1 −1 |
| | | 1 1 1 −1 −1 1 −1 1 −1 −1 |
| | | 1 −1 1 −1 −1 1 1 −1 −1 −1 |
| | | −1 1 −1 −1 1 1 −1 1 −1 1 |
| | | 0 −1 1 1 1 −1 −1 1 1 −1 |
| | | −1 1 −1 1 −1 1 1 1 1 −1 |
| | | 1 1 1 1 1 1 1 −1 −1 −1 |
| | | −1 1 1 1 1 −1 −1 1 −1 −1 |
| | | 1 1 1 1 1 −1 1 −1 1 1 |
| | | 1 −1 1 −1 1 1 −1 1 −1 1 |
| | | −1 1 −1 1 −1 1 −1 1 1 −1 |
| | | 1 1 1 −1 −1 −1 −1 −1 1 −1 |
| | | 1 1 −1 −1 −1 −1 −1 −1 −1 1 |
| | | 1 1 −1 −1 1 −1 1 1 1 1 |
| | | 1 1 1 −1 −1 −1 1 1 1 −1 |
| | | −1 −1 −1 1 −1 −1 1 1 −1 −1 |
| | | 1 1 1 1 −1 1 1 1 −1 −1 |
| | | 0 −1 −1 1 −1 0 1 −1 −1 1 |
| | | 1 −1 −1 1 1 −1 1 −1 −1 1 |
| | | 1 −1 1 −1 1 −1 1 −1 1 −1 |
| | | 1 −1 −1 1 1 1 1 1 1 1 |
| | | 1 −1 −1 −1 1 −1 −1 1 −1 0 |
| | | −1 −1 1 −1 −1 −1 1 1 1 1 |
| | | 1 −1 −1 1 1 1 −1 1 −1 −1 |
| | | −1 −1 1 1 −1 1 1 −1 1 −1 |
| | | −1 −1 −1 1 −1 −1 1 −1 −1 −1 |
| | | −1 1 1 1 −1 −1 −1 1 1 1 |
| | | 1 1 −1 1 −1 1 −1 1 −1 1 |
| | | 1 1 1 −1 −1 −1 −1 −1 −1 1 |
| | | 1 −1 −1 1 −1 −1 −1 −1 −1 −1 |
| | | 1 1 1 −1 1 −1 −1 1 −1 −1 |
| | | 1 −1 1 1 1 1 −1 −1 −1 −1 |
| | | 1 −1 1 −1 1 −1 1 −1 0 −1 |
| | | −1 1 1 −1 1 −1 1 1 −1 1 |
| | | −1 −1 1 1 1 1 1 −1 1 −1 |
| | | 1 1 1 1 1 −1 1 −1 1 1 |
| | | 1 1 1 −1 1 −1 −1 −1 1 1 |
| | | −1 1 −1 1 1 1 1 1 1 1 |
| | | 1 1 −1 1 −1 1 −1 1 −1 −1 |
| | | 1 1 1 1 1 −1 1 −1 1 1 |
| | | 1 −1 −1 −1 1 −1 1 −1 1 1 |
| | | 1 −1 −1 1 1 1 1 1 −1 1 |
| | | 1 1 −1 −1 −1 −1 −1 −1 1 1 |
| | | 1 1 −1 1 1 1 1 1 −1 1 |
| | | −1 −1 −1 1 −1 −1 1 1 1 1 |
| | | 1 1 −1 1 −1 −1 1 1 −1 −1 |
| | | 0 −1 −1 1 1 1 1 1 −1 1 |
| | | −1 1 −1 −1 −1 −1 1 −1 1 1 |
| | | 1 1 −1 −1 −1 −1 1 1 1 −1 |
| | | −1 0 −1 −1 1 −1 −1 1 1 1 |
| | | −1 1 1 1 −1 1 1 1 −1 −1 |
| | | 1 1 1 −1 1 −1 −1 −1 1 −1 |
| | | −1 −1 1 −1 1 −1 1 1 1 −1 |
| | | 1 −1 −1 −1 −1 1 −1 −1 −1 −1 |
| | | 1 −1 1 −1 −1 −1 −1 −1 −1 1 |
| | | −1 1 1 −1 1 1 −1 −1 1 −1 |
| | | 1 1 0 −1 1 1 0 1 1 −1 |
| | | 1 −1 0 −1 −1 1 −1 1 1 −1 |
| | | −1 −1 1 −1 1 −1 1 −1 −1 1 |
| | | 1 −1 1 1 −1 −1 1 1 −1 −1 |
| | | −1 −1 1 −1 1 −1 −1 −1 1 1 |
| | | 1 −1 −1 1 1 1 1 −1 −1 1 |
| | | 1 −1 1 −1 −1 −1 1 1 −1 −1 |
| | | 0 −1 −1 1 1 1 1 −1 −1 −1 |
| | | −1 1 −1 1 −1 −1 −1 −1 −1 1 |
| | | 1 −1 1 1 1 −1 1 −1 1 −1 |
| | | 1 1 −1 1 1 1 1 1 1 1 |
| | | 1 −1 1 −1 −1 −1 −1 −1 −1 −1 |
| | | −1 −1 1 −1 1 −1 1 1 1 −1 |
| | | 1 −1 |

### Embodiment 2

Embodiment 2 of this disclosure mainly describes how to configure sequence-related information for a UWB device, for example, information such as a number of cyclic shift bits of cyclic shifts performed by different UWB devices on a base sequence (namely, a second sequence in this specification).

Optionally, Embodiment 2 of this disclosure may be implemented in combination with Embodiment 1, or may be implemented separately. This is not limited in this disclosure. When Embodiment 2 of this disclosure is implemented in combination with Embodiment 1, a first node in Embodiment 2 of this disclosure may be the first UWB device in Embodiment 1, and correspondingly, a second node is the second UWB device in Embodiment 1. Certainly, the first node in Embodiment 2 of this disclosure may alternatively be the second UWB device in Embodiment 1, and correspondingly, the second node is the first UWB device in Embodiment 1.

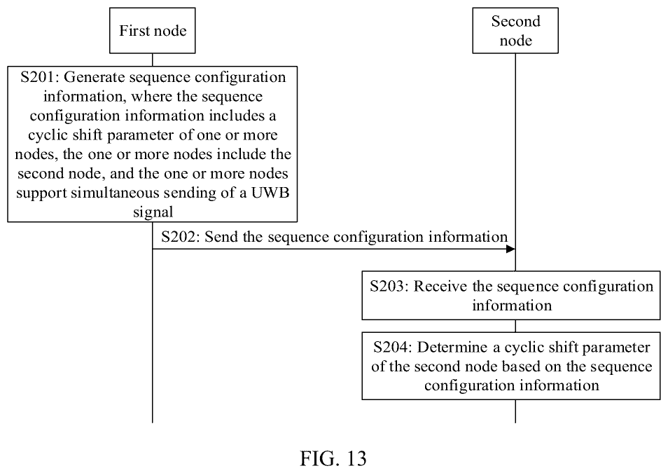

FIG. 13 shows an information exchange method in a UWB system according to an embodiment of this disclosure. The first node in the method may be a central control node (namely, a PAN coordinator) in the communication system shown in FIG. 1, or a central control node (namely, a PAN coordinator) in the communication system shown in FIG. 2, or any other device. The second node in the method is a device other than the first node in the communication system, and the second node may perform data communication with the first node.

As shown in FIG. 13, the information exchange method in the UWB system includes but is not limited to the following steps.

S201: The first node generates sequence configuration information, where the sequence configuration information includes a cyclic shift parameter of one or more nodes, the one or more nodes include a second node, and the one or more nodes support simultaneous sending of a UWB signal.

S202: The first node sends the sequence configuration information. For example, the first node broadcasts the sequence configuration information.

S203: The second node receives the sequence configuration information.

S204: The second node determines a cyclic shift parameter of the second node based on the sequence configuration information. For example, the second node determines a number of cyclic shift bits of the second node based on the received sequence configuration information.

In a possible implementation, the cyclic shift parameter includes a shift factor and a step size of the cyclic shift. A product of the shift factor (denoted as b) and the step size (denoted as Z) of the cyclic shift is equal to the number (denoted as L) of cyclic shift bits, that is, L-b*Z. Z satisfies at least either the foregoing formula (2-1) or the foregoing formula (2-3). A value of b is an integer greater than or equal to 0, and b satisfies the following conditions:

$$b \leq ⌊ \frac{N}{Z} - 1 ⌋ \qquad ( 2 - 5 )$$

In another possible implementation, the cyclic shift parameter includes the number (namely, L) of cyclic shift bits.

In still another possible implementation, the cyclic shift parameter includes the step size of the cyclic shift. The number (L) of cyclic shift bits may be equal to a value obtained by multiplying a product of an identifier (denoted as a UWB ID) of a UWB device and the step size (denoted as Z) of the cyclic shift by N, that is, L=(UWB ID*Z) mod N. N indicates a length of a base sequence (namely, the foregoing second sequence), and mod indicates a modulo operation.

Optionally, the sequence configuration information further includes one or more of the following items: a fragment number of the UWB signal, duration of each fragment, total duration of the UWB signal, a number of nodes (or UWB devices) that support simultaneous sending of UWB signal, or address lengths of the one or more nodes.

Optionally, the sequence configuration information is carried in an RCM. Alternatively, the sequence configuration information may be carried in another message. This is not limited in this embodiment of this disclosure. For example, a new information element (IE) may be defined in an RCM to carry the sequence configuration information. For ease of description, in this embodiment of this disclosure, the information element carrying the sequence configuration information is referred to as a sequence configuration IE. It may be understood that the information element carrying the sequence configuration information may have another name. This is not limited in this embodiment of this disclosure.

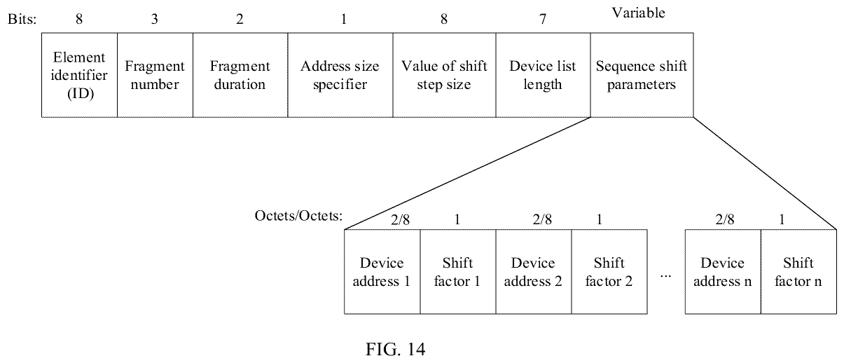

FIG. 14 is a diagram of a frame format of a sequence configuration information element according to an embodiment of this disclosure. As shown in FIG. 14, the sequence configuration information element includes one or more of the following: an element identifier (ID) field, a fragment number field, a fragment duration field, an address size specifier field, a value of shift step size field, a device list length field, or a sequence shift parameters field.

The element identifier field (for example, 8 bits, B0 to B7) indicates an identifier of the sequence configuration information element. The fragment number field (for example, 3 bits, B8 to B10) indicates a fragment number of the UWB signal. For example, a value (using binary as an example) and a meaning of the fragment number field are shown in the following Table 6. It may be understood that Table 6 is merely an example, and there may be another correspondence between the value and the meaning of the fragment number field. This is not limited in this embodiment of this disclosure.

TABLE 6

| Fragment number field value | Fragment number |
|---|---|
| 000 | 1 |
| 001 | 2 |
| 010 | 4 |
| 011 | 8 |
| 100 | 16 |
| 101 | 32 |
| 110 to 111 | Reserved |

The fragment duration field (for example, 2 bits, B11 to B12) indicates duration of each UWB fragment. For example, a value (using binary as an example) and a meaning of the fragment duration field are shown in the following Table 7. It may be understood that Table 7 is merely an example, and there may be another correspondence between the value and the meaning of the fragment duration field. This is not limited in this embodiment of this disclosure.

TABLE 7

| Fragment duration field value | Description |
|---|---|
| 00 | Duration = 2*(1 ms/fragment number) |
| 01 | Duration = 1*(1 ms/fragment number) |
| 10 | Duration = ½*(1 ms/fragment number) |
| 11 | Duration = ¼*(1 ms/fragment number) |

The sequence shift parameters field (of a variable length) indicates cyclic shift factors of one or more nodes (or UWB devices). The sequence shift parameters field includes one or more device address subfields and one or more shift factor subfields. One device address subfield and one shift factor subfield jointly indicate a shift factor of one UWB device (or one node). The device address subfield indicates a device address of the UWB device (or the node). The shift factor subfield indicates a shift factor of the UWB device (or the node).

The address size specifier field (for example, 1 bit, B13) indicates a length of the device address subfield in the sequence shift parameters field, that is, indicates address lengths of one or more UWB devices (or nodes). For example, when the address size specifier field is set to 0, it indicates that the length of the device address subfield in the sequence shift parameters field is 2 bytes, and when the address size specifier field is set to 1, it indicates that the length of the device address subfield in the sequence shift parameters field is 8 bytes. Alternatively, on the contrary, when the address size specifier field is set to 1, it indicates that the length of the device address subfield in the sequence shift parameters field is 2 bytes, and when the address size specifier field is set to 0, it indicates that the length of the device address subfield in the sequence shift parameters field is 8 bytes.

The value of shift step size field (for example, 8 bits, B14 to B21) indicates a step size (Z) of a cyclic shift. A sequence (namely, the foregoing first sequence, also a preamble sequence) generated based on the base sequence (namely, the foregoing second sequence) may be indicated as follows:

$${A}^{k} ( a ) = ( {a}_{L} , {a}_{L + 1} , … , {a}_{L + N - 1} ) ; L = b \times Z , b = 0 , 1 , 2 , … , ⌊ \frac{N}{Z} - 1 ⌋ \qquad ( 2 - 6 )$$

Herein, A⁰(a) indicates the base sequence (namely, the foregoing second sequence), L indicates the number of cyclic shift bits, and different L corresponds to different sequences. b indicates the shift factor. Z indicates the step size of the cyclic shift. A larger value of Z indicates a smaller number of devices that can simultaneously send a UWB signal. A smaller value of Z indicates a larger number of devices that can simultaneously send the UWB signal.

The device list length field (for example, 7 bits, B22 to B27) indicates the number of devices (or a number of nodes) that support simultaneous sending of the UWB signals, namely, a number of device address subfields or shift factor subfields included in the sequence shift parameters field.

It should be understood that names, lengths, and an arrangement order of the fields/subfields included in the sequence configuration information element shown in FIG. 14 are examples. The names, lengths, and arrangement order of the fields/subfields are not limited in this embodiment of this disclosure. It should be further understood that any frame format that carries the sequence configuration information falls within the protection scope of this disclosure.

In this embodiment of this disclosure, one new information element is defined to configure sequence-related information for one or more UWB devices, for example, the number of cyclic shift bits, the fragment number of the UWB signal, the duration of each fragment, and the number of UWB devices that support simultaneous sending of the UWB signals. This can lay a foundation for multi-node ranging, so that different UWB devices have different numbers of cyclic shift bits, and a receiving end can distinguish between UWB signals from the different UWB devices.

The foregoing content describes in detail the method provided in this disclosure. To facilitate implementation of the foregoing solutions in embodiments of this disclosure, embodiments of this disclosure further provide corresponding apparatuses or devices.

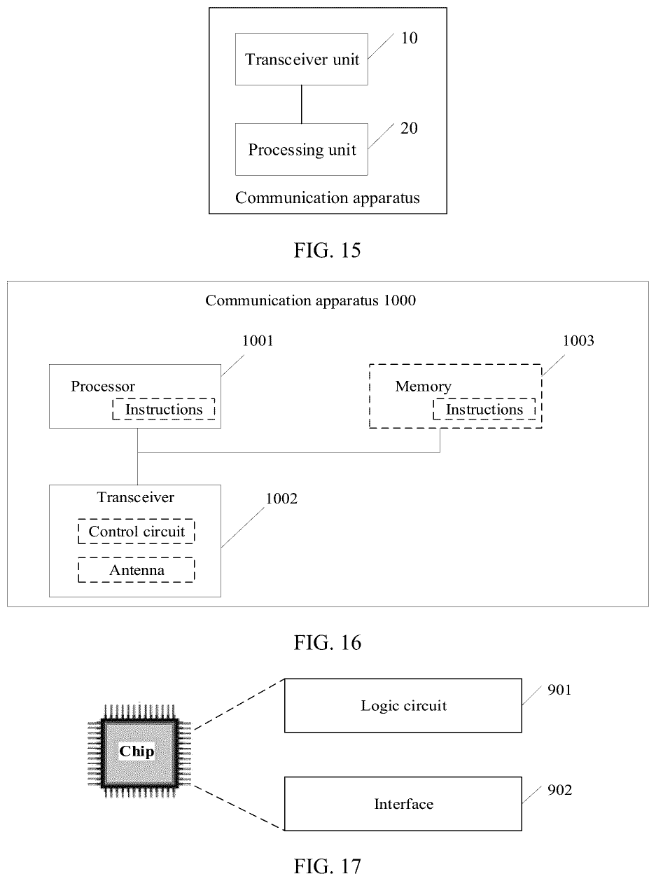

In this disclosure, the UWB device may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that in this disclosure, module division is an example and is merely a logical function division. In actual implementation, there may be another division manner. The following describes in detail a device or an apparatus in embodiments of this disclosure with reference to FIG. 15 to FIG. 17.

FIG. 15 is a diagram of a structure of a communication apparatus according to an embodiment of this disclosure. As shown in FIG. 15, the communication apparatus includes a transceiver unit 10 and a processing unit 20.

In some embodiments of this disclosure, the communication apparatus may be the first UWB device described above or a chip in the first UWB device. To be specific, the communication apparatus shown in FIG. 15 may be configured to perform steps, functions, or the like performed by the first UWB device in the foregoing method embodiments.

The transceiver unit 10 is configured to receive a UWB signal sent by one or more second UWB devices, where a UWB signal sent by any second UWB device is obtained by performing pulse shaping and modulation on a first sequence, the first sequence is obtained by performing cyclic shift on a second sequence, and a number of cyclic shift bits is determined based on a shift factor and a step size of the cyclic shift that are of the any second UWB device. The processing unit 20 is configured to determine, based on the UWB signal sent by the one or more second UWB devices and the second sequence, time of receiving the UWB signal sent by the one or more second UWB devices.

For specific descriptions of the UWB signal, the first sequence, the second sequence, and the like, refer to the foregoing method embodiments. Details are not described one by one herein again.

It may be understood that specific descriptions of the transceiver unit and the processing unit described in embodiments of this disclosure are merely examples. For specific functions, steps, or the like of the transceiver unit and the processing unit, refer to the foregoing method embodiments. Details are not described herein again. For example, the transceiver unit 10 may be configured to perform step S103 shown in FIG. 9, and the processing unit 20 may be configured to perform step S104 shown in FIG. 9.

Still referring to FIG. 15. In some other embodiments of this disclosure, the communication apparatus may be the second UWB device described above or a chip in the second UWB device. To be specific, the communication apparatus shown in FIG. 15 may be configured to perform steps, functions, or the like performed by the second UWB device in the foregoing method embodiments.

The processing unit 20 is configured to generate a UWB signal, where the UWB signal is obtained by performing pulse shaping and modulation on a first sequence, the first sequence is obtained by performing a cyclic shift on a second sequence, and a number of cyclic shift bits is determined based on a shift factor and a step size of the cyclic shift that are of the second UWB device.

For specific descriptions of the UWB signal, the first sequence, the second sequence, and the like, refer to the foregoing method embodiments. Details are not described one by one herein again.

It may be understood that specific descriptions of the transceiver unit and the processing unit described in embodiments of this disclosure are merely examples. For specific functions, steps, or the like of the transceiver unit and the processing unit, refer to the foregoing method embodiments. Details are not described herein again. For example, the transceiver unit 10 may be configured to perform step S102 shown in FIG. 9, and the processing unit 20 may be configured to perform step S101 shown in FIG. 9.

Still referring to FIG. 15. In still some embodiments of this disclosure, the communication apparatus may be the first node described above or a chip in the first node. To be specific, the communication apparatus shown in FIG. 15 may be configured to perform the steps, functions, or the like performed by the first node in the foregoing method embodiments.

The processing unit 20 is configured to generate sequence configuration information, where the sequence configuration information includes a cyclic shift parameter of one or more nodes, the one or more nodes include a second node, and the one or more nodes support simultaneous sending of a UWB signal. The transceiver unit 10 is configured to send the sequence configuration information.

For specific descriptions of the sequence configuration information, refer to the foregoing method embodiments. Details are not described one by one herein again.

It may be understood that specific descriptions of the transceiver unit and the processing unit described in embodiments of this disclosure are merely examples. For specific functions, steps, or the like of the transceiver unit and the processing unit, refer to the foregoing method embodiments. Details are not described herein again. For example, the transceiver unit 10 may be configured to perform step S202 shown in FIG. 13, and the processing unit 20 may be configured to perform step S201 shown in FIG. 13.

Still referring to FIG. 15. In still yet further some embodiment of this disclosure, the communication apparatus may be the second node described above or a chip in the second node. To be specific, the communication apparatus shown in FIG. 15 may be configured to perform steps, functions, or the like performed by the second node in the foregoing method embodiments.

The transceiver unit 10 is configured to receive sequence configuration information, where the sequence configuration information includes a cyclic shift parameter of one or more nodes, the one or more nodes include a second node, and the one or more nodes support simultaneous sending of a UWB signal. The processing unit 20 is configured to determine a cyclic shift parameter of the second node based on the sequence configuration information.

For specific descriptions of the sequence configuration information, refer to the foregoing method embodiments. Details are not described one by one herein again.

It may be understood that specific descriptions of the transceiver unit and the processing unit described in embodiments of this disclosure are merely examples. For specific functions, steps, or the like of the transceiver unit and the processing unit, refer to the foregoing method embodiments. Details are not described herein again. For example, the transceiver unit 10 may be configured to perform step S203 shown in FIG. 13, and the processing unit 20 may be configured to perform step S204 shown in FIG. 13.

The foregoing describes the first UWB device and the second UWB device in embodiments of this disclosure. The following describes possible product forms of the first UWB device and the second UWB device. It should be understood that a product in any form that has the function of the first UWB device in FIG. 15 or a product in any form that has the function of the second UWB device in FIG. 15 falls within the protection scope of embodiments of this disclosure. It should be further understood that the following descriptions are merely examples, and product forms of the first UWB device and the second UWB device in embodiments of this disclosure are not limited thereto.

In a possible implementation, in the communication apparatus shown in FIG. 15, the processing unit 20 may be one or more processors, and the transceiver unit 10 may be a transceiver. Alternatively, the transceiver unit 10 may be a sending unit and a receiving unit. The sending unit may be a transmitter. The receiving unit may be a receiver. The sending unit and the receiving unit are integrated into one device, for example, a transceiver. In embodiments of this disclosure, the processor and the transceiver may be coupled, or the like. A manner of connection between the processor and the transceiver is not limited in embodiments of this disclosure. In a process of performing the foregoing methods, a process related to sending information (for example, sending a UWB signal or sequence configuration information) in the foregoing methods may be understood as a process in which the processor outputs the foregoing information. When outputting the information, the processor outputs the information to a transceiver, so that the transceiver transmits the information. After the information is output by the processor, other processing may further need to be performed on the information before the information arrives at the transceiver. Similarly, a process related to receiving information (for example, receiving a UWB signal or sequence configuration information) in the foregoing methods may be understood as a process in which the processor receives the foregoing input information. When the processor receives the input information, the transceiver receives the information, and inputs the information into the processor. Further, after the transceiver receives the foregoing information, other processing may need to be performed on the information before the information is inputted into the processor.

FIG. 16 is a diagram of a structure of a communication apparatus 1000 according to an embodiment of this disclosure. The communication apparatus 1000 may be a first UWB device, a second UWB device, or a chip in the first UWB device or the second UWB device. FIG. 16 shows only main components in the communication apparatus 1000. In addition to the processor 1001 and the transceiver 1002, the communication apparatus may further include a memory 1003 and an input/output apparatus.

The processor 1001 is mainly configured to process a communication protocol and communication data, control the entire communication apparatus, execute a software program, and process data of the software program. The memory 1003 is mainly configured to store the software program and the data. The transceiver 1002 may include a control circuit and an antenna. The control circuit is mainly configured to perform a conversion between a baseband signal and a radio frequency signal, and process the radio frequency signal. The antenna is mainly configured to receive and send a radio frequency signal in a form of an electromagnetic wave. The input/output apparatus, like a touchscreen, a display, or a keyboard, is mainly configured to receive data input by a user and output data to the user.

After the communication apparatus is powered on, the processor 1001 may read the software program in the memory 1003, interpret and execute instructions of the software program, and process the data of the software program. When data needs to be sent wirelessly, the processor 1001 performs baseband processing on the to-be-sent data, and then outputs a baseband signal to a radio frequency circuit. The radio frequency circuit performs radio frequency processing on the baseband signal, and then sends a radio frequency signal in a form of an electromagnetic wave by using the antenna. When data is sent to the communication apparatus, the radio frequency circuit receives the radio frequency signal through the antenna, converts the radio frequency signal into a baseband signal, and outputs the baseband signal to the processor 1001. The processor 1001 converts the baseband signal into data, and processes the data.

In another implementation, the radio frequency circuit and the antenna may be disposed independent of the processor that performs baseband processing. For example, in a distributed scenario, the radio frequency circuit and the antenna may be remotely disposed independent of the communication apparatus.

The processor 1001, the transceiver 1002, and the memory 1003 may be connected through a communication bus.

In a design, the communication apparatus 1000 may be configured to perform a function of the first UWB device in Embodiment 1. The processor 1001 may be configured to perform step S104 in FIG. 9, and/or configured to perform another process of the technology described in this specification. The transceiver 1002 may be configured to perform step S103 in FIG. 9, and/or configured to perform another process of the technology described in this specification.

In another design, the communication apparatus 1000 may be configured to perform a function of the second UWB device in Embodiment 1. The processor 1001 may be configured to perform step S101 in FIG. 9, and/or configured to perform another process of the technology described in this specification. The transceiver 1002 may be configured to perform step S102 in FIG. 9, and/or configured to perform another process of the technology described in this specification.

In a design, the communication apparatus 1000 may be configured to perform a function of the first node in Embodiment 2. The processor 1001 may be configured to perform step S201 in FIG. 13, and/or configured to perform another process of the technology described in this specification. The transceiver 1002 may be configured to perform step S202 in FIG. 13, and/or configured to perform another process of the technology described in this specification.

In another design, the communication apparatus 1000 may be configured to perform a function of the second node in Embodiment 2. The processor 1001 may be configured to perform step S204 in FIG. 13, and/or configured to perform another process of the technology described in this specification. The transceiver 1002 may be configured to perform step S203 in FIG. 13, and/or configured to perform another process of the technology described in this specification.

In any one of the foregoing designs, the processor 1001 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In any one of the foregoing designs, the processor 1001 may store instructions. The instructions may be a computer program. The computer program is run on the processor 1001, so that the communication apparatus 1000 can perform the methods described in the foregoing method embodiments. The computer program may be fixed in the processor 1001. In this case, the processor 1001 may be implemented by hardware.

In an implementation, the communication apparatus 1000 may include a circuit. The circuit may implement the sending, receiving, or communication function in the foregoing method embodiments. The processor and the transceiver described in this disclosure may be implemented on an integrated circuit (IC), an analog IC, a radio frequency IC (RFIC), a mixed-signal IC, an application-specific integrated circuit (ASIC), a printed circuit board (PCB), an electronic device, or the like. The processor and the transceiver may alternatively be manufactured by using various IC technologies, for example, a complementary metal-oxide-semiconductor (CMOS), an N-type metal-oxide-semiconductor (NMOS), a P-type metal-oxide-semiconductor (PMOS), a bipolar junction transistor (BJT), a bipolar CMOS (BiCMOS), silicon germanium (SiGe), and gallium arsenide (GaAs).

A scope of the communication apparatus described in this disclosure is not limited thereto, and a structure of the communication apparatus may not be limited by FIG. 16. The communication apparatus may be an independent device or may be a part of a large device. For example, the communication apparatus may be:
(1) an independent integrated circuit IC, a chip, or a chip system or subsystem;
(2) a set including one or more ICs, where optionally, the set of ICs may further include a storage component configured to store data and a computer program;
(3) an ASIC, like a modem;
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) others.

In another possible implementation, in the communication apparatus shown in FIG. 15, the processing unit 20 may be one or more logic circuits, and the transceiver unit 10 may be an input/output interface that may also be referred to as a communication interface, an interface circuit, an interface, or the like. Alternatively, the transceiver unit 10 may be a sending unit and a receiving unit. The sending unit may be an output interface. The receiving unit may be an input interface. The sending unit and the receiving unit are integrated into one unit, for example, an input/output interface. FIG. 17 is a diagram of another structure of a communication apparatus according to an embodiment of this disclosure. As shown in FIG. 17, the communication apparatus shown in FIG. 17 includes a logic circuit 901 and an interface 902. In other words, the processing unit 20 may be implemented by using the logic circuit 901, and the transceiver unit 10 may be implemented by using the interface 902. The logic circuit 901 may be a chip, a processing circuit, an integrated circuit, a system on chip (SoC), or the like. The interface 902 may be a communication interface, an input/output interface, a pin, or the like. For example, FIG. 17 is an example in which the foregoing communication apparatus is a chip. The chip includes the logic circuit 901 and the interface 902. It may be understood that the chip shown in this embodiment of this disclosure may include a narrowband chip, an UWB chip, or the like. This is not limited in this embodiment of this disclosure. Alternatively, the narrowband chip and the UWB chip may be integrated into one apparatus or chip, or may be independent of each other. Implementations of the narrowband chip and the UWB chip in a device are not limited in this embodiment of this disclosure. A step of sending a UWB signal described above may be performed by the UWB chip, and whether another step is performed by the UWB chip is not limited in this embodiment of this disclosure.

In this embodiment of this disclosure, the logic circuit and the interface may be coupled to each other. A specific manner of connection between the logic circuit and the interface is not limited in embodiments of this disclosure.

For example, when the communication apparatus is configured to perform a method, a function, or steps performed by the first UWB device in Embodiment 1, the interface 902 is configured to input a UWB signal sent by one or more second UWB devices, and the logic circuit 901 is configured to determine, based on the UWB signal sent by the one or more second UWB devices and the second sequence, time of receiving the UWB signal sent by the one or more second UWB devices.

For example, when the communication apparatus is configured to perform a method, a function, or steps performed by the second UWB device in Embodiment 1, the logic circuit 901 is configured to generate a UWB signal, and the interface 902 is configured to output the UWB signal.

It may be understood that for specific descriptions of the UWB signal, the second sequence, and the like, refer to the foregoing method embodiments. Details are not described one by one herein again.

For example, when the communication apparatus is configured to perform a method, a function, or steps performed by the first node in Embodiment 2, the logic circuit 901 is configured to generate sequence configuration information, and the interface 902 is configured to output the sequence configuration information.

For example, when the communication apparatus is configured to perform a method, a function, or steps performed by the second node in Embodiment 2, the interface 902 is configured to input sequence configuration information, and the logic circuit 901 is configured to determine a cyclic shift parameter of the second node based on the sequence configuration information.

It may be understood that for specific descriptions of the sequence configuration information and the like, refer to the foregoing method embodiments. Details are not described one by one herein again.

It may be understood that the communication apparatus shown in embodiments of this disclosure may implement the methods provided in embodiments of this disclosure in a form of hardware, or may implement the methods provided in embodiments of this disclosure in a form of software. This is not limited in embodiments of this disclosure.

For specific implementations of embodiments shown in FIG. 17, refer to the foregoing embodiments. Details are not described herein again.

An embodiment of this disclosure further provides a wireless communication system. The wireless communication system includes a first UWB device and a second UWB device. The first UWB device and the second UWB device may be configured to perform the method in any one of the foregoing embodiments.

In addition, this disclosure further provides a computer program. The computer program is used to implement the operation and/or processing performed by the first UWB device in the methods provided in this disclosure.

This disclosure further provides a computer program. The computer program is used to implement the operation and/or processing performed by the second UWB device in the methods provided in this disclosure.

This disclosure further provides a computer-readable storage medium. The computer-readable storage medium stores computer code. When the computer code is run on a computer, the computer is enabled to perform the operation and/or processing performed by the first UWB device in the methods provided in this disclosure.

This disclosure further provides a computer-readable storage medium. The computer-readable storage medium stores computer code. When the computer code is run on a computer, the computer is enabled to perform the operation and/or processing performed by the second UWB device in the methods provided in this disclosure.

This disclosure further provides a computer program product. The computer program product includes computer code or a computer program. When the computer code or the computer program is run on a computer, the operation or processing or both performed by the first UWB device in the methods provided in this disclosure are performed.

This disclosure further provides a computer program product. The computer program product includes computer code or a computer program. When the computer code or the computer program is run on a computer, the operation or processing or both performed by the second UWB device in the methods provided in this disclosure are performed.

In the several embodiments provided in this disclosure, it should be understood that the disclosed systems, apparatuses, and methods may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one location, or may be distributed on a plurality of network units. Some or all of the units may be selected based on an actual requirement to implement the technical effects of the solutions provided in embodiments of this disclosure.

In addition, functional units in embodiments of this disclosure may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this disclosure essentially, or the part contributing to the other approaches, or all or some of the technical solutions may be implemented in a form of a software product. The computer software product is stored in a readable storage medium and includes a plurality of instructions for instructing a computer device (which may be a personal computer, a server, or a network device) to perform all or some of the steps of the methods described in embodiments of this disclosure. The readable storage medium includes any medium that can store program code, such as a Universal Serial Bus (USB) flash drive, a removable hard disk, a read-only memory (ROM), a random-access memory (RAM), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. An ultra-wideband (UWB) signal transmission method implemented by a first UWB device, wherein the UWB signal transmission method comprises:
receiving, from a second UWB device, a UWB signal, wherein the UWB signal is based on pulse shaping and adjustment on a first sequence, and wherein the first sequence is based on a cyclic shift of the second UWB device on a second sequence; and
determining, based on the UWB signal and the second sequence, a time of receiving the UWB signal.

2. The UWB signal transmission method of claim 1, wherein the second sequence satisfies one or more of:
a first ratio of a first main lobe amplitude of autocorrelation of the second sequence to a side lobe amplitude of the autocorrelation is greater than or equal to a first threshold;
the first main lobe amplitude is greater than or equal to a second threshold;
the side lobe amplitude is less than or equal to a third threshold; or
a second ratio of the first main lobe amplitude to a second main lobe amplitude of cross-correlation of the second sequence is greater than or equal to a fourth threshold.

3. The UWB signal transmission method of claim 1, wherein a length of the second sequence is less than or equal to a maximum number of pulses in a reference UWB signal.

4. The UWB signal transmission method of claim 3, wherein the reference UWB signal is a UWB fragment signal.

5. The UWB signal transmission method of claim 1, wherein the second sequence comprises at least one of 1, −1, or 0.

6. The UWB signal transmission method of claim 1, wherein a step size of the cyclic shift is based on a length of the second sequence and a number of devices that support simultaneous sending of UWB signals.

7. The UWB signal transmission method of claim 6, wherein the step size satisfies the following condition:
$$Z \leq ⌊ \frac{N}{M} ⌋ ,$$
wherein Z indicates the step size, wherein N indicates the length, and wherein M indicates the number of devices.

8. The UWB signal transmission method of claim 1, wherein a step size of the cyclic shift is based on a ranging range, a delay in a channel environment, and an average pulse repetition frequency.

9. The UWB signal transmission method of claim 8, wherein the step size satisfies the following conditions:
$$Z \geq ( {t}_{max} + {delay}_{channel} ) \times PRF ; and {t}_{max} = \frac{d}{c} ,$$
wherein Z indicates the step size, wherein d indicates the ranging range, wherein c indicates a speed of light, wherein PRF indicates the average pulse repetition frequency, and wherein delay_{channel} indicates the delay.

10. An ultra-wideband (UWB) signal transmission method implemented by a UWB device, wherein the UWB transmission method comprises:
performing a cyclic shift on a second sequence to obtain a first sequence, wherein a number of cyclic shift bits of the cyclic shift is based on a shift factor and a step size of the cyclic shift of the UWB device;
generating a UWB signal by performing pulse shaping and adjustment on the first sequence; and
sending the UWB signal.

11. The UWB signal transmission method of claim 10, wherein the second sequence satisfies one or more of:
a first ratio of a first main lobe amplitude of autocorrelation of the second sequence to a side lobe amplitude of the autocorrelation is greater than or equal to a first threshold;
the first main lobe amplitude is greater than or equal to a second threshold;
the side lobe amplitude is less than or equal to a third threshold; or
a second ratio of the first main lobe amplitude to a second main lobe amplitude is greater than or equal to a fourth threshold.

12. The UWB signal transmission method of claim 10, wherein a length of the second sequence is less than or equal to a maximum number of pulses in a reference UWB signal.

13. The UWB signal transmission method of claim 12, wherein the reference UWB signal is a UWB fragment signal.

14. The UWB signal transmission method of claim 10, wherein the second sequence comprises at least one of 1, −1, or 0.

15. The UWB signal transmission method of claim 10, wherein the step size is based on a length of the second sequence and a number of devices that support simultaneous sending of UWB signals.

16. The UWB signal transmission method of claim 15, wherein the step size satisfies the following condition:
$$Z \leq ⌊ \frac{N}{M} ⌋ ,$$
wherein Z indicates the step size, wherein N indicates the length, and wherein M indicates the number of devices.

17. The UWB signal transmission method of claim 10, wherein the step size is based on a ranging range, a delay in a channel environment, and an average pulse repetition frequency.

18. The UWB signal transmission method of claim 17, wherein the step size of the cyclic shift satisfies the following conditions:
$$Z \geq ( {t}_{max} + {delay}_{channel} ) \times PRF ; and {t}_{max} = \frac{d}{c} ,$$
wherein Z indicates the step size, wherein d indicates the ranging range, wherein c indicates a speed of light, wherein PRF indicates the average pulse repetition frequency, and wherein delay_{channel} indicates the delay.

19. A communication apparatus, comprising:
a transceiver configured to receive, from a UWB device, an ultra-wideband (UWB) signal, wherein the UWB signal is based on pulse shaping and adjustment on a first sequence, and wherein the first sequence is based on a cyclic shift of the UWB device on a second sequence; and
one or more processors coupled to the transceiver and configured to determine, based on the UWB signal and the second sequence, a time of receiving the UWB signal.

20. The communication apparatus of claim 19, wherein the second sequence satisfies one or more of:
a first ratio of a first main lobe amplitude of autocorrelation of the second sequence to a side lobe amplitude of the autocorrelation is greater than or equal to a first threshold;
the first main lobe amplitude is greater than or equal to a second threshold;
the side lobe amplitude is less than or equal to a third threshold; or
a second ratio of the first main lobe amplitude to a second main lobe amplitude of cross-correlation of the second sequence is greater than or equal to a fourth threshold.
